(19) United States
(12) Patent Application Publication
(10) Pub. No.: US 2022/0354339 A1
(43) Pub. Date: Nov. 10, 2022

(54) WATER-DISPERSIBLE ARTICLE INCLUDING WATER-DISPERSIBLE CORE CONSTRUCTION

(71) Applicant: MONOSOL, LLC, Merrillville, IN (US)

(72) Inventors: JONATHON D. KNIGHT, MERRILLVILLE, IN (US); VICTORIA BRIDEWELL, MERRILLVILLE, IN (US); RAMYA RAMASWAMY, MERRILLVILLE, IN (US); RYAN SLOPEK, MERRILLVILLE, IN (US)

(73) Assignee: MONOSOL, LLC, Merrillville, IN (US)

(21) Appl. No.: 17/737,946

(22) Filed: May 5, 2022

Related U.S. Application Data
(60) Provisional application No. 63/185,632, filed on May 7, 2021.

(51) Int. Cl. A47L 17/00; B08B 7/04; B08B 1/00; B08B 3/08

(52) U.S. Cl. CPC A47L 17/00; B08B 7/04; B08B 1/006; B08B 3/08

(57) ABSTRACT

An article for cleaning or hand-washing an object includes a core substrate comprising a plurality of fibers including a resin. The core substrate has one or more abrasive surfaces and contains an active cleaning formulation. The resin and the core substrate are water-dispersible upon contact with water at a low temperature, such as 40° C. or below, and water-soluble upon contact with water at a higher temperature. Also disclosed are methods for making the article.

### CROSS-REFERENCE TO RELATED APPLICATIONS

This application claims the benefit of U.S. Provisional Application No. 63/185,632, filed May 7, 2021, which application is expressly incorporated by reference herein in its entirety.

### FIELD

The present disclosure relates generally to water-dispersible and/or water-soluble unit dose articles including water-dispersible and/or water-soluble core constructions. More particularly, the disclosure relates to water-dispersible articles including water-dispersible substrates, such as nonwoven substrates, configured to contain a cleaning formulation, for example, for handwashing an object.

### BACKGROUND

Water-soluble packaging materials, such as water-soluble film packaging materials, are commonly used to simplify dispersing, pouring, dissolving, and dosing of a material to be delivered. Pouches made from conventional water-soluble films are commonly used to package formulations, such as laundry detergents, dish detergents, or personal care formulations. A consumer can directly add the water-soluble film pouch that contains a dish detergent formulation into an automatic dishwashing unit before starting the dishwasher cleaning cycle. Advantageously, this provides for accurate dosing while eliminating the need for the consumer to measure the formulation. However, this single unit dose concept has not been extended to handwashing to facilitate the dish washing process of a consumer choosing to wash dishes manually rather than using an automatic dishwashing unit. Instead, consumers choosing manual handwashing must rely on chemical and mechanical means of cleaning their dishes across multiple brands, products, and forms, e.g., bulk dish detergents or powders and a sponge, brush, cloth, or towel to provide a scrubbing action that present hygiene concerns if not frequently replaced.

Thus, there exists a need in the art for unit dose articles, such as single unit dose articles or multiple unit dose articles, having a construction that is easily manufacturable and provides an abrasive surface suitable for dry-cleaning debris from cookware and tableware, e.g., pots, pans, dishes, cooking utensils, eating utensils, glasses, and/or cups, while also being dissolvable or soluble when contacted with water at a suitable temperature to deliver a cleaning formulation, e.g., introduced into a sink containing a volume of water to deliver a suitable sanitizing and/or cleaning formulation in which the cookware and tableware can soak. After soaking in the water containing the sanitizing and/or cleaning formulation, the cookware and tableware can be easily cleaned, if necessary, rinsed, and dried.

### BRIEF DESCRIPTION OF THE DRAWINGS

FIGS. 1-4 are schematic sectional views of example articles containing an active cleaning formulation and optionally a carrier solvent, according to example embodiments; and

FIG. 5 illustrates an example method for making an article, according to an example embodiment.

### DETAILED DESCRIPTION

In example embodiments described herein, an article for cleaning or hand-washing an object is provided. Example articles, such as unit dose articles, e.g., single unit dose (SUD) articles or multiple unit dose (MUD) articles, include one or more water-dispersible and/or water-soluble core substrates, e.g., one or more water-dispersible and/or water-soluble nonwoven, foam, or film substrates, having precision dosing to deliver a carrier solvent with one or more active cleaning formulations, e.g., one or more cleaning agents, for cleaning soiled cookware and tableware including, without limitation, pots, pans, dishes, plates, cooking utensils, eating utensils, forks, spoons, knives, glasses, and/or cups. The core substrates may be water-dispersible at a temperature, for example, from about 10° C. to about 40° C., and water-soluble after multiple uses at such a temperature or at a higher temperature. In example embodiments, the article includes a water-dispersible core substrate comprising a water-dispersible resin. The core substrate has one or more abrasive surfaces having a relatively fibrous appearance and/or profile and one or more smooth surfaces having a relatively smooth appearance and/or profile. The core substrate is configured to contain an active cleaning formulation, e.g., a sanitizing and/or a cleaning formulation. A carrier solvent is optionally included.

Contacting an abrasive surface of the article to a dry or wet surface of a soiled or dirty pan, for example, a consumer simply applies pressure against the surface of the soiled or dirty pan such that the abrasive surface removes the baked or dried soiling on the pan surface. Once the soiling is removed from the pan surface, the article may be contacted with water at a suitable temperature, for example, to release the active cleaning formulation for chemical and/or mechanical cleaning action. Alternatively, the consumer may place the article in a sink or vessel containing a suitable volume of water such that, as the core substrate is dispersible or eventually soluble, the active cleaning formulation is released. Once released, the active cleaning formulation will disperse, dissolve, and/or biodegrade during the hand wash cleaning process without leaving undesired residue.

In example embodiments, when the core substrate is contacted with water having a temperature greater than 40° C., or having a temperature greater than 80° C., the water-soluble core substrate is soluble to release the active cleaning formulation. In example embodiments, the core substrate includes a water-dispersible or water-soluble polymer, such as polyvinyl alcohol (PVOH) polymer, starch derivatives, or blends thereof, for example, with otherwise water dispersible polymers that have a high degree of biodegradation activity or can be composted or recycled.

The article and, more specifically, in example embodiments, the core substrate, is configured to contain one or more active cleaning formulations, such as a sanitizing formulation and/or a cleaning detergent formulation. As an example, the active cleaning formulation may include, without limitation, a sanitizer and/or a dish detergent, soap, or cleaner. Other examples include a detergent, soap or cleaner, a fabric softener, a bleaching agent, a laundry booster, a stain remover, an optical brightener, a water softener, a shampoo, a conditioner, a body wash, a face wash, a skin lotion, a skin treatment, a body oil, fragrance, a hair treatment, a bath salt, an essential oil, a bath bomb, or an enzyme, or any suitable combination thereof. In example embodiments, suitable carrier solvents include solvents having a desired polarity and coat weight to facilitate incorporation of the active cleaning formulation into the polymer matrix of the water-soluble core substrate including, without limitation, water, polyols, such as glycerol, DPG (dipropylene glycol), and other polar carrier solvents or any combination thereof. In example embodiments, the carrier solvent with the active cleaning formulation is disposed on or coats one or more surfaces of the core substrate or is embedded in and/or adhered to the water-soluble core substrate. The core substrate may include a single layer, for example, a single layer nonwoven core substrate, or may include a plurality of layers, for example, a sheet of nonwoven core substrate folded in a serpentine arrangement or cut and plied to form layers with the carrier solvent with the active cleaning formulation disposed between adjacent layers of the water-soluble nonwoven core substrate, for example.

As used herein and unless specified otherwise, the term “water-dispersible” refers to any nonwoven substrate (or nonwoven web), foam substrate, film, or laminate wherein upon submersion in water at a specified temperature, the nonwoven substrate, foam substrate, film, or laminate physically disassociates into smaller constituent pieces. The smaller pieces may or may not be visible to the naked eye, may or may not remain suspended in the water, and may or may not ultimately dissolve. In example embodiments wherein a dispersion temperature is not specified, the nonwoven substrate, foam substrate, film, or laminate will disintegrate in 300 seconds or less at a temperature of about 100° C. or less, according to MSTM-205. For example, the disintegration time optionally can be 200 seconds or less, 100 seconds or less, 60 seconds or less, or 30 seconds or less at a temperature of about 80° C., about 70° C., about 60° C., about 50° C., about 40° C., about 20° C., or about 10° C., according to MSTM-205. For example, such dispersion parameters can be characteristic of a nonwoven substrate, foam substrate, film, or laminate structure having a thickness of 6 mil (about 152 μm). In example embodiments, the water-dispersible core substrate has a dispersion time of 300 seconds or less.

As used herein and unless specified otherwise, the term “water-soluble” refers to any nonwoven substrate (or nonwoven web), foam substrate, film, or laminate having a dissolution time of 300 seconds or less at a specified temperature as determined according to MSTM-205 as set forth herein. For example, the dissolution time of the nonwoven substrate, foam substrate, film, or laminate optionally can be 200 seconds or less, 100 seconds or less, 60 seconds or less, or 30 seconds or less at a temperature of about 80° C., about 70° C., about 60° C., about 50° C., about 40° C., about 20° C., or about 10° C. according to MSTM-205. In example embodiments wherein the dissolution temperature is not specified, the water-soluble nonwoven substrate, foam substrate, film, or laminate has a dissolution time of 300 seconds or less at a temperature no greater than about 80° C. In example embodiments, “water-soluble nonwoven substrate” or “water-soluble nonwoven web” means that at a thickness of 1.5 mil (about 38 μm), the nonwoven substrate dissolves in 300 seconds or less at a temperature no greater than 80° C. according to MSTM-205. For example, a 1.5 mil (about 38 μm) thick water-soluble nonwoven substrate can have a dissolution time of 300 seconds or less, 200 seconds or less, 100 seconds or less, 60 seconds or less, or 30 seconds or less at a temperature of about 70° C., about 60° C., about 50° C., about 40° C., about 30° C., about 20° C., or about 10° C. according to MSTM-205. In example embodiments, the water-soluble core substrate has a dissolution time of 300 seconds or less.

As used herein and unless specified otherwise, the term “hot water-soluble” refers to any water-soluble nonwoven substrate, foam substrate, film, or laminate having a dissolution time of 300 seconds or less at a temperature of at least 40° C., for example, in a range of about 40° C. to about 100° C., as determined according to MSTM-205. For example, the dissolution time of a hot water-soluble nonwoven substrate, foam substrate, film, or laminate optionally can be 200 seconds or less, 100 seconds or less, 60 seconds or less, or 30 seconds at a temperature greater than about 40° C. according to MSTM-205, for example, in a range of about 41° C. to about 80° C., about 40° C. to about 100° C., about 40° C. to about 60° C., about 50° C. to about 60° C., about 60° C. to about 80° C., or about 60° C. to about 90° C. In example embodiments, “hot water-soluble nonwoven substrate” or “hot water-soluble nonwoven web” means that at a thickness of 1.5 mil (about 38 μm), the nonwoven substrate dissolves in 300 seconds or less at a temperature no less than about 21° C. according to MSTM-205. For example, a 1.5 mil (about 38 μm) thick water-soluble nonwoven substrate can have a dissolution time of 300 seconds or less, 200 seconds or less, 100 seconds or less, 60 seconds or less, or 30 seconds or less at a temperature of about 80° C., 70° C., about 60° C., about 50° C., or about 40° C. according to MSTM-205. In example embodiments, a hot water-soluble substrate, such as a “hot water-soluble nonwoven substrate” or a “hot water-soluble nonwoven web,” remains stable, e.g., does not dissolve, when contacted with water having a temperature less than its hot water-soluble temperature but is soluble, e.g., dissolves, when contacted with water having a temperature equal to its hot water-soluble temperature for a suitable dissolution time, e.g., at least 300 seconds to between 300 seconds and 600 seconds. For example, in example embodiments, a hot water-soluble nonwoven substrate contacted with water having a temperature of 40° C. for at least 300 seconds, e.g., for 300 seconds to 600 seconds, is soluble according to MSTM-205; however, the hot water-soluble nonwoven substrate is stable when contacted with water having a temperature less than 40° C. or contacted with water having a temperature of 40° C. for less than 300 seconds.

As used herein and unless specified otherwise, the term “nonwoven web” refers to a web or sheet comprising, consisting of, or consisting essentially of fibers arranged (e.g., by a carding process) and bonded to each other. Thus, the term “nonwoven web” can be considered short hand for nonwoven fiber-based webs. Further, as used herein, “nonwoven web” includes any structure including a nonwoven web or sheet, including, for example, a nonwoven web or sheet having a film laminated to a surface thereof. Methods of preparing nonwoven webs from fibers are well known in the art, for example, as described in Nonwoven Fabrics Handbook, prepared by Ian Butler, edited by Subhash Batra et al., Printing by Design, 1999, herein incorporated by reference in its entirety. As used herein and unless specified otherwise, the term “film” refers to a continuous film or sheet, e.g., prepared by a casting or extrusion process.

As used herein, a “plurality of fibers” can include a sole fiber type or can include two or more different fiber types. In example embodiments wherein the plurality of fibers comprise two or more different fiber types, each fiber type can be generally included in any amount, for example, from about 0.5 wt. % to about 99.5 wt. % of the total weight of the plurality of fibers. In example embodiments wherein the plurality of fibers consists of a sole fiber type, the plurality of fibers is substantially free of a second or more fiber types. A plurality of fibers is substantially free of a second or more fiber types when the plurality of fibers comprise less than about 0.5 wt. % of the second or more fiber types. In general, the difference between fiber types can be a difference in fiber length to diameter ratio (LID), tenacity, shape, rigidness, elasticity, solubility, melting point, glass transition temperature (T_{g}), chemical composition, color, or a combination thereof.

As used herein, the terms “resin(s)” and “polymer(s)” should be considered interchangeable. In certain embodiments, the terms resin(s) and polymer(s), respectively, are used to refer to a polymer optionally combined with one or more additional polymers, and to a single type of polymer, e.g., a resin can comprise more than one polymer.

As used herein and unless specified otherwise, the terms “wt. %” and “wt %” are intended to refer to the composition of the identified element in “dry” (non-water) parts by weight of the entire water-soluble film, for example, including residual moisture in the water-soluble film, or parts by weight of the entire composition, depending on context.

As used herein and unless specified otherwise, the term “PHR” (“phr”) is intended to refer to the composition of the identified element in parts per one hundred parts water-soluble polymer resin(s) (whether PVOH or other polymer resins, unless specified otherwise) in the water-soluble nonwoven substrate, foam substrate, or film, or a solution used to make the water-soluble nonwoven substrate, foam substrate, or film.

As used herein and unless specified otherwise, the term “comprising” means that various components, ingredients, or steps can be conjointly employed in practicing the present disclosure. Accordingly, the term “comprising” encompasses the more restrictive terms “consisting essentially of” and “consisting of” The present compositions can comprise, consist essentially of, or consist of any of the required and optional elements disclosed herein. The disclosure illustratively disclosed herein suitably may be practiced in the absence of any element or step which is not specifically disclosed herein.

When values are expressed as approximations, by use of the antecedent “about,” it will be understood that the particular value forms another embodiment. As used herein, “about X” (where X is a numerical value) in example embodiments refers to ±10% (for example, ±5%) of the recited value, inclusive.

The articles, the water-dispersible and/or water-soluble nonwoven materials, the water-dispersible and/or water-soluble foam materials, and the water-dispersible and/or water-soluble film materials, and related methods of making and using the articles, the water-dispersible and/or water-soluble nonwoven materials, the water-dispersible and/or water-soluble foam materials, and the water-dispersible and/or water-soluble film materials are contemplated to include embodiments including any combination of one or more of the additional optional elements, features, and steps further described below, unless stated otherwise.

In example embodiments, the article includes a water-dispersible and/or water-soluble core substrate including a water-dispersible and/or water-soluble resin. In example embodiments, the core substrates and the resin may be water-dispersible at a temperature, for example, from about 10° C. to about 40° C., and water-soluble after multiple uses at such a temperature or at a higher temperature such as 40° C. or above. The highest safe hot water temperature for domestic use is about 48° C. In example embodiments, the core substrate includes one of more water-dispersible nonwoven core substrates. The core substrate contains an active cleaning formulation, wherein, when the core substrate is contacted with water having a temperature greater than 20° C., or water having a temperature greater than 40° C., or water having a temperature greater than 80° C., the core substrate is dispersible or soluble to release the active cleaning formulation. In example embodiments, the active cleaning formulation is in the form of at least one of a solid, e.g., a powder or plurality of granules or particles, a gel, a liquid, or a slurry form, or any suitable combination thereof. In certain embodiments, the core substrate is saturated with the carrier solvent with the active cleaning formulation. In other embodiments, the carrier solvent with the active cleaning formulation is embedded in, disposed on, applied to, coated on, and/or adhered to the water-soluble core substrate, e.g., the carrier solvent with the active cleaning formulation is disposed on a surface of the water-soluble core substrate. In example embodiments, the water-soluble core substrate is at least one of coated with the carrier solvent with the active cleaning formulation or impregnated with the carrier solvent with the active cleaning formulation. In example embodiments, the carrier solvent with the active cleaning formulation is present in the core substrate, e.g., present in the fiber-forming composition, the foam-forming composition, or the film-forming composition. The carrier solvent is optional.

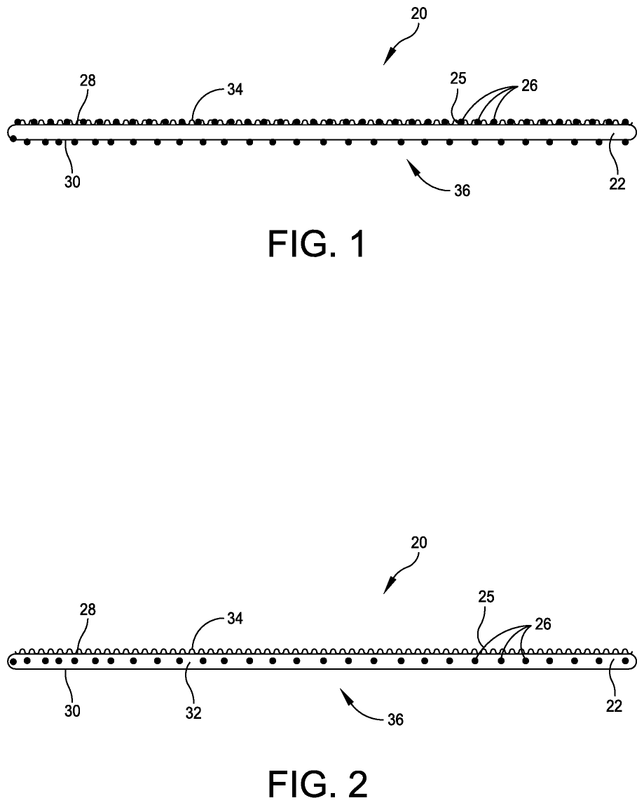

Referring to the Figures and, initially, to FIGS. 1-4, an article, such as a single unit dose article 20, includes a water-dispersible and/or water-soluble nonwoven substrate 22 comprising a plurality of fibers including a water-dispersible and/or water-soluble resin. In example embodiments, nonwoven substrate 22 includes any suitable fiber chemistry including, without limitation, PVOH fibers as described herein or PVOH fibers blended with up to 90 wt. % cellulose-type fibers, or PVOH fibers blended with fibers made of other polymers. In some embodiments, the nonwoven substrate is made of water-dispersible fibers.

In example embodiments, nonwoven substrate 22 has a basis weight of 15 gsm to 150 gsm (grams per square meter); a fiber length of 10.0 mm to 150 mm; and a suitable fiber diameter of 5 microns to 100 microns. In other example embodiments, water-soluble nonwoven substrate 22 has any suitable basis weight, fiber length, and/or fiber diameter. For example, in example embodiments, the fiber diameter is less than 5 microns or greater than 100 microns. The fibers of nonwoven substrate 22 may be formed using any suitable methods including, without limitation, a carded process or any suitable process for making water-soluble nonwoven fibers. Further, the fibers of nonwoven substrate 22 are bonded together using any suitable bonding process or method including, without limitation, a heat, thermal, chemical, water, and/or solution bonding method or any suitable bonding method known in the art of nonwoven fiber bonding. As described below and shown in FIGS. 1-4, nonwoven substrate 22 may include any suitable number of layers or plies, for example, 1 layer or ply to 50 layers or plies, or more in certain embodiments Nonwoven substrate 22 may be porous or non-porous and cold water-soluble, warm water-soluble, or hot water-soluble. In alternative example embodiments, the nonwoven substrate may be cold water-dispersible, warm water-dispersible, or hot water-dispersible. Water-soluble nonwoven substrate 22 may be formed using any suitable manufacturing process known in the nonwoven manufacturing art including, without limitation, a carded process. The construction of water-soluble nonwoven substrate 22 may include, for example, folded layers or plies, stacked layers or plies, and/or rolled layers or plies.

In example embodiments, nonwoven substrate 22 contains an active cleaning formulation 26 and optionally a carrier solvent 25. In example embodiments, nonwoven substrate 22 has a moisture content less than 15 wt. %, and, more particularly, less than 10 wt. %, and, even more particularly, between 2 wt. % and 10 wt. % before contact with carrier solvent 25 with active cleaning formulation 26. In example embodiments as described herein, upon contact of carrier solvent 25 with at least one fiber of the plurality of fibers, the at least one fiber exhibits a degree of shrinkage of 0.5% to 65%. In example embodiments, active cleaning formulation 26 is a liquid formulation.

In example embodiments, when nonwoven substrate 22 is contacted with water having a temperature in a range of 10° C. to 40° C., the nonwoven substrate 22 is dispersible to release the active cleaning formulation 26. When the nonwoven substrate 22 is contacted with water having a temperature greater than 40° C., or a temperature greater than 80° C., water-soluble nonwoven substrate 22 is soluble, i.e., dissolves. Further, in example embodiments, when nonwoven substrate 22 is contacted with water having a temperature greater than 20° C., or a temperature greater than 40° C. for not more than 300 seconds, active cleaning formulation 26 is substantially released from water-soluble nonwoven substrate 22. In example embodiments, nonwoven substrate 22 has a dissolution time of at least 300 seconds according to MSTM-205 at a temperature, for example, above 40° C. such as 60-100° C. In example embodiments, the core substrate dissolves completely in application, and can be assessed by being able to completely dissolve under MSTM 205 testing in under 300 seconds. In an example application test, there is no residue remaining when the water-soluble core substrate is dissolved in 40° C. to 100° C. in less than 600 seconds with undefined agitation.

Suitable carrier solvents 25 include, without limitation, water, polyols, such as glycerol, DPG, etc., and other polar solvents having a desired polarity and coat weight to facilitate incorporation of active cleaning formulation 26 into the polymer matrix of water-soluble nonwoven substrate 22. Active cleaning formulation 26 may be in the form of a solid, e.g., a powder or a plurality of granules or particles, a gel, a liquid, or a slurry formulation, or any suitable combination of a solid, a gel, a liquid, or a slurry formulation, for example. In example embodiments, active cleaning formulation 26 is in any suitable phase including, for example, a solid phase, a liquid phase, a slurry phase (a liquid containing solids and multiple phases), or any suitable combination of phases. For example, active cleaning formulation 26 may include fine powder particles or granules, gels, one or more liquids, or a slurry, or multiple phases. Active cleaning formulation 26 may include, without limitation, one or more of the following: sanitizers, sanitizing agents, detergents, surfactants, emulsifiers, chelants, dirt suspenders, stain releasers, enzymes, pH adjusters, builders, soil release polymers, structurants, free fragrance, encapsulated fragrance, preservatives, solvent, minerals, oxidizers, a foam builder, an HLB adjuster, or a degreaser, and/or any ingredients suitable for including in a sanitizer and/or dish detergent (or personal care, laundry detergent, and/or home surface cleaners or cleansers). In example embodiments, active cleaning formulation 26 may include a sanitizer or a sanitizing agent or water-soluble nonwoven substrate 22 may include the sanitizer or the sanitizing agent as an auxiliary agent. In example embodiments, article 20 includes active cleaning formulation 26 having a mass of 0.5 gram (g) to 250 grams, and a volume of 1.0 milliliter (ml) to 250 ml. In example embodiments wherein active cleaning formulation 26 is a solid phase, the particles or granules may have a size of 1 micron to 100 microns, for example, or may be in tablet form.

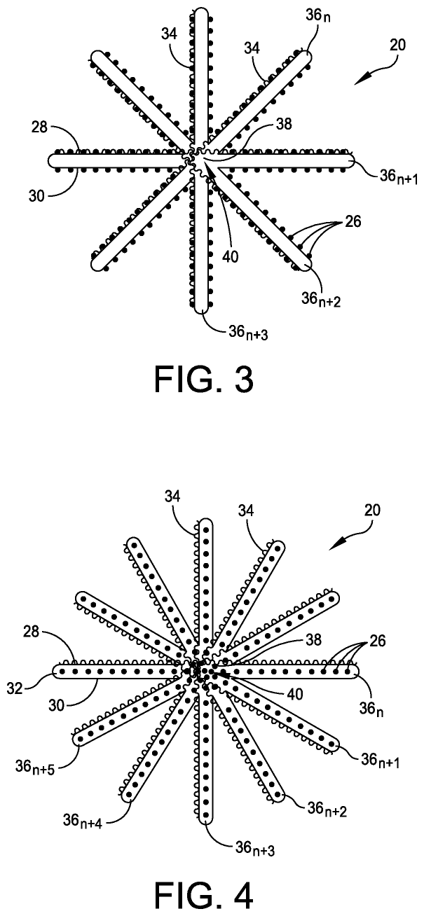

In example embodiments, active cleaning formulation 26 is contained in or by nonwoven substrate 22, for example, by saturating nonwoven substrate 22 with carrier solvent 25 with active cleaning formulation 26, by disposing, e.g., applying or coating, carrier solvent 25 with active cleaning formulation 26 on one or more surfaces, e.g., a first surface 28 and/or a second surface 30, of nonwoven substrate 22, as shown in FIGS. 1 and 3, by embedding carrier solvent 25 with active cleaning formulation 26 in a matrix 32 of nonwoven substrate 22, as shown in FIGS. 2 and 4, e.g., in one or more layers of nonwoven substrate 22, and/or by disposing, e.g., applying or coating, carrier solvent 25 with active cleaning formulation 26 between different layers, e.g., adjacent layers, of nonwoven substrate 22, e.g., coating one or more surfaces of one or more layers, for example, with carrier solvent 25 with active cleaning formulation 26. Carrier solvent 25 with active cleaning formulation 26 may be adsorbed in and/or adhered to or bonded to a surface of nonwoven substrate 22, for example. In example embodiments, carrier solvent 25 with one or more active cleaning formulations 26 is suspended in a water-soluble polymer system or resin, such as a PVOH resin as described herein, or disposed on, e.g., coated on, one or more surfaces of water-soluble nonwoven substrate 22. The various morphologies as described herein allow for control over a release and/or a delivery of active cleaning formulation 26 and a solubility of article 20. In example embodiments, active cleaning formulation 26 is released at a specific or determined water temperature and/or over a specific or determined amount of time dictated by thermodynamics and capillary pressure. The carrier solvent 25 is optional. In some embodiments, the article 20 contains no carrier solvent 25.

In example embodiments, one or more first surfaces 28 includes an abrasive material 34 forming a rough area or region of water-soluble nonwoven substrate 22, e.g., an abrasive portion or region, having a fibrous appearance and/or profile. In example embodiments, abrasive material 34 includes, without limitation, at least one of the following: the plurality of fibers described herein, the active cleaning formulation in solid form as described herein, silicon dioxide or silica (SiO₂), diatomaceous earth, one or more clays, minerals, jute, or a plurality of natural insoluble fibers, or combinations thereof, for providing first surface 28 with a desired abrasiveness suitable for scrubbing or scouring dry or wet soiled cookware and tableware without damaging the surface finish of the cookware or the tableware. In example embodiments, the plurality of fibers in the nonwoven substrate 22 and the active cleaning formulation 26 in solid form as the abrasive material 34 provide the first surface 28 with a desired abrasiveness. Other suitable abrasive materials 34 may also be used, alone or in combination, to provide first surface 28 with the desired abrasiveness. Generally, in example embodiments abrasion is defined by a change in Ra (gloss) values before and after a metallic surface has been cleaned, with defined parameters in an X-direction and a rotational direction. In example embodiments, the one or more abrasive materials 34 are contained within water-soluble nonwoven substrate 22. For example, abrasive material 34 is embedded in, disposed on, applied to, coated on, and/or adhered to first surface 28 and/or embedded in nonwoven substrate 22, e.g., abrasive material 34 is disposed in matrix 32 of nonwoven substrate 22. In example embodiments, the abrasive material has a surface finish Ra value for a carbon steel substrate of about 8 uin (0.2 μm) to about 16 uin (0.4 μm) (XY Auto); 11 uin (0.275 μm) to about 22 uin (0.55 μm) (Off Hand Short); and about 13 uin (0.325 μm) to about 21 uin (0.525 μm) (Off Hand Long). In example embodiments, the abrasive material has a surface finish Ra value for an aluminum substrate of about 29 uin (0.725 μm) to about 57 uin (1.425 μm) (XY Auto); and about 33 uin (0.825 μm) to about 60 uin (1.5 μm) (Off Hand Short).

In example embodiments, nonwoven substrate 22 includes one or more relatively smooth second surfaces 30, i.e., each second surface 30 has a relatively smooth appearance and/or profile compared to the relatively fibrous appearance and/or profile of first surface 28. For example, second surface 30 may be coated with water and/or heated to create a continuous smooth surface.

Abrasive material 34 may be applied to first surface 28 using any suitable application method known to those skilled in the art including, for example, adhesive or heat applications. In example embodiments, a suitable adhesive is applied to first surface 28 to adhere abrasive material 34 to first surface 28 or first surface 28 is heated and abrasive material 34 is applied to first surface 28 using a suitable spraying application or placing first surface 28 on a suitable abrasive material 34 contained within a bed or container, for example. In other example embodiments, nonwoven substrate 22 is impregnated with abrasive material 34. In example embodiments, abrasive material 34 is present in the nonwoven substrate 22, e.g., present in the fiber-forming composition.

In other example embodiments, one or more abrasive materials 34 are embedded in, disposed on, applied to, coated on, and/or adhered to second surface 30 and/or embedded in water-soluble nonwoven substrate 22 to form a rough area or region of water-soluble nonwoven substrate 22, e.g., an abrasive portion or region, on second surface 30 having a fibrous appearance and/or profile. In example embodiments, abrasive material 34 may be disposed throughout a thickness of water-soluble nonwoven substrate 22 such that an abrasive gradient is formed, wherein first surface 28 has a first degree of abrasiveness and opposing second surface 30 has a second degree of abrasiveness less than or greater than the first degree of abrasiveness. In example embodiments, first surface 28 has a relatively rougher appearance and/or a rougher profile when compared to the appearance and/or the profile of second surfaces 30. Conversely, second surface 30 has a relatively smoother appearance and/or a smoother profile when compared to the appearance and/or the profile of first surfaces 28.

In example embodiments such as shown in FIG. 1, article 20 includes one or more layers of nonwoven substrate 22 forming a nonwoven sheet 36 and carrier solvent 25 with active cleaning formulation 26 in a solid phase disposed on first surface 28 and/or opposing second surface 30 of nonwoven substrate 22. In example embodiments, such as shown in FIG. 2, article 20 includes one or more layers of nonwoven substrate 22 forming a nonwoven sheet 36 containing carrier solvent 25 with active cleaning formulation 26 in a solid phase embedded within matrix 32 of nonwoven substrate 22. In example embodiments such as shown in FIG. 3, article 20 includes a plurality of sheets 36 (for example, 36n, 36n+1, 36n+2, 36n+3, 36n+4, 36n+5, . . . , as shown in FIGS. 3 and 4) of nonwoven substrate 22 coupled together to form a sphere or spheroid and carrier solvent 25 with active cleaning formulation 26 in a solid phase disposed on one or more surfaces of one or more sheets 36, e.g., first surface 28 and/or opposing second surface 30 of sheet 36. The plurality of sheets 36 may be coupled together along a center line 38 of each sheet 36, as shown in FIGS. 3 and 4, collectively defining a center point 40 of article 20 and forming a sphere-shaped article 20 or spheroid-shaped article 20. In other example embodiments, one or more sheets 36 may be coupled along an edge of each sheet 36, for example, collectively defining center point 40 of article 20 and forming the sphere-shaped article 20 or spheroid-shaped article 20. In example embodiments, such as shown in FIG. 3, one or more sheets 36 of nonwoven substrate 22 contain carrier solvent 25 with active cleaning formulation 26 in a solid phase disposed on first surface 28 and/or opposing second surface 30 of sheet 36. In example embodiments, such as shown in FIG. 4, article 20 includes one or more sheets 36 of nonwoven substrate 22 containing carrier solvent 25 with active cleaning formulation 26 in a solid phase embedded within matrix 32 of nonwoven substrate 22.

Referring further to FIGS. 1-4, in example embodiments, nonwoven substrate 22 includes a plurality of fibers as described herein but not explicitly shown in FIGS. 1-4. In example embodiments, one or more fibers of the plurality of fibers is saturated with or impregnated with carrier solvent 25 with active cleaning formulation 26. Carrier solvent 25 with active cleaning formulation 26 may be embedded in one or more of fibers of the plurality of fibers or between one or more adjacent fibers of the plurality of fibers, or carrier solvent 25 with active cleaning formulation may be disposed on, e.g., applied to or coated on, a surface of one or more fibers of the plurality of fibers.

In example embodiments, an example water dispersible and/or water-soluble article 20, e.g., a water-dispersible and/or water-soluble nonwoven towel, sheet, wipe, loofa, pad, strip, or sponge, is provided that allows the consumer to initially scrub or scour the soiled or dirty cookware and dinnerware. Article 20 is configured in example embodiments to provide one or more abrasive surfaces to facilitate cleaning wet or dry debris and food stuffs from surfaces of the cookware and dinnerware and deliver a suitable amount of active cleaning formulation 26 for cleaning a single load of hand-washed cookware and dinnerware, for example. A consumer may scrub dishes when the dishes are dry. Once a desired amount of debris and food stuffs are removed using article 20, article 20 can be dissolved in a sink (or in a soaking tub) to deliver a sanitizing and/or cleaning formulation for further removal of debris and food stuffs from the dishes and sanitize the dishes. As another example, a consumer may apply cold water (e.g., water having a temperature not greater than 20° C.) to the dishes as the consumer scrubs the dishes, and article 20 dissolves progressively or slowly during use. Once the dishes are cleaned, water may be squeezed out of article 20, which may be reused. After single or multiple uses, the consumer can apply hot water (e.g., water having a temperature of at least 40° C., preferably 60-70° C. or above) to article 20 to substantially or completely dissolve article 20 and release a sanitizing agent into the hot water contained in the sink. When the water temperature is close to 40° C., article 20 starts to dissolve while dissolving much faster at a temperature of 60-70° C. or above. As another example, article 20 does not dissolve as the dishes are washed with hot water (e.g., water having a temperature of at least 40° C.). During the washing process, carrier solvent 25 with active cleaning formulation 26 is substantially continuously released from article 20. Once the manual dish washing process is complete, article 20 can be introduced into an automatic dish washer where article 20 dissolves during the washing cycle to aid in dish washing. Alternatively, because article 20 exhibits a suitable biodegradation profile, article 20 may be disposed of in the trash or placed in a paper recycle bin.

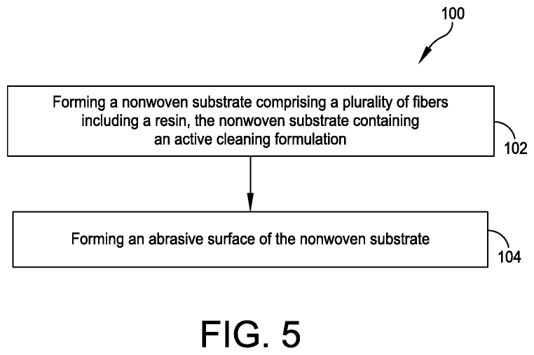

Referring now to FIG. 5, in example embodiments, a method 100 for making an article 20, such as a single unit dose article, containing an active cleaning formulation and optionally carrier solvent includes step 102 or steps 102 and 104. At step 102, a core substrate comprising a plurality of fibers including a water-dispersible and/or water-soluble resin is formed. In example embodiments, one or more layers of the core substrate or substrates containing a carrier solvent with an active cleaning formulation are formed. In example embodiments, the core substrate, e.g., nonwoven substrate 22, is configured to contain the carrier solvent with the one or more active cleaning formulation, such as described herein. In example embodiments, carrier solvent 25 with active cleaning formulation 26 is contained in or by nonwoven substrate 22, for example, by saturating nonwoven substrate 22 with carrier solvent 25 with active cleaning formulation 26, by disposing, e.g., applying or coating, carrier solvent 25 with active cleaning formulation 26 on one or more surfaces, e.g., a first surface 28 and/or a second surface 30, of nonwoven substrate 22, as shown in FIGS. 1 and 3, by embedding carrier solvent 25 with active cleaning formulation 26 in a matrix 32 of nonwoven substrate 22, as shown in FIGS. 2 and 4, e.g., in one or more layers of nonwoven substrate 22, and/or by disposing carrier solvent 25 with active cleaning formulation 26 between different layers, e.g., adjacent layers, of nonwoven substrate 22, e.g., coating one or more surfaces of one or more layers, for example, with carrier solvent 25 with active cleaning formulation 26. Active cleaning formulation 26 may be adsorbed in and/or adhered to or bonded to a surface of nonwoven substrate 22, for example. When at least one fiber of the plurality of fibers forming nonwoven substrate 22 is contacted with a suitable amount of carrier solvent 25, the at least one fiber exhibits a degree of shrinkage of 0.5% to 65%. In example embodiments, method 100 includes contacting the carrier solvent with the nonwoven substrate 22, wherein upon contact with the carrier solvent, the at least one fiber exhibits a degree of shrinkage of 0.5% to 65%. In example embodiments, when nonwoven substrate 22 is contacted with water having a temperature greater than 20° C., or water having a temperature greater than 40° C., or water having a temperature greater than 80° C., nonwoven substrate 22 is dispersible or soluble to release the active cleaning formulation. The carrier solvent 25 is optional in the article 20. If carrier solvent 25 is used, it may be dried off in the article 20.

In example embodiments, method 100 includes step 104. At step 104, an abrasive surface is formed on the water-soluble nonwoven substrate 22. For example, one or more surfaces of nonwoven substrate 22 are formed having a rough or abrasive area or region. In example embodiments, one or more abrasive materials 34 are formed on, disposed in, or adhered to one or more first surfaces 28 of nonwoven substrate 22 forming a rough area or region of nonwoven substrate 22, e.g., an abrasive area or region, having a fibrous appearance and/or profile, for example. Suitable abrasive materials 34, as described herein, may be used, alone or in combination, to provide first surface 28 with the desired abrasiveness. In example embodiments, the one or more abrasive materials 34 are contained within nonwoven substrate 22. For example, abrasive material 34 is embedded in, disposed on, applied to, coated on, and/or adhered to first surface 28 and/or embedded in nonwoven substrate 22, e.g., abrasive material 34 is disposed in matrix 32 of nonwoven substrate 22.

In example embodiments, method 100 includes forming one or more abrasive materials 34 on first surface 28 or applying one or more abrasive materials 34 to first surface 28 using any suitable application method known to those skilled in the art including, for example, adhesive or heat applications. In example embodiments, a suitable adhesive is applied to first surface 28 to adhere abrasive material 34 to first surface 28 or first surface 28 is heated and abrasive material 34 is applied to first surface 28 using a suitable spraying application or placing first surface 28 on a suitable abrasive material 34 contained within a bed or container, for example. In other example embodiments, first surface 28 is at least partially dissolved and abrasive material 34 is applied to at least partially dissolved first surface 28 or nonwoven substrate 22 is impregnated with abrasive material 34. In example embodiments, abrasive material 34 is present in the nonwoven substrate 22, e.g., present in the fiber-forming composition or resin.

In example embodiments, method 100 includes forming one or more surfaces of water-soluble nonwoven substrate 22 having a relatively smooth area or region having a smooth appearance and/or profile. For example, water-soluble nonwoven substrate 22 may include one or more relatively smooth second surfaces 30, i.e., each second surface 30 has a relatively smooth appearance and/or profile compared to the relatively fibrous appearance and/or profile of first surface 28. In example embodiments, second surface 30 may be coated with water and/or heated to create a continuous smooth surface. In other example embodiments, method 100 includes forming one or more abrasive areas or regions on second surfaces 30. For example, one or more abrasive materials 34 are embedded in, disposed on, applied to, coated on, and/or adhered to second surface 30 and/or embedded in nonwoven substrate 22 to form a rough area or region of nonwoven substrate 22, e.g., an abrasive area or region, on second surface 30 having a fibrous appearance and/or profile.

In other example embodiments, method 100 includes forming an abrasive gradient throughout a thickness of nonwoven substrate 22. For example, abrasive material 34 may be disposed throughout a thickness of nonwoven substrate 22 such that an abrasive gradient is formed, wherein first surface 28 has a first degree of abrasiveness and opposing second surface 30 has a second degree of abrasiveness less than or greater than the first degree of abrasiveness. In example embodiments, first surface 28 has a relatively rougher appearance and/or rougher profile when compared to the appearance and/or profile of second surfaces 30. Conversely, second surface 30 has a relatively smoother appearance and/or smoother profile when compared to the appearance and/or profile of first surfaces 28.

### Water-Soluble Film and Fiber-Forming Materials

Water-soluble polymers for use in the water-soluble fibers, water-soluble nonwoven substrates, water-soluble foam substrates, and water-soluble films include, but are not limited to, a polyvinyl alcohol (PVOH) polymer, polyacrylate, water-soluble acrylate copolymer, polyvinyl pyrrolidone, polyethyleneimine, pullulan, water-soluble natural polymers including, but not limited to, guar gum, gum Acacia, xanthan gum, carrageenan, and starch, water-soluble polymer derivatives including, but not limited to, modified starches, ethoxylated starch, and hydroxypropylated starch, copolymers of the forgoing and combinations of any of the foregoing. Other water-soluble polymers can include polyalkylene oxides, polyacrylamides, polyacrylic acids and salts thereof, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, and combinations of any of the foregoing. Such water-soluble polymers, whether PVOH or otherwise, are commercially available from a variety of sources.

In general, the fibers, foams, and films as described herein include polyvinyl alcohol. Polyvinyl alcohol is a synthetic polymer generally prepared by the alcoholysis, usually termed “hydrolysis” or “saponification,” of polyvinyl acetate. Fully hydrolyzed PVOH, where virtually all the acetate groups have been converted to alcohol groups, is a strongly hydrogen-bonded, highly crystalline polymer which dissolves only in hot water, e.g., water having a temperature greater than about 140° F. (about 60° C.). If a sufficient number of acetate groups are allowed to remain after the hydrolysis of polyvinyl acetate, that is the PVOH polymer is partially hydrolyzed, then the polymer is more weakly hydrogen-bonded, less crystalline, and is generally soluble in cold water, e.g., water having a temperature less than about 50° F. (about 10° C.). As such, the partially hydrolyzed polymer is a vinyl alcohol-vinyl acetate copolymer that is a PVOH copolymer, but is commonly referred to as PVOH.

In some embodiments, suitable examples of such a polymer include, without limitation, a polyvinyl alcohol homopolymer, a polyvinyl alcohol copolymer, a modified polyvinyl alcohol copolymer, and combinations thereof. For example, the polyvinyl alcohol copolymer is a copolymer of vinyl acetate and vinyl alcohol in some embodiments. For example, in some embodiments, the modified polyvinyl alcohol copolymer comprises an anionically modified copolymer, which may be a copolymer of vinyl acetate and vinyl alcohol further comprising additional groups such as a carboxylate, a sulfonate, or combinations thereof. As such, the partially hydrolyzed polymer is a vinyl alcohol-vinyl acetate copolymer that is a PVOH copolymer, but is commonly referred to as “polyvinyl alcohol (PVOH)” or “the PVOH polymer.” For brevity, the term “PVOH polymer” used herein is understood to encompass a homopolymer, a copolymer, and a modified copolymer comprising vinyl alcohol moieties, for example, 50% or higher of vinyl alcohol moieties. The term “PVOH fiber” used herein refers to fiber comprising a PVOH polymer.

The fibers, foams, and/or films described herein can include one or more polyvinyl alcohol (PVOH) homopolymers, one or more polyvinyl alcohol copolymers, one or more modified polyvinyl alcohol copolymers, or a combination thereof. As used herein, the term “homopolymer” generally includes polymers having a single type of monomeric repeating unit (e.g., a polymeric chain consisting of or consisting essentially of a single monomeric repeating unit). For the particular case of PVOH, the term “PVOH polymer” further includes copolymers consisting of a distribution of vinyl alcohol monomer units and vinyl acetate monomer units, depending on the degree of hydrolysis (e.g., a polymeric chain consisting of or consisting essentially of vinyl alcohol and vinyl acetate monomer units). In the limiting case of 100% hydrolysis, a PVOH homopolymer can include a true homopolymer having only vinyl alcohol units. In some embodiments, the fibers, foams, and/or films of the disclosure include polyvinyl alcohol copolymers. In some embodiments, the fibers, foams, and/or films of the disclosure include cold-water soluble or hot water-soluble polyvinyl alcohol copolymers.

Unless expressly indicated otherwise, the term “degree of hydrolysis” is understood as a percentage (e.g., a molar percentage) of hydrolyzed moieties among all hydrolyzable moieties a polymer initially has. For example, for a polymer comprising at least one of a vinyl acetate moiety or a vinyl alcohol moiety, partial replacement of an ester group in vinyl acetate moieties with a hydroxyl group occurs during hydrolysis, and a vinyl acetate moiety becomes a vinyl alcohol moiety. The degree of hydrolysis of a polyvinyl acetate homopolymer is considered as zero, while the degree of hydrolysis of a polyvinyl alcohol homopolymer is considered as 100%. The degree of hydrolysis of a copolymer of vinyl acetate and vinyl alcohol is equal to a percentage of vinyl alcohol moieties among a total of vinyl acetate and vinyl alcohol moieties, and is between zero and 100%.

In some embodiments, the polyvinyl alcohol polymer includes a modified polyvinyl alcohol, for example, a copolymer. The modified polyvinyl alcohol can include a co-polymer or higher polymer (e.g., ter-polymer) including one or more monomers in addition to the vinyl acetate/vinyl alcohol groups. Optionally, the modification is neutral, e.g., provided by an ethylene, propylene, N-vinylpyrrolidone or other non-charged monomer species. Optionally, the modification is a cationic modification, e.g., provided by a positively charged monomer species. Optionally, the modification is an anionic modification. Thus, in some embodiments, the polyvinyl alcohol includes an anionic modified polyvinyl alcohol.

An anionic modified polyvinyl alcohol can include a partially or fully hydrolyzed PVOH copolymer that includes an anionic monomer unit, a vinyl alcohol monomer unit, and optionally a vinyl acetate monomer unit (i.e., when not completely hydrolyzed). In some embodiments, the modified PVOH copolymer can include two or more types of anionic monomer units. General classes of anionic monomer units which can be used for the PVOH copolymer include the vinyl polymerization units corresponding to sulfonic acid vinyl monomers and their esters, monocarboxylic acid vinyl monomers, their esters and anhydrides, dicarboxylic monomers having a polymerizable double bond, their esters and anhydrides, and alkali metal salts of any of the foregoing. Examples of suitable anionic monomer units include the vinyl polymerization units corresponding to vinyl anionic monomers including vinyl acetic acid, maleic acid, monoalkyl maleate, dialkyl maleate, maleic anhydride, fumaric acid, monoalkyl fumarate, dialkyl fumarate, itaconic acid, monoalkyl itaconate, dialkyl itaconate, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, alkyl acrylates, alkyl alkacrylates, vinyl sulfonic acid, allyl sulfonic acid, ethylene sulfonic acid, 2-acrylamido-1-methyl propane sulfonic acid, 2-acrylamide-2-methylpropanesulfonic acid, 2-methylacrylamido-2-methylpropanesulfonic acid (AMPS), 2-sulfoethyl acrylate, alkali metal salts of the foregoing (e.g., sodium, potassium, or other alkali metal salts), esters of the foregoing (e.g., methyl, ethyl, or other C1-C4 or C6 alkyl esters), and combinations of the foregoing (e.g., multiple types of anionic monomers or equivalent forms of the same anionic monomer). In some embodiments, the PVOH copolymer can include two or more types of monomer units selected from neutral, anionic, and cationic monomer units.

The level of incorporation of the one or more anionic monomer units in the PVOH copolymers is not particularly limited. In certain embodiments, the one or more anionic monomer units are present in the PVOH copolymer in an amount in a range of about 1 mol. % or 2 mol. % to about 6 mol. % or 10 mol. % (e.g., at least 1.0, 1.5, 2.0, 2.5, 3.0, 3.5, or 4.0 mol. % and/or up to about 3.0, 4.0, 4.5, 5.0, 6.0, 8.0, or 10 mol. % in various embodiments).

Polyvinyl alcohols can be subject to changes in solubility characteristics. The acetate group in the co-poly(vinyl acetate vinyl alcohol) polymer (PVOH copolymer) is known by those skilled in the art to be hydrolysable by either acid or alkaline hydrolysis. As the degree of hydrolysis increases, a polymer composition made from the PVOH copolymer will have increased mechanical strength but reduced solubility at lower temperatures (e.g., requiring hot water temperatures for complete dissolution). Accordingly, exposure of a PVOH homopolymer to an alkaline environment (e.g., resulting from a laundry bleaching additive) can transform the polymer from one which dissolves rapidly and entirely in a given aqueous environment (e.g., a cold-water medium) to one which dissolves slowly and/or incompletely in the aqueous environment, potentially resulting in undissolved polymeric residue.

The degree of hydrolysis (DH) of the PVOH homopolymers and PVOH copolymers (including modified PVOH copolymers) included in the water-soluble fibers, foams, and films of the present disclosure can be in a range of about 75% to about 99.9% (e.g., about 79% to about 92%, about 75% to about 89%, about 80% to about 90%, about 88% to 92%, about 86.5% to about 89%, or about 88%, 90% or 92% such as for cold-water-soluble compositions; about 90% to about 99.9%, about 90% to about 99% about 92% to about 99%, about 95% to about 99%, about 98% to about 99%, about 98% to about 99.9%, about 96%, about 98%, about 99%, or greater than 99%). As the degree of hydrolysis is reduced, a fiber, foam, or film made from the polymer will have reduced mechanical strength but faster solubility at temperatures below about 20° C. As the degree of hydrolysis increases, a fiber, foam, or film made from the polymer will tend to be mechanically stronger and the thermoformability will tend to decrease. The degree of hydrolysis of the PVOH can be chosen such that the water-solubility of the polymer is temperature dependent, and thus the solubility of a film, foam, or fiber made from the polymer and additional ingredients is also influenced. In certain embodiments, the film, foam, and/or fibers are cold water-soluble. For a co-poly(vinyl acetate vinyl alcohol) polymer that does not include any other monomers (e.g., a homopolymer not copolymerized with an anionic monomer) a cold water-soluble fiber, foam, or film, soluble in water at a temperature of less than 10° C., can include PVOH with a degree of hydrolysis in a range of about 75% to about 90%, about 75% to about 89%, or in a range of about 80% to about 90%, or in a range of about 85% to about 90%. In another embodiment, the fiber, foam, or film is hot water-soluble. For a co-poly(vinyl acetate vinyl alcohol) polymer that does not include any other monomers (e.g., a copolymer not copolymerized with an anionic monomer) a hot water-soluble fiber, foam, or film that is soluble in water at a temperature of at least about 60° C., can include PVOH with a degree of hydrolysis of at least about 98%. In example embodiments, one of more of the plurality of fibers comprise a polyvinyl alcohol polymer having a degree of hydrolysis in a range of about 75% to about 99.9%. In example embodiments, one or more of the plurality of fibers comprise a polyvinyl alcohol polymer having a degree of hydrolysis in a range of about 75% to about 98%. In example embodiments, one of more of the plurality of fibers comprise a polyvinyl alcohol polymer having a degree of hydrolysis in a range of about 75% to about 89%. In example embodiments, one of more of the plurality of fibers comprise a polyvinyl alcohol polymer having a degree of hydrolysis in a range of about 90% to about 99.9%. In example embodiments, the water-soluble film comprises a polyvinyl alcohol homopolymer or a PVOH copolymer having a degree of hydrolysis in a range of about 75% to about 99.9%. In example embodiments, the water-soluble film comprises a polyvinyl alcohol copolymer or a modified polyvinyl alcohol copolymer having a degree of hydrolysis in a range of about 75% to about 98%.

The degree of hydrolysis of a polymer blend can also be characterized by the arithmetic weighted, average degree of hydrolysis (H̅°̅). For example, H̅°̅ for a PVOH polymer that includes two or more PVOH polymers is calculated by the formula H̅°̅=Σ(Wᵢ·Hᵢ) where Wᵢ is the molar percentage of the respective PVOH polymer and Hᵢ is the respective degrees of hydrolysis. When a polymer is referred to as having (or not having) a specific degree of hydrolysis, the polymer can be a single polyvinyl alcohol polymer having the specified degree of hydrolysis or a blend of polyvinyl alcohol polymers having an average degree of hydrolysis as specified.

The viscosity of a PVOH polymer (μ) is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in Centipoise (cP) should be understood to refer to the viscosity of 4% aqueous polyvinyl alcohol solution at 20° C., unless specified otherwise. Similarly, when a polymer is described as having (or not having) a particular viscosity, unless specified otherwise, it is intended that the specified viscosity is the average viscosity for the polymer, which inherently has a corresponding molecular weight distribution, i.e., the weighted natural log average viscosity. It is well known in the art that the viscosity of PVOH polymers is correlated with the weight average molecular weight (M̅w) of the PVOH polymer, and often the viscosity is used as a proxy for the M̅w.

In example embodiments, the PVOH resin may have a viscosity of about 1.0 to about 50.0 cP, about 1.0 to about 40.0 cP, or about 1.0 to about 30.0 cP, for example, about 4 cP, 8 cP, 15 cP, 18 cP, 23 cP, or 26 cP. In example embodiments, the PVOH homopolymers and/or copolymers may have a viscosity of about 1.0 to about 40.0 cP, or about 5 cP to about 23 cP, for example, about 1 cP, 1.5 cP, 2 cP, 2.5 cP, 3 cP, 3.5 cP, 4 cP, 4.5 cP, 5 cP, 5.5 cP, 6 cP, 6.5 cP, 7 cP, 7.5 cP, 8 cP, 8.5 cP, 9 cP, 9.5 cP, 10 cP, 11 cP, 12 cP, 13 cP, 14 cP, 15 cP, 17.5 cP, 18 cP, 19 cP, 20 cP, 21 cP, 22 cP, 23 cP, 24 cP, 25 cP, 26 cP, 27 cP, 28 cP, 29 cP, 30 cP, 31 cP, 32 cP, 33 cP, 34 cP, 35 cP, or 40 cP. In example embodiments, the PVOH homopolymers and/or copolymers may have a viscosity of about 21 cP to 26 cP. In example embodiments, the PVOH homopolymers and/or copolymers can have a viscosity of about 5 cP to about 14 cP. In example embodiments, the PVOH homopolymers and/or copolymers can have a viscosity of about 5 cP to about 23 cP.

The water-soluble polymers, whether polyvinyl alcohol polymers or otherwise, can be blended. When the polymer blend includes a blend of polyvinyl alcohol polymers, the PVOH polymer blend can include a first PVOH polymer (“first PVOH polymer”) which can include a PVOH copolymer or a modified PVOH copolymer including one or more types of anionic monomer units (e.g., a PVOH ter- (or higher co-) polymer) and a second PVOH polymer (“second PVOH polymer”) which can include a PVOH copolymer or a modified PVOH copolymer including one or more types of anionic monomer units (e.g., a PVOH ter- (or higher co-) polymer). In some embodiments, the PVOH polymer blend includes only the first PVOH polymer and the second PVOH polymer (e.g., a binary blend of the two polymers). Alternatively, or additionally, the PVOH polymer blend or a fiber, foam, or film made therefrom can be characterized as being free or substantially free from other polymers (e.g., other water-soluble polymers generally, other PVOH-based polymers specifically, or both). As used herein, “substantially free” means that the first PVOH polymer and the second PVOH polymer make up at least 95 wt. %, at least 97 wt. %, or at least 99 wt. % of the total amount of water-soluble polymers in the water-soluble fiber, foam, or film. In other embodiments, the water-soluble fiber, foam, or film can include one or more additional water-soluble polymers. For example, the PVOH polymer blend can include a third PVOH polymer, a fourth PVOH polymer, a fifth PVOH polymer, etc. (e.g., one or more additional PVOH copolymers or modified PVOH copolymers, with or without anionic monomer units). For example, the water-soluble fiber or film can include at least a third (or fourth, fifth, etc.) water-soluble polymer which is other than a PVOH polymer (e.g., other than PVOH copolymers or modified PVOH copolymers, with or without anionic monomer units). A PVOH homopolymer may also be included in each blend.

### Biodegradability

Polyvinyl alcohol polymers are generally biodegradable as they decompose in the presence of water and enzymes under aerobic, anaerobic, soil, and compost conditions. In general, as the degree of hydrolysis of a polyvinyl alcohol polymer increases up to about 80%, the biodegradation activity of the polyvinyl alcohol polymer increases. Without intending to be bound by theory, it is believed that increasing the degree of hydrolysis above 80% does not appreciably affect biodegradability. Additionally, the stereoregularity of the hydroxyl groups of polyvinyl alcohol polymers has a large effect on the biodegradability activity level and the more isotactic the hydroxyl groups of the polymer sequence, the higher the degradation activity becomes. Without intending to be bound by theory, for soil and/or compost biodegradation, it is believed that a nonwoven substrate or nonwoven web prepared from a polyvinyl alcohol fiber will have higher biodegradation activity levels relative to a water-soluble film prepared from a similar polyvinyl alcohol polymer, due to the increase in the polymer surface area provided by the nonwoven substrate or nonwoven web relative to a film. Further, without intending to be bound by theory, it is believed that while the degree of polymerization of the polyvinyl alcohol polymer has little to no effect on the biodegradability of a film, foam, or nonwoven substrate or web prepared with the polymer, the polymerization temperature may have an effect on the biodegradability of a film, foam substrate, or nonwoven substrate because the polymerization temperature can affect the crystallinity and aggregating status of a polymer. As the crystallinity decreases, the polymer chain hydroxyl groups become less aligned in the polymer structure and the polymer chains become more disordered allowing for chains to accumulate as amorphous aggregates, thereby decreasing availability of ordered polymer structures such that the biodegradation activity is expected to decrease for soil and/or compost biodegradation mechanisms wherein the polymer is not dissolved. Without intending to be bound by theory, it is believed that because the stereoregularity of the hydroxyl groups of polyvinyl alcohol polymers has a large effect on biodegradability activity levels, the substitution of functionalities other than hydroxyl groups (e.g., anionic AMPS functional groups, carboxylate groups, or lactone groups) is expected to decrease the biodegradability activity level, relative to a polyvinyl alcohol copolymer having the same degree of hydrolysis, unless the functional group itself is also biodegradable, in which case biodegradability of the polymer can be increased with substitution. Further, it is believed that while the biodegradability activity level of a substituted polyvinyl alcohol can be less than that of the corresponding homopolymer or copolymer, the substituted polyvinyl alcohol will still exhibit biodegradability.

Methods of determining biodegradation activity are known in the art, for example, as described in Chiellini et al., Progress in Polymer Science, Volume 28, Issue 6, 2003, pp. 963-1014, which is incorporated herein by reference in its entirety. Further methods and standards can be found in ECHA's Annex XV Restriction Report—Microplastics, Version number 1, Jan. 11, 2019, which is incorporated herein by reference in its entirety. Suitable standards include OECD 301B (ready biodegradation), OECD 301B (enhanced biodegradation), OECD 302B (inherent biodegradation), OECD 311 (anaerobic), and ASTM D5988 (soil).

In example embodiments, the fibers described herein can be of the standard ready biodegradation or enhanced degradation. As used herein, the term “ready biodegradation” refers to a standard that is met if the material (e.g., a fiber) reached 60% biodegradation (mineralization) within 28 days of the beginning of the test, according to the OECD 301B test as described in the ECHA's Annex XV. As used herein, the term “enhanced biodegradation” refers to a standard that is met if the material (e.g., a fiber) reaches 60% biodegradation within 60 days from the beginning of the test, according to the OECD 301B test as described in the ECHA's Annex XV. In example embodiments, the fibers meet the standards of ready biodegradation.

### Carrier Solvent

In example embodiments, the carrier solvent comprises a polar solvent. In example embodiments, the solvent comprises octanol, heptanol, hexanol, pentanol, butanol, propanol, tetrahydrofuran, dichloromethane, acetone, ethanol, N-methylpyrrolidone, methanol, acetonitrile, ethylene glycol, N,N-dimethylformamide, glycerol, dimethyl sulfoxide, formic acid, water, or a combination thereof. In example embodiments, the carrier solvent comprises n-octanol, n-heptanol, n-hexanol, n-pentanol, n-butanol, isobutanol, sec-butanol, tert-butanol, n-propanol, isopropanol, acetone, ethanol, N-methylpyrrolidone, methanol, acetonitrile, N,N-dimethylformamide, dimethyl sulfoxide, formic acid, water, or a combination thereof. In example embodiments, the carrier solvent comprises n-propanol, acetone, ethanol, N-methylpyrrolidone, methanol, acetonitrile, N,N-dimethylformamide, dimethyl sulfoxide, formic acid, water, or a combination thereof. In example embodiments, the carrier solvent comprises an alcohol that is a liquid under the admixing conditions. In example embodiments, the carrier solvent comprises methanol. In example embodiments, the carrier solvent comprises methanol and at least one additional solvent. In embodiments, the carrier solvent comprises methanol and water. In example embodiments, the carrier solvent comprises at least one of butanol, pentanol, hexanol, heptanol, and octanol in combination with water. In example embodiments, the carrier solvent comprises DMSO and water. In example embodiments, the carrier solvent comprises DMSO and water and the DMSO and water are provided in a weight ratio of about 40/60 to 80/20. Without intending to be bound by theory, it is believed that as the amount of water increases above 60% or the amount of DMSO increases above about 80%, the interaction of the respective solvents with polyvinyl alcohol increases, resulting in increased swelling and gelling of the polymer.

In example embodiments, the carrier solvent comprises a nonpolar solvent. In example embodiments, the carrier solvent comprises hexanes, cyclohexane, methylpentane, pentane, cyclopropane, dioxane, benzene, pyridine, xylene, toluene, diethyl ether, chloroform, or a combination thereof.

In example embodiments, the carrier solvent comprises a mixture of a first carrier solvent and a second carrier solvent. In example embodiments, the first carrier solvent comprises a polar solvent and the second carrier solvent comprises a nonpolar solvent. In example embodiments, the first carrier solvent has a first dielectric constant and the second carrier solvent has a second dielectric constant and the dielectric constant of the first carrier solvent is different from, e.g., higher than, the dielectric constant of the second carrier solvent. In example embodiments, the first dielectric constant is 5 or less, 4 or less, 3 or less, or 2 or less. In example embodiments, the second dielectric constant is greater than 5, greater than 7.5, greater than 10, greater than 15, greater than 18, greater than 20, greater than 25, or greater than 30. In example embodiments, the difference between the first dielectric constant and the second dielectric constant is at least 3, at least 5, at least 8, or at least 10. In example embodiments, wherein the carrier solvent comprises a mixture of a first carrier solvent and a second carrier solvent, the first carrier solvent and the second carrier solvent can be provided in any ratio provided the fiber is not soluble in the mixture prior to treatment, during treatment, and after treatment. In example embodiments, the first carrier solvent and the second carrier solvent can be provided in a weight ratio of about 99/1 to about 1/99, about 95/5 to about 5/95, about 90/10 to 10/90, about 85/15 to about 15/85, about 80/20 to about 20/80, about 75/25 to about 25/75, about 70/30 to about 30/70, about 65/35 to about 35/65, about 60/40 to about 40/60, about 55/45 to about 45/55, or about 50/50.

### Active Cleaning Formulations

In example embodiments, the article and, more specifically, the water-dispersible and/or water-soluble core substrate, is configured to contain a carrier solvent with one or more active cleaning formulations, such as a dish wash detergent formulation. In example embodiments, the carrier solvent with the active cleaning formulation is disposed on, e.g., applied to or coated on, one or more surfaces of the core substrate or is embedded in and/or adhered to the core substrate. The core substrate may include a single layer, for example, a single layer nonwoven core substrate, or may include a plurality of layers, for example, a sheet of nonwoven core substrate folded in a serpentine arrangement or plied to form layers with the carrier solvent with the active cleaning formulation disposed between adjacent layers of the nonwoven core substrate, for example. As an example, the active cleaning formulation may include, without limitation, an active, a sanitizing agent and/or a dish detergent, soap or cleaner. Other examples include a laundry detergent, a soap, a fabric softener, a bleaching agent, a laundry booster, a stain remover, an optical brightener, or a water softener, a shampoo, a conditioner, a body wash, a face wash, a skin lotion, a skin treatment, a body oil, fragrance, a hair treatment, a bath salt, an essential oil, a bath bomb, or an enzyme.

### Auxiliary Agents

In general, along with the film-forming, foam-forming, and/or fiber-forming material, the fibers, nonwoven substrates or webs, foam substrates, and/or water-soluble films of the disclosure can include auxiliary agents such as, but not limited to, sanitizers or sanitizing agents, plasticizers, plasticizer compatibilizers, surfactants, lubricants, release agents, fillers, extenders, cross-linking agents, antiblocking agents, antioxidants, detackifying agents, antifoams, nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes. Suitable sanitizing agents include, without limitation, one or more of the following sanitizing agents: Quaternary Ammonium Compounds (QACs), halogenated oxidizers, hypochlorous acid generating compounds, hypochlorite generating compounds, 1-Bromo-3-chloro-5,5-dimethylhydantoin, dichloroisocyanuric acid, alcohols including, without limitation, methanol, ethanol, isopropyl alcohol, and/or other longer chain alcohols, oxygen radical generators, hydrogen peroxide (H₂O₂), sulfate generating compounds, Methylisothiazolinone (MIT), Benzisothiazolinone (BIT), or sodium metabisulfite. As used herein and unless specified otherwise, “auxiliary agents” include secondary additives, processing agents, and active agents. Specific such auxiliary agents can be selected from those suitable for use in water-soluble fibers, non-water-soluble fibers, nonwoven webs, foams, or those suitable for use in water-soluble films.

In example embodiments, the fibers, foams, and/or films can be free of auxiliary agents. As used herein and unless specified otherwise, “free of auxiliary agents” with respect to the fiber means that the fiber includes less than about 0.01 wt. %, less than about 0.005 wt. %, or less than about 0.001 wt. % of auxiliary agents, based on the total weight of the fiber. As used herein and unless specified otherwise, “free of auxiliary agents” with respect to the nonwoven substrate or web means that the nonwoven substrate or web includes less than about 0.01 wt. %, less than about 0.005 wt. %, or less than about 0.001 wt. % of auxiliary agents, based on the total weight of the nonwoven substrate or web. In example embodiments, the water-soluble fibers comprise a plasticizer. In example embodiments, the water-soluble fibers comprise a surfactant. In example embodiments, the non-water-soluble fibers comprise a plasticizer. In example embodiments, the non-water-soluble fibers comprise a surfactant. In example embodiments, the nonwoven substrate or web includes a plasticizer. In example embodiments, the nonwoven substrate or web includes a surfactant.

A plasticizer is a liquid, solid, or semi-solid that is added to a material (usually a resin or elastomer) making that material softer, more flexible (by decreasing the glass-transition temperature of the polymer), and easier to process. A polymer can alternatively be internally plasticized by chemically modifying the polymer or monomer. In addition, or in the alternative, a polymer can be externally plasticized by the addition of a suitable plasticizing agent. Water is recognized as a very efficient plasticizer for PVOH polymer and other polymers including, but not limited to, water-soluble polymers; however, the volatility of water makes its utility limited because polymer films need to have at least some resistance (robustness) to a variety of ambient conditions including low and high relative humidity.

The plasticizer can include, without limitation, glycerin, diglycerin, sorbitol, xylitol, maltitol, ethylene glycol, diethylene glycol, triethylene glycol, dipropylene glycol, tetraethylene glycol, propylene glycol, polyethylene glycols up to 1000 MW, neopentyl glycol, trimethylolpropane, polyether polyols, sorbitol, 2-methyl-1,3-propanediol (MPDiol®), ethanolamines, and a mixture thereof.

Surfactants for use in films are well known in the art and can suitably be used in the fibers, foam, films, and/or compositions of the disclosure. Optionally, surfactants are included to aid in the dispersion of the fibers during carding. Optionally, surfactants are included as cleaning aids. Suitable surfactants can include the nonionic, cationic, anionic and zwitterionic classes. Suitable surfactants include, but are not limited to, propylene glycols, diethylene glycols, monoethanolamine, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), alkali metal salts of higher fatty acids containing about 8 to 24 carbon atoms, alkyl sulfates, alkyl polyethoxylate sulfates and alkylbenzene sulfonates (anionics), and amine oxides, N-alkylbetaines and sulfobetaines (zwitterionics). Other suitable surfactants include dioctyl sodium sulfosuccinate, lactylated fatty acid esters of glycerin and propylene glycol, lactylic esters of fatty acids, sodium alkyl sulfates, polysorbate 20, polysorbate 60, polysorbate 65, polysorbate 80, lecithin, acetylated fatty acid esters of glycerin and propylene glycol, and odium lauryl sulfate, acetylated esters of fatty acids, myristyl dimethylamine oxide, trimethyl tallow alkyl ammonium chloride, quaternary ammonium compounds, alkali metal salts of higher fatty acids containing about 8 to 24 carbon atoms, alkyl sulfates, alkyl polyethoxylate sulfates, alkylbenzene sulfonates, monoethanolamine, lauryl alcohol ethoxylate, propylene glycol, diethylene glycol, sodium cocoyl isethionate, sodium lauryl sulfate, glucotain, phoenamids, cola lipid, cocamides, such as cocamide ethanolamines, ethylene oxide based surfactants, saponified oils of avocado and palm, salts thereof and combinations of any of the foregoing. In example embodiments, the surfactant comprises a cocamide. Without intending to be bound by theory, it is believed that a cocamide can aid in foam formation, enhancing the foaming experience of an article comprising a personal care composition. In various embodiments, the amount of surfactant in the fiber is in a range of about 0.01 wt. % to about 10 wt. %, about 0.1 wt. % to about 5 wt. %, about 1.0 wt. % to about 2.5 wt. %, about 0.01 wt. % to about 1.5 wt. %, about 0.1 wt. % to about 1 wt. %, about 0.01 wt. % to 0.25 wt. %, or about 0.10 wt. % to 0.20 wt. %.

In example embodiments, the nonwoven substrates or webs, foam, and/or films of the disclosure can further comprise auxiliary agents such as one or more auxiliary agents in the group of: an exfoliant (chemical exfoliants and mechanical exfoliants), a fragrance and/or perfume microcapsule, an aversive agent, a surfactant, a colorant, an enzyme, a skin conditioner, a de-oiling agent, and a cosmetic agent.

In example embodiments, an auxiliary agent is provided in or on one or more of the nonwoven web, the foam, the plurality of fibers, and the water-soluble film. In example embodiments, an active cleaning formulation is provided on or in one or more of the group of the nonwoven web, the plurality of fibers, and the water-soluble film. In example embodiments, one or more auxiliary agents can be provided on the surface of the nonwoven web. In example embodiments, one or more auxiliary agents can be dispersed among the fibers of the nonwoven web. In example embodiments, one or more auxiliary agents can be dispersed on a face of the nonwoven web. In example embodiments, one or more auxiliary agents can be dispersed in the fibers. In example embodiments, one or more auxiliary agents can be dispersed on the fibers. In example embodiments, one or more auxiliary agents can be provided on a face of the water-soluble film.

The chemical exfoliants, mechanical exfoliants, fragrances and/or perfume microcapsules, aversive agents, surfactants, colorants, proteins, peptides, enzymes, skin conditioners, de-oiling agents, cosmetic agents, or a combination thereof, when present, can be provided in an amount of at least about 1 wt. %, or in a range of about 1 wt. % to about 99 wt. % based on the weight of the polymeric mixture (e.g., fiber forming material or film forming material). In example embodiments, the chemical exfoliants, mechanical exfoliants, fragrances and/or perfume microcapsules, aversive agents, surfactants, colorants, enzymes, skin conditioners, de-oiling agents, and/or cosmetic agents can be provided in an amount sufficient to provide additional functionality to the fiber and/or film, such as exfoliation of human skin. The chemical exfoliants, mechanical exfoliants, fragrances and/or perfume microcapsules, aversive agents, surfactants, colorants, enzymes, skin conditioners, de-oiling agents, cosmetic agents, or a combination thereof, can take any desired form, including as a solid (e.g., powder, granulate, crystal, flake, or ribbon), a liquid, a mull, a paste, a gas, etc., and optionally can be encapsulated, such as microcapsules.

In certain embodiments, the nonwoven substrate or web, foam, and/or film can comprise an enzyme. Suitable enzymes include enzymes categorized in any one of the six conventional Enzyme Commission (EC) categories, i.e., the oxidoreductases of EC 1 (which catalyze oxidation/reduction reactions), the transferases of EC 2 (which transfer a functional group, e.g., a methyl or phosphate group), the hydrolases of EC 3 (which catalyze the hydrolysis of various bonds), the lyases of EC 4 (which cleave various bonds by means other than hydrolysis and oxidation), the isomerases of EC 5 (which catalyze isomerization changes within a molecule) and the ligases of EC 6 (which join two molecules with covalent bonds). Examples of such enzymes include dehydrogenases and oxidases in EC 1, transaminases and kinases in EC 2, lipases, cellulases, amylases, mannanases, and peptidases (a.k.a. proteases or proteolytic enzymes) in EC 3, decarboxylases in EC 4, isomerases and mutases in EC 5 and synthetases and synthases of EC 6. Suitable enzymes from each category are described in, for example, U.S. Pat. No. 9,394,092, the entire disclosure of which is herein incorporated by reference. In certain embodiments, enzymes can include bromeline (pineapple extract), papain (papaya), ficin (fig), actinidin (kiwi), hyaluronidase, lipase, peroxidase, superoxide dismutase, tyrosinase, alkaline phosphatase, or a combination thereof. In example embodiments, the enzyme can be encapsulated in the form of, for example, nanoemulsions, nanocapsules, granules or a combination thereof.

Enzymes for use in laundry and dishwashing applications can include one or more of protease, amylase, lipase, dehydrogenase, transaminase, kinase, cellulase, mannanase, peptidase, decarboxylase, isomerase, mutase, synthetase, synthase, and oxido-reductase enzymes, including oxido-reductase enzymes that catalyze the formation of bleaching agents.

It is contemplated that an enzyme for use herein can come from any suitable source or combination of sources, for example, bacterial, fungal, plant, or animal sources. In one embodiment, a mixture of two or more enzymes will come from at least two different types of sources. For example, a mixture of protease and lipase can come from a bacterial (protease) and fungal (lipase) sources.

Optionally, an enzyme for use herein, including but not limited to any enzyme class or member described herein, is one which works in alkaline pH conditions, e.g., a pH in a range of about 8 to about 11. Optionally, an enzyme for use herein, including but not limited to any enzyme class or member described herein, is one which works in a temperature in a range of about 5° C. to about 45° C.

In example embodiments, the nonwoven substrate or web, foam, and/or film can comprise a protein and/or peptide. Suitable proteins and/or peptides can include, but are not limited to, collagen and/or collagen peptides, or amino acids, for example, aspartic acid, glutamic acid, serine, histidine, glycine, threonine, arginine, alanine, tyrosine, cysteine, valine, methionine, phenylalanine, isoleucine, leucine, lysine, hydroxyproline, or proline.

In example embodiments, the nonwoven substrate or web, foam, and/or film can comprise a colorant. Suitable colorants can include an indicator dye, such as a pH indicator (e.g., thymol blue, bromothymol, thymolphthalein, and thymolphthalein), a moisture/water indicator (e.g., hydrochromic inks or leuco dyes), or a thermochromic ink, wherein the ink changes color when temperature increases and/or decreases. Suitable colorants include, but are not limited to a triphenylmethane dye, an azo dye, an anthraquinone dye, a perylene dye, an indigoid dye, a food, drug and cosmetic (FD&C) colorant, an organic pigment, an inorganic pigment, or a combination thereof. Examples of colorants include, but are not limited to, FD&C Red #40; Red #3; FD&C Black #3; Black #2; Mica-based pearlescent pigment; FD&C Yellow #6; Green #3; Blue #1; Blue #2; titanium dioxide (food grade); brilliant black; and a combination thereof. Other examples of suitable colorants can be found in U.S. Pat. No. 5,002,789, hereby incorporated by reference in its entirety.

Other embodiments can include one or more fragrances in the nonwoven substrate or webs, foams, and/or films of the disclosure. As used herein, the term “fragrance” refers to any applicable material that is sufficiently volatile to produce a scent. Embodiments including fragrances can include fragrances that are scents pleasurable to humans, or alternatively fragrances that are scents repellant to humans, animals, and/or insects. Suitable fragrances include, but are not limited to, fruits including, but not limited to, lemon, apple, cherry, grape, pear, pineapple, orange, strawberry, raspberry, musk, and flower scents including, but not limited to, lavender-like, rose-like, iris-like and carnation-like. Optionally, the fragrance is one which is not also a flavoring. Other fragrances include herbal scents including, but not limited to, rosemary, thyme, and sage; and woodland scents derived from pine, spruce, and other forest smells. Fragrances may also be derived from various oils, including, but not limited to, essential oils, or from plant materials including, but not limited to, peppermint, spearmint, and the like or any combination thereof. Suitable fragrant oils can be found in U.S. Pat. No. 6,458,754, hereby incorporated by reference in its entirety. Suitable fragrant oils include, but are not limited to, 4-(2,2,6-trimethylcyclohex-1-enyl)-2-en-4-one, acetaldehyde phenylethyl propyl acetal, 2,6,10-trimethyl-9-undecenal, hexanoic acid 2-propenyl ester, 1-octen-3-ol, trans-anethole, iso butyl (z)-2-methyl-2-butenoate, anisaldehyde diethyl acetal, 3-methyl-5-propyl-cyclohezen-1-one, 2,4-dimethyl-3-cyclohexene-1-carbaldehyde, trans-4-decenal, decanal, 2-pentylcyclopentanone, ethyl anthranilate, eugenol, 3-(3-isopropylphenyl)butanal, methyl 2-octynoate, isoeugenol, cis-3-hexenyl methyl carbonate, linalool, methyl-2-nonynonate, benzoic acid 2-hydroxymethyl ester, nonal, octanal, 2-nonennitrile, 4-nonanolide, 9-decen-1-ol, and 10-undecen-1-al. Applicable fragrances can also be found in U.S. Pat. Nos. 4,534,981; 5,112,688; 5,145,842; 6,844,302; and Perfumes Cosmetics and Soaps, Second Edition, edited by W. A. Poucher, 1959, all hereby incorporated by reference in their entireties. These fragrances include acacia, cassie, chypre, cyclamen, fern, gardenia, hawthorn, heliotrope, honeysuckle, hyacinth, jasmine, lilac, lily, magnolia, mimosa, narcissus, freshly-cut hay, orange blossom, orchids, reseda, sweet pea, trefle, tuberose, vanilla, violet, wallflower, and the like or any combination thereof.

Fragrances can include perfumes. The perfume may comprise neat perfume, encapsulated perfume, or mixtures thereof. In example embodiments, the perfume includes neat perfume. A portion of the perfume may be encapsulated in a core-shell encapsulate. In other embodiments, the perfume will not be encapsulated in a core/shell encapsulate.

As used herein, the term “perfume” encompasses the perfume raw materials (PRMs) and perfume accords. The term “perfume raw material” as used herein refers to compounds having a molecular weight of at least about 100 g/mol and which are useful in imparting an odor, fragrance, essence or scent, either alone or with other perfume raw materials. As used herein, the terms “perfume ingredient” and “perfume raw material” are interchangeable. The term “accord” as used herein refers to a mixture of two or more PRMs. In example embodiments, any of the perfume accords, perfume raw materials, or fragrances can be encompassed in a microcapsule, termed “perfume microcapsules” as used herein.

Typical PRM comprise inter alia alcohols, ketones, aldehydes, esters, ethers, nitrites, and alkenes, such as terpene. A listing of common PRMs can be found in various reference sources, for example, “Perfume and Flavor Chemicals,” Vols. I and II; Steffen Arctander Allured Pub. Co. (1994) and “Perfumes: Art, Science and Technology,” Miller, P. M. and Lamparsky, D., Blackie Academic and Professional (1994). The PRMs are characterized by their boiling points (B.P.) measured at the normal pressure (760 mm Hg), and their octanol/water partitioning coefficient (P). Based on these characteristics, the PRMS may be categorized as Quadrant I, Quadrant II, Quadrant III, or Quadrant IV perfumes.

In example embodiments, the nonwoven web, foam, and/or film can include an exfoliant. In example embodiments, the exfoliant can comprise a chemical exfoliant or a mechanical exfoliant. Suitable mechanical exfoliants for use herein can include, but are not limited to, apricot shells, sugar, oatmeal, salt, silica, diatomaceous earth, clay, aluminum hydrates, PVOH microbeads, pumice, or a combination thereof. Suitable chemical exfoliants for use herein can include, but are not limited to, alpha hydroxyl acid, beta hydroxyl acid, enzyme, salicylic acid, glycolic acid, citric acid, malic acid, or a combination thereof.

In certain embodiments, the aversive agents, surfactants, colorants, enzymes, skin conditioners, de-oiling agents, cosmetic agents, or a combination thereof, are encapsulated, allowing for controlled release. Suitable microcapsules can include or be made from one or more of melamine formaldehyde, polyurethane, urea formaldehyde, chitosan, polymethyl methacrylate, polystyrene, polysulfone, poly tetrahydrofuran, gelatin, gum arabic, starch, polyvinyl pyrrolidone, carboxymethylcellulose, hydroxyethylcellulose, methylcellulose, arabinogalactan, polyvinyl alcohol, polyacrylic acid, ethylcellulose, polyethylene, polymethacrylate, polyamide, poly (ethylenevinyl acetate), cellulose nitrate, silicones, poly(lactideco-glycolide), paraffin, carnauba, spermaceti, beeswax, stearic acid, stearyl alcohol, glyceryl stearates, shellac, cellulose acetate phthalate, zein, and combinations thereof. In one type of embodiment, the microcapsule is characterized by a mean particle size (e.g., Dv50) of at least about 0.1 micron, or in a range of about 0.1 micron to about 200 microns, for example. In alternate embodiments, the microcapsules can form agglomerates of individual particles, for example wherein the individual particles have a mean particle size of at least about 0.1 micron, or in a range of about 0.1 micron to about 200 microns.

Water-Dispersible and/or Water-Soluble Fibers

As described, fibers used for making a core substrate are water-dispersible and/or water-soluble. The fibers may be dispersible at a lower temperature (e.g., 10-40° C.) and soluble in water at a higher temperature (e.g., above 40° C.). Such fibers are referred as water-soluble fibers for the conciseness of the description. Water-soluble fibers include fibers and/or fiber forming materials made of any material that, when provided as the sole resin in a film or foam, or sole fiber forming material in a nonwoven, the film, foam, or nonwoven dissolves in 300 seconds or less at temperatures of 80° C. or less, as determined by MSTM-205. The water-soluble fibers can include a single water-soluble polymer or a blend of water-soluble polymers. Suitable water-soluble polymers include, but are not limited to, polyvinyl alcohol homopolymer, polyvinyl alcohol copolymer, modified polyvinyl alcohol copolymer, polyacrylate, water-soluble acrylate copolymer, polyvinyl pyrrolidone, polyethyleneimine, pullulan, water-soluble natural polymer including, but not limited to, guar gum, gum Acacia, xanthan gum, carrageenan, and starch, water-soluble polymer derivatives including, but not limited to, modified starches, ethoxylated starch, and hydroxypropylated starch, copolymers of the forgoing and combinations of any of the foregoing. Yet other water-soluble fibers can include polyalkylene oxides, polyacrylamides, polyacrylic acids and salts thereof, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, and combinations of any of the foregoing. In example embodiments, the water-soluble fibers can include a PVOH copolymer fiber forming material, modified PVOH copolymer fiber forming material, or a combination thereof. In example embodiments, the water-soluble fibers can comprise a sole PVOH homopolymer fiber forming material or a blend of PVOH copolymer fiber forming materials. In example embodiments, the water-soluble fibers can comprise a hot water-soluble PVOH homopolymer fiber forming material. In further embodiments, the water-soluble fibers can comprise a PVOH copolymer fiber forming material with a viscosity in a range of 5 cP to 23 cP and a degree of hydrolysis in a range of 86% to 92%.

In example embodiments, the water-soluble fibers can include an auxiliary agent as described above. In example embodiments, the water-soluble fibers can be substantially free of auxiliary agents as described above. In example embodiments, the water-soluble fibers can include a plasticizer as described above. The total amount of the non-water plasticizer provided in the water-soluble fiber can be in a range of about 1 wt. % to about 45 wt. %, or about 5 wt. % to about 45 wt. %, or about 10 wt. % to about 40 wt. %, or about 20 wt. % to about 30 wt. %, about 1 wt. % to about 4 wt. %, or about 1.5 wt. % to about 3.5 wt. %, or about 2.0 wt. % to about 3.0 wt. %, for example about 1 wt. %, about 2.5 wt. %, about 5 wt. %, about 10 wt. %, about 15 wt. %, about 20 wt. %, about 25 wt. %, about 30 wt. %, about 35 wt. %, or about 40 wt. %, based on total fiber weight. In example embodiments, the water-soluble fibers comprise glycerin, sorbitol, or a combination thereof. In example embodiments, the water-soluble fibers comprise glycerin. In example embodiments, the water-soluble fibers comprise sorbitol. In certain embodiments, the water-soluble fibers can include glycerin, for example, in about 10 wt. % based on total fiber weight, and sorbitol, for example, in about 5 wt. % based on the total fiber weight.

In example embodiments, the water-soluble fibers can include a surfactant as described above. In various embodiments, the amount of surfactant in the water-soluble fiber is in a range of about 0.01 wt. %, to about 2.5 wt. %, about 0.1 wt. % to about 2.5 wt. %, about 1.0 wt. % to about 2.0 wt. %, about 0.01 wt. % to 0.25 wt. %, or about 0.10 wt. % to 0.20 wt. %.

In example embodiments, any of the auxiliary agents disclosed herein can be added to the fibers of the disclosure. In refinements of the forgoing embodiment, the auxiliary agents can be added to the fiber forming material prior to formation of the fiber such that the auxiliary agents are dispersed in the fiber. In addition, and/or in the alternative, auxiliary agents can be added to the surface of a fiber after fiber formation (e.g., dispersed on the fibers).

When included in the water-soluble fiber, a colorant can be provided in an amount of 0.01% to 25% by weight of the polymer mixture, such as, 0.02%, 0.05%, 0.1%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, and 24% by weight of the polymer mixture.

### Non-Water-Soluble Fibers

Non-water-soluble fibers generally include fibers and/or fiber forming materials made of any material that, when provided in a film as the sole film forming material or provided in a nonwoven web or foam as the sole fiber forming material, the film, the nonwoven web, or the foam does not dissolve in 300 seconds or less at temperatures of 80° C. or less, as determined by MSTM-205. The non-water-soluble fibers can include a sole non-water-soluble polymer fiber forming material or a blend of non-water-soluble polymer fiber forming materials. Suitable non-water-soluble fibers and/or non-water-soluble fiber forming materials include, but are not limited to, cotton, polyester, polyethylene (e.g., high density polyethylene and low density polyethylene), polypropylene, wood pulp, fluff pulp, abaca, viscose, polylactic acid, polyester, nylon 6, insoluble cellulose, insoluble starch, hemp, jute, flax, ramie, sisal, bagasse, banana fiber, lacebark, silk, sinew, catgut, wool, sea silk, mohair, angora, cashmere, collagen, actin, nylon, dacron, rayon, bamboo fiber, modal, diacetate fiber, triacetate fiber, and combinations thereof. In example embodiments, the non-water-soluble fiber forming material and/or non-water-soluble fibers comprise one or more of the group of: cotton, hemp, jute, flax, ramie, sisal, bagasse, banana, lacebark, silk, sinew, catgut, wool, sea silk, mohair, angora, cashmere, collagen, actin, nylon, dacron, rayon, bamboo, modal, diacetate fiber, triacetate fiber, or a combination thereof.

In example embodiments, the non-water-soluble fibers can include an auxiliary agent as described above. In example embodiments, the non-water-soluble fibers can be substantially free of auxiliary agents as described above. In example embodiments, the non-water-soluble fibers can include a plasticizer as described above. The total amount of the non-water plasticizer provided in the non-water-soluble fiber can be in a range of about 1 wt. % to about 45 wt. %, or about 5 wt. % to about 45 wt. %, or about 10 wt. % to about 40 wt. %, or about 20 wt. % to about 30 wt. %, about 1 wt. % to about 4 wt. %, or about 1.5 wt. % to about 3.5 wt. %, or about 2.0 wt. % to about 3.0 wt. %, for example, about 1 wt. %, about 2.5 wt. %, about 5 wt. %, about 10 wt. %, about 15 wt. %, about 20 wt. %, about 25 wt. %, about 30 wt. %, about 35 wt. %, or about 40 wt. %, based on total fiber weight. In example embodiments, the non-water-soluble fibers comprise glycerin, sorbitol, or a combination thereof. In example embodiments, the non-water-soluble fibers comprise glycerin. In example embodiments, the non-water-soluble fibers comprise sorbitol. In certain embodiments, the non-water-soluble fibers can include a plasticizer such as glycerin, for example in about 10 wt % based on total fiber weight, and sorbitol, for example in about 5 wt % based on the total fiber weight.

In example embodiments, the non-water-soluble fibers can include a surfactant as described above. In various embodiments, the amount of surfactant in the water-soluble fiber is in a range of about 0.01 wt. %, to about 2.5 wt. %, about 0.1 wt. % to about 2.5 wt. %, about 1.0 wt. % to about 2.0 wt. %, about 0.01 wt. % to 0.25 wt. %, or about 0.10 wt. % to 0.20 wt. %.

In example embodiments, any of the auxiliary agents disclosed herein can be added to the fibers of the disclosure. In refinements of the forgoing embodiment can be added to the fiber forming material prior to formation of the fiber such that the auxiliary agents can be added to the surface of a fiber after fiber formation. In refinements of the foregoing embodiments, the auxiliary agents can be added to a surface of the fiber after fiber formation.

When included in the non-water-soluble fiber, the colorant can be provided in an amount of 0.01% to 25% by weight of the polymer mixture, such as, 0.02%, 0.05%, 0.1%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, and 24% by weight of the polymer mixture.

### Nonwoven Webs or Nonwoven Substrates

The nonwoven web or nonwoven substrates of the disclosure can be water-soluble (or water dispersible), non-water-soluble, or at least partially non-water-soluble. The article of the disclosure can include a nonwoven web, wherein at least a portion of the nonwoven web is soluble in water at a temperature in a range of about 0° C. to about 20° C. according to MSTM-205, or at least a portion of the nonwoven web is not soluble in water at a temperature of 20° C. or less according to MSTM-205, or the nonwoven web is not soluble in water at a temperature of 20° C. or less according to MSTM-205, or the nonwoven web is soluble in water at a temperature in a range of about 0° C. to about 20° C. according to MSTM-205. It will be understood that “at least a portion” of a nonwoven web is soluble (or not soluble) at a given temperature if the nonwoven web includes in the plurality of the fibers, a fiber type which when provided in a nonwoven as the sole fiber type, the nonwoven web consisting of that fiber type is soluble (or not soluble) at the given temperature, according to MSTM-205.

The nonwoven web of the disclosure includes a plurality of fibers. A nonwoven web refers to an arrangement of fibers bonded to one another, wherein the fibers are neither woven nor knitted. The plurality of fibers can be arranged in any orientation. In example embodiments, the plurality of fibers are arranged randomly (i.e., do not have an orientation). In example embodiments, the plurality of fibers are arranged in a unidirectional orientation. In example embodiments, the plurality of fibers are arranged in a bidirectional orientation. In some embodiments, the plurality of fibers are multi-directional, having different arrangements in different areas of the nonwoven web.

The plurality of fibers in any given nonwoven web can include any fiber-forming materials disclosed herein. The nonwoven web can include (1) a single fiber type including a single fiber forming material, (2) a single fiber type including a blend of fiber forming materials, (3) a blend of fiber types, each fiber type including a single fiber forming material, (4) a blend of fiber types, each fiber type including a blend of fiber forming materials, or (5) a blend of fiber types, each fiber type including a single fiber forming material or a blend of fiber forming materials. In example embodiments including a blend of fiber types, the different fiber types can have a difference in one or more of the group of length to diameter ratio (LID), tenacity, shape, rigidness, elasticity, solubility, melting point, glass transition temperature (T_{g}), fiber forming material chemistries, and color. In certain embodiments, the plurality of fibers can comprise two or more types of water-soluble fibers. In example embodiments, the plurality of fibers can comprise at least one fiber type comprising at least one type of water-soluble fiber forming materials and at least one fiber type comprising at least type of one non-water-soluble fiber. In example embodiments, the plurality of fibers can comprise two or more fiber types comprising at least one type of non-water-soluble fiber forming material.

In example embodiments, the nonwoven web can further comprise any carrier solvent with any suitable active cleaning formulation and/or any auxiliary agents as disclosed herein for fibers and/or films. In example embodiments, the carrier solvent, the active cleaning formulation, and/or the auxiliary agents can be added to the fiber itself, to the nonwoven web during carding of the nonwoven web, to the nonwoven web prior to bonding (e.g., after carding), to the nonwoven web after bonding, or a combination thereof. The carrier solvent, active cleaning formulation, and/or auxiliary agents added to the fibers during carding can be distributed throughout the nonwoven web. The carrier solvent, active cleaning formulation, and/or auxiliary agents added to the nonwoven web after carding but prior to bonding can be selectively added to one or both faces of the nonwoven web.

The carrier solvent, active cleaning formulation, and/or auxiliary agents can be applied to one or more faces of a nonwoven web or to an article containing same, e.g., a packet, by any suitable means. In example embodiments, the carrier solvent, active cleaning formulation, and/or auxiliary agents are in powder form. In refinements of the foregoing embodiment, one or more stationary powder spray guns are used to direct the powder stream towards the web or a packet, from one or more than one direction, while the web or packet is transported through the coating zone by means of a belt conveyor. In example embodiments, a web or packet is conveyed through a suspension of the powder in air. In example embodiments, the webs or packets are tumble-mixed with the powder in a trough-like apparatus. In example embodiments, which can be combined with any other embodiment, electrostatic forces are employed to enhance the attraction between the powder and the packet or web. This type of process may be based on negatively charging the powder particles and directing these charged particles to the grounded packets or webs. In other alternative embodiments, the powder is applied to the web or packet by a secondary transferring tool including, but not limited to, rotating brushes which are in contact with the powder or by powdered gloves which can transfer the powder from a container to the web or packet. In yet another embodiment, the powder is applied by dissolving or suspending the powder in a non-aqueous solvent or carrier which is then atomized and sprayed onto the web or packet. In one embodiment, the solvent or carrier subsequently evaporates, leaving the active agent powder behind. In certain embodiments, the powder is applied to the web or packet in an accurate dose. These embodiments utilize closed-system dry lubricant application machinery, such as PekuTECH's powder applicator PM 700 D. In this process, the powder, optionally batch-wise or continuously, is fed to a feed trough of application machinery. The webs or packets are transferred from the output belt of a standard rotary drum pouch machine onto a conveyor belt of the powder application machine, wherein a controlled dosage of the powder is applied to the web or packet. The web or packet can thereafter be conveyed to a suitable secondary packaging process.

In example embodiments wherein the carrier solvent, active cleaning formulation, and/or auxiliary agents are in liquid form or in a solution, the foregoing can be dispersed among the fibers, dispersed on a face of the nonwoven web, or a combination thereof, for example, by spin casting, spraying a solution such as an aerosolized solution, roll coating, flow coating, curtain coating, extrusion, knife coating, and combinations thereof.

The auxiliary agents, such as chemical exfoliants, mechanical exfoliants, fragrances and/or perfume microcapsules, aversive agents, surfactants, colorants, enzymes, skin conditioners, de-oiling agents, cosmetic agents, or a combination thereof, when present in the nonwoven web, are in an amount of at least about 1 wt. %, or in a range of about 1 wt. % to about 99 wt. %, provides additional functionality to the nonwoven web. The chemical exfoliants, mechanical exfoliants, fragrances and/or perfume microcapsules, aversive agents, surfactants, colorants, enzymes, skin conditioners, de-oiling agents, cosmetic agents, or a combination thereof, can take any desired form, including as a solid (e.g., powder, granulate, crystal, flake, or ribbon), a liquid, a mull, a paste, a gas, etc., and optionally can be encapsulated.

In example embodiments, the nonwoven web can be colored, pigmented, and/or dyed to provide an improved aesthetic effect relative to water-soluble films. Suitable colorants for use in the nonwoven web can include an indicator dye, such as a pH indicator (e.g., thymol blue, bromothymol, thymolphthalein, and thymolphthalein), a moisture/water indicator (e.g., hydrochromic inks or leuco dyes), or a thermochromic ink, wherein the ink changes color when temperature increases and/or decreases. Suitable colorants include, but are not limited to, a triphenylmethane dye, an azo dye, an anthraquinone dye, a perylene dye, an indigoid dye, a food, drug and cosmetic (FD&C) colorant, an organic pigment, an inorganic pigment, or a combination thereof. Examples of colorants include, but are not limited to, FD&C Red #40; Red #3; FD&C Black #3; Black #2; Mica-based pearlescent pigment; FD&C Yellow #6; Green #3; Blue #1; Blue #2; titanium dioxide (food grade); brilliant black; and a combination thereof.

In example embodiments, the nonwoven web can include any of the surfactants disclosed herein. In example embodiments, the nonwoven web can comprise one or more of the group of: sodium cocoyl isethionate, glucotain, phoenamids, cola lipid, cocamides, such as cocamide ethanolamines, ethylene oxide-based surfactants, and saponified oils of avocado and palm.

The nonwoven webs of the disclosure can generally have any thickness. Suitable thicknesses can include, but are not limited to, about 5 microns (μm) to about 10,000 μm (1 cm), about 5 μm to about 5,000 μm, about 5 μm to about 1,000 μm, about 5 μm to about 500 μm, about 200 μm to about 500 μm, about 5 μm to about 200 μm, about 20 μm to about 100 μm, or about 40 μm to about 90 μm, or about 50 μm to 80 μm, or about or about 60 μm to 65 μm, for example, 50 μm, 65 μm, 76 μm, or 88 μm. The nonwoven webs of the disclosure can be characterized as high loft or low loft. In general, loft refers to the ratio of thickness to mass per unit area (i.e., basis weight). High loft nonwoven webs can be characterized by a high ratio of thickness to mass per unit area. As used herein, “high loft” refers to a nonwoven web of the disclosure having a basis weight as defined herein and a thickness exceeding 200 μm. The thickness of the nonwoven web can be determined according to ASTM D5729-97, ASTM D5736, and/or ISO 9073-2:1995 and can include, for example, subjecting the nonwoven web to a load of 2 N and measuring the thickness. High loft materials can be used according to known methods in the art, for example, cross-lapping, which uses a cross-lapper to fold the unbonded web over onto itself to build loft and basis weight. Without intending to be bound by theory, in contrast to water-soluble films wherein the solubility of the film can be dependent on the thickness of the film, the solubility of a nonwoven web is not believed to be dependent on the thickness of the web. In this regard, it is believed that because the individual fibers provide a higher surface area than a water-soluble film, regardless of the thickness of the nonwoven web, the parameter that limits approach of water to the fibers and, thereby, dissolution of the fibers is the basis weight (i.e., fiber density in the nonwoven).

In general, the coefficient of dynamic friction and the ratio of the coefficient of static friction to the coefficient of dynamic friction for a nonwoven web of the disclosure will be lower than the coefficient of dynamic friction and the ratio of the coefficient of static friction to the coefficient of dynamic friction for a water-soluble film due to the increased surface roughness of the nonwoven web relative to a water-soluble film, which provides decreased surface contact to the nonwoven web. Advantageously, this surface roughness can provide an improved feel to the consumer (i.e., a cloth-like hand-feel instead of a rubbery hand-feel), improved aesthetics (i.e., less glossy than a water-soluble film), and/or facilitate processability in preparing thermoformed, and/or vertical formed, filled, and sealed, and/or multichamber packets which require drawing the web along a surface of the processing equipment/mold. Accordingly, the water-soluble fibers and/or non-water-soluble fibers should be sufficiently coarse to provide a surface roughness to the resulting nonwoven web without being so coarse as to produce drag.

The solubility in water of the nonwoven webs of the disclosure is generally a function of the type of fiber(s) used to prepare the web as well as the basis weight of the web. Without intending to be bound by theory, it is believed that the solubility profile of a nonwoven web follows the same solubility profile of the fiber(s) used to prepare the nonwoven web, and the solubility profile of the fiber generally follows the same solubility profile of the polymer(s) from which the fiber is prepared. For example, for nonwoven webs comprising PVOH fibers, the degree of hydrolysis of the PVOH polymer can be chosen such that the water-solubility of the nonwoven web is also influenced. In general, at a given temperature, as the degree of hydrolysis of the PVOH polymer increases from partially hydrolyzed (88% DH) to fully hydrolyzed (>98% DH), water solubility of the polymer generally decreases. Thus, in example embodiments, the nonwoven web can be cold water-soluble. For a co-poly(vinyl acetate vinyl alcohol) polymer that does not include any other monomers (e.g., not copolymerized with an anionic monomer) a cold water-soluble web, soluble in water at a temperature of less than 10° C., can include fibers of PVOH with a degree of hydrolysis in a range of about 75% to about 90%, or in a range of about 75% to about 89%, or in a range of about 80% to about 90%, or in a range of about 85% to about 90%, or in a range of about 90% to about 99.5%. In other example embodiments, the nonwoven web can be hot water-soluble. For example, a co-poly(vinyl acetate vinyl alcohol) polymer that does not include any other monomers (e.g., not copolymerized with an anionic monomer), a hot water-soluble web can be soluble in water at a temperature of at least about 60° C., by including fibers of PVOH with a degree of hydrolysis of at least about 98%.

Modification of PVOH generally increases the solubility of the PVOH polymer. Thus, it is expected that at a given temperature the solubility of a nonwoven web or film prepared from a PVOH copolymer would be higher than that of a nonwoven web or film prepared from a PVOH homopolymer having the same degree of hydrolysis as the PVOH copolymer. Following these trends, a nonwoven web having specific solubility characteristics can be designed by blending polymers within the fibers and/or blending fibers within the nonwoven web. Further, as described herein, the nonwoven web includes a plurality of fibers that may, in some cases, include two or more fiber types that differ in solubility.

Inclusion of non-water-soluble fiber and/or non-water-soluble fiber forming material in the plurality of fibers of a nonwoven web can also be used to design a nonwoven web having specific solubility and/or prolonged release properties. Without intending to be bound by theory, it is believed that as the weight percent of non-water-soluble fiber included in a nonwoven web is increased (based on the total weight of the nonwoven web), the solubility of the nonwoven web generally decreases and the prolonged release properties of a pouch comprising a nonwoven web generally increases. Upon contact with water at a temperature at or above the solubility temperature of the water-soluble fiber, a nonwoven web comprising water-soluble fiber and non-water-soluble fiber will begin to disperse as the water-soluble fiber dissolves, thereby breaking down the web structure and/or increasing the pore size of the pores of the nonwoven web. In general, the larger the break-down of the web structure or increase in the pore size, the faster the water can access the contents of the pouch and the faster the contents of the pouch will be released. Similarly, prolonged release of the contents of a pouch comprising the nonwoven web of the disclosure can be achieved by using a blend of water-soluble fibers having different solubility properties and/or different solubility temperatures. Once the faster dissolving fiber has dissolved, thereby breaking up the web, the less soluble fibers will have a larger surface area exposed, facilitating dissolution of the less soluble fibers and release of the pouch contents. In example embodiments wherein the nonwoven web includes water-soluble fibers and non-water-soluble fibers, the ratio of soluble fibers to non-water-soluble fibers is not particularly limited. The water-soluble fibers can comprise about 1% to about 99%, about 20% to about 80%, about 40% to about 90%, about 50% to about 90%, or about 60% to about 90% by weight, of the total weight of the plurality of fibers, and the non-water-soluble fibers can comprise about 1% to about 99%, about 20% to about 80%, about 10% to about 60%, about 10% to about 50%, or about 10% to about 40% by weight, of the total weight of the fibers. In example embodiments, the plurality of fibers comprise about 10% to about 80% water-soluble fibers by weight, based on the total weight of the fibers and the balance being non-water-soluble fibers.

In example embodiments, the nonwoven web, the plurality of fibers, the foam, the water-soluble film, or a combination thereof, disclosed herein can comprises a biodegradable polymer. In certain embodiments, the plurality of fibers can comprise non-water-soluble fiber forming materials that are biodegradable. In example embodiments, the plurality of fibers can comprise first fibers that are non-water-soluble biodegradable fibers, and second fibers that are soluble in water at a temperature of about 10° C. to about 20° C. according to MSTM-205 or not soluble in water at a temperature of about 30° C. or less according to MSTM-205, according to MSTM-205. In example embodiments, the nonwoven web is non-water-soluble and biodegradable.

In example embodiments, the nonwoven web is biodegradable. As used herein, when the nonwoven web is said to be biodegradable, at least 50% of the nonwoven web is biodegradable, for example, at least 60%, at least 70%, at least 80%, at least 90%, or 100%, of the nonwoven web is biodegradable.

The nonwoven web as disclosed herein can comprise the plurality of fibers comprising a first fiber type and a second fiber type, wherein the first and second fiber types have a difference in diameter, length, tenacity, shape, rigidness, elasticity, solubility, melting point, glass transition temperature (T_{g}), chemical composition, color, or a combination thereof. In example embodiments, the first fiber type can comprise a PVOH homopolymer fiber forming material, a PVOH copolymer fiber forming material, or a combination thereof. In example embodiments, the first fiber type can comprise two or more PVOH homopolymer fiber forming materials, two or more PVOH copolymer fiber forming materials, or a combination thereof. In example embodiments, the second fiber type can comprise a PVOH homopolymer fiber forming material, a PVOH copolymer fiber forming material, or a combination thereof. In example embodiments, the second fiber type can comprise two or more PVOH homopolymer fiber forming materials, two or more PVOH copolymer fiber forming materials, or a combination thereof. In example embodiments, the first fiber type and/or the second fiber type are non-water-soluble fiber forming material. In example embodiments, the first fiber type can comprise a non-water-soluble polymer fiber forming material and the second fiber type can comprise a polyvinyl alcohol fiber forming material that, when provided as the sole fiber forming material of a nonwoven web or as a film, the resulting web or film is soluble in water at a temperature in a range of about 0° C. to about 20° C. according to MSTM-205. In example embodiments, the first fiber type can comprise a non-water-soluble polymer fiber forming material and the second fiber type can comprise a PVOH homopolymer or copolymer fiber forming material that, when provided as the sole fiber forming material of a nonwoven web or as a film, the resulting web or film is not soluble in water at a temperature of 20° C. or less according to MSTM-205. In example embodiments, the first fiber type comprises two or more polyvinyl alcohol homopolymer fiber forming materials, two or more polyvinyl alcohol copolymer fiber forming materials, or a combination of polyvinyl alcohol homopolymer fiber forming materials and polyvinyl alcohol copolymer fiber forming materials. In example embodiments, the second fiber type comprises two or more polyvinyl alcohol homopolymer fiber forming materials, two or more polyvinyl alcohol copolymer fiber forming materials, or a combination of polyvinyl alcohol homopolymer fiber forming materials and polyvinyl alcohol copolymer fiber forming materials.

The plurality of fibers comprised in the nonwoven webs of the disclosure can generally have any tenacity. The tenacity of the fiber correlates to the coarseness of the fiber. As the tenacity of the fiber decreases the coarseness of the fiber increases. Fibers used to prepare the nonwoven webs of the disclosure can have a tenacity in a range of about 1 to about 100 cN/dtex, or about 1 to about 75 cN/dtex, or about 1 to about 50 cN/dtex, or about 1 to about 45 cN/dtex, or about 1 to about 40 cN/dtex, or about 1 to about 35 cN/dtex, or about 1 to about 30 cN/dtex, or about 1 to about 25 cN/dtex, or about 1 to about 20 cN/dtex, or about 1 to about 15 cN/dtex, or about 1 to about 10 cN/dtex, or about 3 to about 8 cN/dtex, or about 4 to about 8 cN/dtex, or about 6 to about 8 cN/dtex, or about 4 to about 7 cN/dtex, or about 10 to about 20, or about 10 to about 18, or about 10 to about 16, or about 1 cN/dtex, about 2 cN/dtex, about 3 cN/dtex, about 4 cN/dtex, about 5 cN/dtex, about 6 cN/dtex, about 7 cN/dtex, about 8 cN/dtex, about 9 cN/dtex, about 10 cN/dtex, about 11 cN/dtex, about 12 cN/dtex, about 13 cN/dtex, about 14 cN/dtex, or about 15 cN/dtex. In example embodiments, the plurality of fibers can have a tenacity in a range of about 3 cN/dtex to about 15 cN/dtex, or about 5 cN/dtex to about 12 cN/dtex, or about 5 cN/dtex to about 10 cN/dtex.

The tenacity of the nonwoven web can be the same or different from the tenacity of the plurality of fibers used to prepare the web. Without intending to be bound by theory, it is believed that the tenacity of the nonwoven web is related to the strength of the nonwoven web, wherein a higher tenacity provides a higher strength to the nonwoven web. In general, the tenacity of the nonwoven web can be modified by using fibers having different tenacities. The tenacity of the nonwoven web may also be affected by processing. In general, the nonwoven webs of the disclosure have relatively high tenacities, i.e., the nonwoven web is a self-supporting web that can be used as the sole material for preparing an article and/or pouch. In contrast, nonwoven webs prepared according to melt blown, electro-spinning, and/or rotary spinning processes have low tenacities and may not be self-supporting or capable of being used as a sole web for forming an article or pouch.

The fibers used to prepare the nonwoven webs of the disclosure can generally have any fineness. The fineness of the fiber correlates to how many fibers are present in a cross-section of a yarn of a given thickness. The fineness of a fiber can be measured by the linear mass density, a measure of the ratio of fiber mass per unit length. The main physical unit of linear mass density is 1 tex, which is equal to 1000 m of fiber weighing 1 g. The unit dtex is used, representing 1 g/10,000 m of fiber. The linear mass density can be selected to provide a nonwoven web having suitable stiffness/hand-feel of the nonwoven web, torsional rigidity, reflection and interaction with light, absorption of dye and/or other actives/additives, ease of fiber spinning in the manufacturing process, and uniformity of the finished article. In general, as the linear mass density of the fibers increases the nonwovens resulting therefrom demonstrate higher uniformity, improved tensile strengths, extensibility, and luster. Additionally, without intending to be bound by theory it is believed that finer fibers will lead to slower dissolution times as compared to larger fibers based on density. Further, without intending to be bound by theory, when a blend of fiber types is used, the average linear mass density can be determined using a weighted average of the individual fiber types. Fibers can be characterized as very fine (dtex ≤1.22), fine (1.22≤dtex ≤1.54), medium (1.54≤dtex ≤1.93), slightly coarse (1.93≤dtex ≤2.32), and coarse (dtex ≥2.32). The nonwoven web of the disclosure can include fibers that are very fine, fine, medium, slightly coarse, or a combination thereof. In example embodiments, the nonwoven web has an average linear mass density in a range of about 1 dtex to about 5 dtex, or about 1 dtex to about 3 dtex, or about 1.5 dtex to about 2.5 dtex. In example embodiments, the nonwoven web comprises a blend of fibers wherein first fiber comprises 1.7 dtex average linear mass density and second fiber comprises 2.2 dtex average linear mass density.

The plurality of fibers used to prepare the nonwoven webs of the disclosure have a diameter in a range of about 10 microns to 300 microns, for example, at least 10 microns, at least 25 microns, at least 50 microns, at least 100 microns, or at least 125 microns and up to about 300 microns, up to about 275 microns, up to about 250 microns, up to about 225 microns, or up to about 200 microns. In example embodiments, the plurality of fibers used to prepare the nonwoven webs of the disclosure can have a diameter greater than 100 microns to about 300 microns. In example embodiments, the diameters of the plurality of fibers used to prepare the nonwoven webs of the disclosure have diameters that are substantially uniform. In example embodiments, the one or more fiber types can have a mean diameter in a range of about 10 microns to about 300 microns, or about 50 microns to 200 microns, or about 50 microns to about 100 microns.

The plurality of fibers used to prepare the nonwoven webs of the disclosure can generally be of any length. In example embodiments, the length of the plurality of fibers can be in a range of about 10 millimeters (mm) to about 100 mm, about 10 mm to about 60 mm, or about 30 mm to about 60 mm, for example, at least about 30 mm, at least about 35 mm, at least about 40 mm, at least about 45 mm, or at least about 50 mm, and up to about 100 mm, up to about 95 mm, up to about 90 mm, up to about 80 mm, up to about 70 mm, or up to about 60 mm. In example embodiments, the length of the plurality of fibers can be less than about 30 mm or in a range of about 0.25 mm to less than about 30 mm, for example, at least about 0.25 mm, at least about 0.5 mm, at least about 0.75 mm, at least about 1 mm, at least about 2.5 mm, at least about 5 mm, at least about 7.5 mm, or at least about 10 mm and up to about 29 mm, up to about 28 mm, up to about 27 mm, up to about 26 mm, up to about 25 mm, up to about 20 mm, or up to about 15 mm. In example embodiments, the fibers have an average length of about 30 mm to about 100 mm, or about 30 mm to about 60 mm. In example embodiments, the nonwoven web comprises a blend of fiber types wherein first fiber type comprises a length of about 38 mm and second fiber type comprises a length of about 54 mm.

The plurality of fibers used to prepare the nonwoven webs of the disclosure can generally have any length to diameter (L/D) ratio. Advantageously, the tactility of a nonwoven web of the disclosure can be controlled using the L/D ratio of the fibers and the respective amounts of fibers having various L/D ratios in the nonwoven composition. In general, as the L/D of the fiber decreases, the stiffness and resistance to bending increases, providing a rougher hand feel. The fibers of the disclosure generally impart a rough feel to a nonwoven web including same, when the fibers have a low L/D ratio in a range of about 0.5 to about 15, or about 0.5 to about 25, or about 1 to about 5. Such low L/D fibers can be provided in a nonwoven web in an amount in a range of about 0 to about 50% by weight, based on the total weight of the fibers in the nonwoven web, for example, in a range of about 0.5 wt. % to about 25 wt. %, or about 1 wt. % to about 15 wt. %. If the amount of low L/D fibers in a nonwoven web is not known, the amount can be estimated by visual inspection of a micrograph of a nonwoven web. In example embodiments wherein a first fiber includes a blend of fiber forming materials including a first polyvinyl alcohol fiber forming material, at least a portion of the first fibers can have a L/D ratio of about 0.5 to about 25, or about 0.5 to about 15, or about 1 to about 5.

Pore sizes can be determined using high magnification and ordered surface analysis techniques including, but not limited to Brunauer-Emmett-Teller theory (BET), small angle X-ray scattering (SAXS), and molecular adsorption.

Nonwoven webs can be characterized by basis weight. The basis weight of a nonwoven web is the mass per unit area of the nonwoven web. Basis weight can be modified by varying manufacturing conditions, as is known in the art. A nonwoven web can have the same basis weight prior to and after bonding. Alternatively, the bonding method can change the basis weight of the nonwoven web. For example, wherein bonding occurs through the application of heat and pressure, the thickness of the nonwoven (and, thus, the area of the nonwoven) can be decreased, thereby increasing the basis weight. Accordingly, as used herein and unless specified otherwise, the basis weight of a nonwoven refers to the basis weight of the nonwoven after bonding.

The nonwoven webs of the disclosure can generally have any basis weight in a range of about 0.1 g/m² to about 700 g/m², about 0.5 g/m² to about 600 g/m², about 1 g/m² to about 500 g/m², about 1 g/m² to about 400 g/m², about 1 g/m² to about 300 g/m², about 1 g/m² to about 200 g/m², about 1 g/m² to about 100 g/m², about 30 g/m² to about 100 g/m², about 20 g/m² to about 100 g/m², about 20 g/m² to about 80 g/m², or about 25 g/m² to about 70 g/m².

Further, as the basis weight of the web increases the rate of dissolution of the web decreases, provided the fiber composition and web thickness remain constant, as there is more material to be dissolved. For example, at a given temperature, a water-soluble web prepared from fibers comprising PVOH polymer(s) and having a basis weight of, e.g., 40 g/m², is expected to dissolve slower than an otherwise-identical water-soluble web having a basis weight of, e.g., 30 g/m². Accordingly, basis weight can also be used to modify the solubility characteristics of the nonwoven web. The nonwoven web can generally have any basis weight in a range of about 1 g/m² to about 700 g/m², about 1 g/m² to about 600 g/m², about 1 g/m² to about 500 g/m², about 1 g/m² to about 400 g/m², about 1 g/m² to about 300 g/m², about 1 g/m² to about 200 g/m², about 10 g/m² to about 100 g/m², about 30 g/m² to about 100 g/m², about 20 g/m² to about 100 g/m², about 20 g/m² to about 80 g/m², about 25 g/m² to about 70 g/m², or about 40 g/m² to about 60 g/m².

The nonwoven web of the disclosure can be used as a single layer or can be layered with other nonwoven webs or can be in the form of a laminate with a water-soluble film. In some embodiments, the nonwoven web includes a single layer of nonwoven web. In some embodiments, the nonwoven web is a multilayer nonwoven web comprising two or more layers of nonwoven webs. The two or more layers can be laminated to each other. In refinements of the foregoing embodiment, the two or more layers can be the same (e.g., be prepared from the same fibers and basis weight). In refinements of the foregoing embodiment, the two or more layers can be different (e.g., be prepared from different types of fibers, fiber chemistries, and/or have different basis weights).

In general, a multilayer nonwoven web can have a basis weight that is the sum of the basis weights of the individual layers. Accordingly, a multilayer nonwoven web will take longer to dissolve than any of the individual layers provided as a single layer.

### Water-Soluble Foams

In example embodiments, a suitable water-soluble foam includes any suitable resin chemistry, such as a homopolymer, MA modified PVOH, MMM Modified PVOH, AMPS Modified PVOH, cellulose and cellulose derivatives, PVP, proteins, casein, soy, or any water-dispersible or water-soluble resin. In certain embodiments, the water-soluble foam substrate has a thickness of 3 microns to 3000 microns and can be formed using any suitable manufacturing process known in the foam manufacturing art including, without limitation, a cast, extruded, melt processed, coated, chemically blown, mechanically aerated, air injected, turbulent extrusion process. The water-soluble foam substrate may be porous or non-porous and cold water-soluble or hot water-soluble. The construction of the water-soluble foam substrate may include, for example, folded layers or plies, stacked layers or plies, or rolled layers or plies.

In example embodiments, the water-soluble foam substrate can further comprise any auxiliary agents as disclosed herein for nonwoven webs, fibers and/or films. The auxiliary agents can be applied to one or more faces of a water-soluble foam substrate or to an article containing same, e.g., a packet, by any suitable means. In example embodiments, the auxiliary agents are in powder form. In refinements of the foregoing embodiment, one or more stationary powder spray guns are used to direct the powder stream towards the water-soluble foam substrate or a packet, from one or more than one direction, while the water-soluble foam substrate or packet is transported through the coating zone by means of a belt conveyor. In example embodiments, a water-soluble foam substrate or packet is conveyed through a suspension of the powder in air. In example embodiments, the water-soluble foam substrate or packets are tumble-mixed with the powder in a trough-like apparatus. In example embodiments, which can be combined with any other embodiment, electrostatic forces are employed to enhance the attraction between the powder and the packet or water-soluble foam substrate. This type of process may be based on negatively charging the powder particles and directing these charged particles to the grounded packets or water-soluble foam substrates. In other alternative embodiments, the powder is applied to the water-soluble foam substrate or packet by a secondary transferring tool including, but not limited to, rotating brushes, which are in contact with the powder or by powdered gloves, which can transfer the powder from a container to the water-soluble foam substrate or the packet. In yet another embodiment, the powder is applied by dissolving or suspending the powder in a non-aqueous solvent or carrier. which is then atomized and sprayed onto the water-soluble foam substrate or packet. In one embodiment, the solvent or carrier subsequently evaporates, leaving the active agent powder behind. In certain embodiments, the powder is applied to the water-soluble foam substrate or packet in an accurate dose. These embodiments utilize closed-system dry lubricant application machinery, such as PekuTECH's powder applicator PM 700 D. In this process, the powder, optionally batch-wise or continuously, is fed to a feed trough of application machinery. The water-soluble foam substrates or packets are transferred from the output belt of a standard rotary drum pouch machine onto a conveyor belt of the powder application machine, wherein a controlled dosage of the powder is applied to the water-soluble foam substrate or packet. The water-soluble foam substrate or packet can thereafter be conveyed to a suitable secondary packaging process.

In example embodiments wherein the auxiliary agents are in liquid form or in a solution, the foregoing can be dispersed in the water-soluble foam substrate, dispersed on a face of the water-soluble foam substrate, or a combination thereof, for example, by spin casting, spraying a solution such as an aerosolized solution, roll coating, flow coating, curtain coating, extrusion, knife coating, and combinations thereof.

The auxiliary agents, such as chemical exfoliants, mechanical exfoliants, fragrances and/or perfume microcapsules, aversive agents, surfactants, colorants, enzymes, skin conditioners, de-oiling agents, cosmetic agents, or a combination thereof, when present in the water-soluble foam substrate, are in an amount of at least about 1 wt. %, or in a range of about 1 wt. % to about 99 wt. %, provides additional functionality to the water-soluble foam substrate. The chemical exfoliants, mechanical exfoliants, fragrances and/or perfume microcapsules, aversive agents, surfactants, colorants, enzymes, skin conditioners, de-oiling agents, cosmetic agents, or a combination thereof, can take any desired form, including as a solid (e.g., powder, granulate, crystal, flake, or ribbon), a liquid, a mull, a paste, a gas, etc., and optionally can be encapsulated.

In example embodiments, the water-soluble foam substrate can be colored, pigmented, and/or dyed to provide an improved aesthetic effect relative to water-soluble films. Suitable colorants for use in the water-soluble foam substrate can include an indicator dye, such as a pH indicator (e.g., thymol blue, bromothymol, thymolphthalein, and thymolphthalein), a moisture/water indicator (e.g., hydrochromic inks or leuco dyes), or a thermochromic ink, wherein the ink changes color when temperature increases and/or decreases. Suitable colorants include, but are not limited to, a triphenylmethane dye, an azo dye, an anthraquinone dye, a perylene dye, an indigoid dye, a food, drug and cosmetic (FD&C) colorant, an organic pigment, an inorganic pigment, or a combination thereof. Examples of colorants include, but are not limited to, FD&C Red #40; Red #3; FD&C Black #3; Black #2; Mica-based pearlescent pigment; FD&C Yellow #6; Green #3; Blue #1; Blue #2; titanium dioxide (food grade); brilliant black; and a combination thereof.

In example embodiments, the water-soluble foam substrate can include any of the surfactants disclosed herein. In example embodiments, the water-soluble foam substrate can comprise one or more of the group of: sodium cocoyl isethionate, glucotain, phoenamids, cola lipid, cocamides, such as cocamide ethanolamines, ethylene oxide-based surfactants, and saponified oils of avocado and palm.

The water-soluble foam substrate of the disclosure can have any thickness. Suitable thicknesses can include, but are not limited to, about 5 microns (μm) to about 10,000 μm (1 cm), about 3 μm to about 5,000 μm, about 5 μm to about 1,000 μm, about 5 μm to about 500 μm, about 200 μm to about 500 μm, about 5 μm to about 200 μm, about 20 μm to about 100 μm, or about 40 μm to about 90 μm, or about 50 μm to 80 μm, or about or about 60 μm to 65 μm, for example, 50 μm, 65 μm, 76 μm, or 88 μm. The water-soluble foam substrate of the disclosure can be characterized as high loft or low loft. Loft refers to the ratio of thickness to mass per unit area (i.e., basis weight). High loft water-soluble foam substrates can be characterized by a high ratio of thickness to mass per unit area. As used herein, “high loft” refers to a water-soluble foam substrate of the disclosure having a basis weight as defined herein and a thickness exceeding 200 μm. The thickness of the water-soluble foam substrate can be determined according to ASTM D5729-97, ASTM D5736, and/or ISO 9073-2:1995 and can include, for example, subjecting the water-soluble foam substrate to a load of 2 N and measuring the thickness. High loft materials can be used according to known methods in the art, for example, cross-lapping, which uses a cross-lapper to fold the unbonded web over onto itself to build loft and basis weight.

In general, the coefficient of dynamic friction and the ratio of the coefficient of static friction to the coefficient of dynamic friction for a water-soluble foam substrate of the disclosure will be lower than the coefficient of dynamic friction and the ratio of the coefficient of static friction to the coefficient of dynamic friction for a water-soluble film due to the increased surface roughness of the water-soluble foam substrate relative to a water-soluble film, which provides decreased surface contact to the water-soluble foam substrate. Advantageously, this surface roughness can provide an improved feel to the consumer (i.e., a cloth-like hand-feel instead of a rubbery hand-feel), improved aesthetics (i.e., less glossy than a water-soluble film), and/or facilitate processability in preparing thermoformed, and/or vertical formed, filled, and sealed, and/or multichamber packets which require drawing the water-soluble foam substrate along a surface of the processing equipment/mold. Accordingly, the water-soluble fibers and/or non-water-soluble fibers should be sufficiently coarse to provide a surface roughness to the resulting water-soluble foam substrate without being so coarse as to produce drag.

The solubility in water of the soluble foam substrate closure is a function of the type of fiber(s) used to prepare the water-soluble foam substrate as well as the basis weight of the water-soluble foam substrate. Without intending to be bound by theory, it is believed that the solubility profile of a water-soluble foam substrate follows the same solubility profile of the fiber(s) used to prepare the water-soluble foam substrate, and the solubility profile of the fiber generally follows the same solubility profile of the polymer(s) from which the fiber is prepared. For example, for the water-soluble foam substrates comprising PVOH fibers, the degree of hydrolysis of the PVOH polymer can be chosen such that the water-solubility of the water-soluble foam substrate is also influenced. At a given temperature, as the degree of hydrolysis of the PVOH polymer increases from partially hydrolyzed (88% DH) to fully hydrolyzed (>98% DH), water solubility of the polymer generally decreases. Thus, in example embodiments, the water-soluble foam substrate can be cold water-soluble. For a co-poly(vinyl acetate vinyl alcohol) polymer that does not include any other monomers (e.g., not copolymerized with an anionic monomer) a cold water-soluble web, soluble in water at a temperature of less than 10° C., can include fibers of PVOH with a degree of hydrolysis in a range of about 75% to about 90%, or in a range of about 75% to about 89%, or in a range of about 80% to about 90%, or in a range of about 85% to about 90%, or in a range of about 90% to about 99.5%. In other example embodiments, the water-soluble foam substrate can be hot water-soluble. For example, a co-poly(vinyl acetate vinyl alcohol) polymer that does not include any other monomers (e.g., not copolymerized with an anionic monomer), a hot water-soluble foam substrate can be soluble in water at a temperature of at least about 60° C., by including fibers of PVOH with a degree of hydrolysis of at least about 98%.

Modification of a PVOH polymer increases the solubility of the PVOH polymer. Thus, it is expected that at a given temperature the solubility of a water-soluble foam substrate prepared from a modified PVOH copolymer would be higher than that of a water-soluble foam substrate prepared from a PVOH copolymer having the same degree of hydrolysis as the modified PVOH copolymer. Following these trends, a water-soluble foam substrate having specific solubility characteristics can be designed by blending polymers within the fibers and/or blending fibers within the water-soluble foam substrate. Further, as described herein, the water-soluble foam substrate includes a plurality of fibers that may, in some cases, include two or more fiber types that differ in solubility.

Inclusion of non-water-soluble fiber and/or non-water-soluble fiber forming material in the plurality of fibers of a water-soluble foam substrate can also be used to design a water-soluble foam substrate having specific solubility and/or prolonged release properties. Without intending to be bound by theory, it is believed that as the weight percent of non-water-soluble fiber included in a water-soluble foam substrate is increased (based on the total weight of the water-soluble foam substrate), the solubility of the water-soluble foam substrate generally decreases and the prolonged release properties of a pouch comprising a water-soluble foam substrate generally increases. Upon contact with water at a temperature at or above the solubility temperature of the water-soluble fiber, a water-soluble foam substrate comprising water-soluble fiber and non-water-soluble fiber will begin to disperse as the water-soluble fiber dissolves, thereby breaking down the foam structure and/or increasing the pore size of the pores of the water-soluble foam substrate. The larger the break-down of the foam structure or increase in the pore size, the faster the water can access the contents of the pouch and the faster the contents of the pouch will be released. Similarly, prolonged release of the contents of a pouch comprising the water-soluble foam substrate of the disclosure can be achieved by using a blend of water-soluble fibers having different solubility properties and/or different solubility temperatures. Once the faster dissolving fiber has dissolved, thereby breaking up the foam, the less soluble fibers will have a larger surface area exposed, facilitating dissolution of the less soluble fibers and release of the pouch contents. In example embodiments wherein the foam substrate includes water-soluble fibers and non-water-soluble fibers, the ratio of soluble fibers to non-water-soluble fibers is not particularly limited. The water-soluble fibers can comprise about 1% to about 99%, about 20% to about 80%, about 40% to about 90%, about 50% to about 90%, or about 60% to about 90% by weight, of the total weight of the plurality of fibers, and the non-water-soluble fibers can comprise about 1% to about 99%, about 20% to about 80%, about 10% to about 60%, about 10% to about 50%, or about 10% to about 40% by weight, of the total weight of the fibers. In example embodiments, the plurality of fibers comprise about 10% to about 80% water-soluble fibers by weight, based on the total weight of the fibers and the balance being non-water-soluble fibers.

In example embodiments, the nonwoven web, the plurality of fibers, the foam, the water-soluble film, or a combination thereof, disclosed herein can comprises a biodegradable polymer. In certain embodiments, the plurality of fibers can comprise non-water-soluble fiber forming materials that are biodegradable. In example embodiments, the plurality of fibers can comprise first fibers that are non-water-soluble biodegradable fibers, and second fibers that are soluble in water at a temperature of about 10° C. to about 20° C. according to MSTM-205 or not soluble in water at a temperature of about 30° C. or less according to MSTM-205, according to MSTM-205. In example embodiments, the nonwoven web is non-water-soluble and biodegradable.

In example embodiments, the foam substrate is biodegradable. As used herein, when the foam substrate is said to be biodegradable, at least 50% of the foam substrate is biodegradable, for example, at least 60%, at least 70%, at least 80%, at least 90%, or 100%, of the foam substrate is biodegradable.

The foam substrate as disclosed herein can comprise the plurality of fibers comprising a first fiber type and a second fiber type, wherein the first and second fiber types have a difference in diameter, length, tenacity, shape, rigidness, elasticity, solubility, melting point, glass transition temperature (T_{g}), chemical composition, color, or a combination thereof. In example embodiments, the first fiber type can comprise a PVOH homopolymer fiber forming material, a modified PVOH copolymer fiber forming material, a PVOH copolymer fiber forming material, or a combination thereof. In example embodiments, the first fiber type can comprise two or more PVOH homopolymer fiber forming materials, two or more PVOH copolymer fiber forming materials, two or more modified PVOH copolymer fiber forming materials, or a combination thereof. In example embodiments, the second fiber type can comprise a PVOH homopolymer fiber forming material, a PVOH copolymer fiber forming material, a more modified PVOH copolymer fiber forming material, or a combination thereof. In example embodiments, the second fiber type can comprise two or more PVOH homopolymer fiber forming materials, two or more PVOH copolymer fiber forming materials, two or more modified PVOH copolymer fiber forming materials, or a combination thereof. In example embodiments, the first fiber type and/or the second fiber type are non-water-soluble fiber forming material. In example embodiments, the first fiber type can comprise a non-water-soluble polymer fiber forming material and the second fiber type can comprise a polyvinyl alcohol fiber forming material that, when provided as the sole fiber forming material of a nonwoven web or as a film, the resulting web or film is soluble in water at a temperature in a range of about 0° C. to about 20° C. according to MSTM-205. In example embodiments, the first fiber type can comprise a non-water-soluble polymer fiber forming material and the second fiber type can comprise a PVOH homopolymer or copolymer fiber forming material that, when provided as the sole fiber forming material of a water-soluble foam substrate, the resulting water-soluble foam substrate is not soluble in water at a temperature of 20° C. or less according to MSTM-205. In example embodiments, the first fiber type comprises two or more PVOH copolymer fiber forming materials, two or more modified PVOH copolymer fiber forming materials, or a combination of PVOH copolymer fiber forming materials and modified PVOH copolymer fiber forming materials. In example embodiments, the second fiber type comprises two or more PVOH copolymer fiber forming materials, two or more modified PVOH copolymer fiber forming materials, or a combination of PVOH copolymer fiber forming materials and modified PVOH copolymer fiber forming materials.

The plurality of fibers comprised in the water-soluble foam substrate of the disclosure can have any tenacity. The tenacity of the fiber correlates to the coarseness of the fiber. As the tenacity of the fiber decreases the coarseness of the fiber increases. Fibers used to prepare the nonwoven webs of the disclosure can have a tenacity in a range of about 1 to about 100 cN/dtex, or about 1 to about 75 cN/dtex, or about 1 to about 50 cN/dtex, or about 1 to about 45 cN/dtex, or about 1 to about 40 cN/dtex, or about 1 to about 35 cN/dtex, or about 1 to about 30 cN/dtex, or about 1 to about 25 cN/dtex, or about 1 to about 20 cN/dtex, or about 1 to about 15 cN/dtex, or about 1 to about 10 cN/dtex, or about 3 to about 8 cN/dtex, or about 4 to about 8 cN/dtex, or about 6 to about 8 cN/dtex, or about 4 to about 7 cN/dtex, or about 10 to about 20, or about 10 to about 18, or about 10 to about 16, or about 1 cN/dtex, about 2 cN/dtex, about 3 cN/dtex, about 4 cN/dtex, about 5 cN/dtex, about 6 cN/dtex, about 7 cN/dtex, about 8 cN/dtex, about 9 cN/dtex, about 10 cN/dtex, about 11 cN/dtex, about 12 cN/dtex, about 13 cN/dtex, about 14 cN/dtex, or about 15 cN/dtex. In example embodiments, the plurality of fibers can have a tenacity in a range of about 3 cN/dtex to about 15 cN/dtex, or about 5 cN/dtex to about 12 cN/dtex, or about 5 cN/dtex to about 10 cN/dtex.

The tenacity of the water-soluble foam substrate can be the same or different from the tenacity of the plurality of fibers used to prepare the web. Without intending to be bound by theory, it is believed that the tenacity of the water-soluble foam substrate is related to the strength of the nonwoven web, wherein a higher tenacity provides a higher strength to the nonwoven web. The tenacity of the water-soluble foam substrate can be modified by using fibers having different tenacities. The tenacity of the water-soluble foam substrate may also be affected by processing. The water-soluble foam substrate of the disclosure has relatively high tenacities, i.e., the water-soluble foam substrate is a self-supporting substrate that can be used as the sole material for preparing an article and/or pouch. In contrast, water-soluble foam substrate prepared according to melt blown, electro-spinning, and/or rotary spinning processes have low tenacities and may not be self-supporting or capable of being used as a sole substrate for forming an article or pouch.

Water-soluble foam substrates can be characterized by basis weight. The basis weight of a water-soluble foam substrate is the mass per unit area of the water-soluble foam substrate. Basis weight can be modified by varying manufacturing conditions, as is known in the art. A water-soluble foam substrate can have the same basis weight prior to and after bonding. Alternatively, the bonding method can change the basis weight of the water-soluble foam substrate. For example, wherein bonding occurs through the application of heat and pressure, the thickness of the water-soluble foam substrate (and, thus, the area of the water-soluble foam substrate) can be decreased, thereby increasing the basis weight. Accordingly, as used herein and unless specified otherwise, the basis weight of a water-soluble foam substrate refers to the basis weight of the water-soluble foam substrate after bonding.

The water-soluble foam substrate of the disclosure can have any basis weight in a range of about 0.1 g/m² to about 700 g/m², about 0.5 g/m² to about 600 g/m², about 1 g/m² to about 500 g/m², about 1 g/m² to about 400 g/m², about 1 g/m² to about 300 g/m², about 1 g/m² to about 200 g/m², about 1 g/m² to about 100 g/m², about 30 g/m² to about 100 g/m², about 20 g/m² to about 100 g/m², about 20 g/m² to about 80 g/m², or about 25 g/m² to about 70 g/m².

Further, as the basis weight of the water-soluble foam substrate increases the rate of dissolution of the water-soluble foam substrate decreases, provided the fiber composition and web thickness remain constant, as there is more material to be dissolved. For example, at a given temperature, a water-soluble foam substrate prepared from fibers comprising PVOH polymer(s) and having a basis weight of, e.g., 40 g/m², is expected to dissolve slower than an otherwise-identical water-soluble web having a basis weight of, e.g., 30 g/m². Accordingly, basis weight can also be used to modify the solubility characteristics of the water-soluble foam substrate. The water-soluble foam substrate can generally have any basis weight in a range of about 1 g/m² to about 700 g/m², about 1 g/m² to about 600 g/m², about 1 g/m² to about 500 g/m², about 1 g/m² to about 400 g/m², about 1 g/m² to about 300 g/m², about 1 g/m² to about 200 g/m², about 10 g/m² to about 100 g/m², about 30 g/m² to about 100 g/m², about 20 g/m² to about 100 g/m², about 20 g/m² to about 80 g/m², about 25 g/m² to about 70 g/m², or about 40 g/m² to about 60 g/m².

The water-dispersible or water-soluble foam substrate of the disclosure can be used as a single layer or can be layered with other water-soluble foam substrates or can be in the form of a laminate with a water-soluble film. In some embodiments, the foam substrate includes a single layer. In some embodiments, the foam substrate is a multilayer foam substrate comprising two or more layers. The two or more layers can be laminated to each other. In refinements of the foregoing embodiment, the two or more layers can be the same (e.g., be prepared from the same fibers and basis weight). In refinements of the foregoing embodiment, the two or more layers can be different (e.g., be prepared from different types of fibers, fiber chemistries, and/or have different basis weights).

A multilayer foam substrate can have a basis weight that is the sum of the basis weights of the individual layers. Accordingly, a multilayer water-soluble foam substrate will take longer to dissolve than any of the individual layers provided as a single layer.

### Water-Soluble Films

The water-dispersible and/or water-soluble film described herein generally comprises any of the water-dispersible and/or water-soluble polymers disclosed herein. In example embodiments, the film of the disclosure comprises a polyvinyl alcohol (PVOH) resin, a modified polyvinyl alcohol resin, or combinations thereof. In example embodiments, the water-soluble film includes a PVOH resin selected from the group consisting of a PVOH homopolymer, a PVOH copolymer, a PVOH copolymer having an anionic modification, and combinations of the foregoing. In example embodiments, the film can comprise a single PVOH polymer or a blend of PVOH polymer. In example embodiments, the film comprises a PVOH copolymer. In example embodiments, the film comprises a hot water-soluble PVOH copolymer. In example embodiments wherein the nonwoven web includes a surfactant and/or an exfoliant, the film can comprise a modified PVOH copolymer having an anionic modification. In example embodiments, the film can comprise a water-soluble polyvinyl alcohol copolymer or modified copolymer that, when provided in a film as the sole film forming material, the film is soluble in water at a temperature in a range of about 0° C. to about 20° C. according to MSTM-205. In example embodiments, the film can comprise a water-soluble polyvinyl alcohol copolymer or modified copolymer that, when provided in a film as the sole film forming material, the film is not water-soluble at a water temperature of 20° C. or less according to MSTM-205.

The water-soluble film can include other film forming polymers including, but not limited to, polyvinyl alcohols, water-soluble acrylate copolymers, polyethyleneimine, pullulan, water-soluble natural polymers including, but not limited to, guar gum, gum Acacia, xanthan gum, carrageenan, and starch, water-soluble polymer modified starches, copolymers of the foregoing, or a combination of any of the foregoing. Other water-soluble polymers can include polyalkylene oxides, polyacrylamides, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, or a combination of any of the foregoing. Such water-soluble polymers are commercially available from a variety of sources. In example embodiments, the water-soluble film can include a PVOH homopolymer, PVOH copolymer, modified PVOH copolymer, or a combination thereof. In example embodiments, the water-soluble film comprises a single PVOH copolymer or a blend of PVOH copolymers. In further embodiments, the water-soluble film comprises a PVOH copolymer with a viscosity in a range of 5 cP to 23 cP and a degree of hydrolysis in a range of 86% to 92%.

The film can have any suitable thickness, and a film thickness of about 76 microns (μm)) is typical and particularly contemplated. Other values and ranges contemplated include values in a range of about 5 μm to about 200 μm, or in a range of about 20 μm to about 100 μm, or about 40 μm to about 90 μm, or about 50 μm to 80 μm, or about or about 60 μm to 65 μm, for example, 65 μm, 76 μm, or 88 μm.

In example embodiments, the water-dispersible and/or water-soluble films can include an auxiliary agent as described above. In example embodiments, the films can be substantially free of auxiliary agents as described above. In example embodiments, the water-soluble films can include a plasticizer as described above. The total amount of the non-water plasticizer provided in the water-soluble film can be in a range of about 1 wt. % to about 45 wt. %, or about 5 wt. % to about 45 wt. %, or about 10 wt. % to about 40 wt. %, or about 20 wt. % to about 30 wt. %, about 1 wt. % to about 4 wt. %, or about 1.5 wt. % to about 3.5 wt. %, or about 2.0 wt. % to about 3.0 wt. %, for example, about 1 wt. %, about 2.5 wt. %, about 5 wt. %, about 10 wt. %, about 15 wt. %, about 20 wt. %, about 25 wt. %, about 30 wt. %, about 35 wt. %, or about 40 wt. %, based on total film weight. In example embodiments, the film comprises one or more of propylene glycol, glycerol, diglycerol, sorbitol, xylitol, maltitol, trimethylol propane (TMP), and polyethylene glycol (100-1000 molecular weight).

In example embodiments, the films can include a surfactant as described above. In various embodiments, the amount of surfactant in the film is in a range of about 0.01 wt. %, to about 2.5 wt. %, about 0.1 wt. % to about 2.5 wt. %, about 1.0 wt. % to about 2.0 wt. %, about 0.01 wt. % to 0.25 wt. %, or about 0.10 wt. % to 0.20 wt. %. In example embodiments, the film comprises one or more of polysorbate 80, lecithin from various plant sources, and sodium lauryl sulfate (SLS) and the like.

In example embodiments, the auxiliary agents of the film can include fillers/extenders/antiblocking agents/detackifying agents. Suitable fillers/extenders/antiblocking agents/detackifying agents include, but are not limited to, crosslinked polyvinylpyrrolidone, crosslinked cellulose, microcrystalline cellulose, silica, metallic oxides, calcium carbonate, talc, mica, stearic acid, and metal salts thereof, for example, magnesium stearate. Optionally, an additional unmodified starch or modified starch can be included the water-soluble in addition to one of the specific starch components described above, for example, hydroxypropylated starch present in an amount in a range of about 5 phr to about 30 phr, or modified starch having a degree of modification of greater than about 2% and is present in an amount in a range of about 2.5 phr to about 30 phr, or an unmodified starch having an amylose content in a range of about 20% to about 80%, or a hydroxypropyl modified starch having an amylose content in a range of about 23% to about 95% when the polyvinyl alcohol comprises an unmodified polyvinyl alcohol or an anionic modified polyvinyl alcohol copolymer with the proviso that the anionic modifier is not an acrylate. Preferred materials are starches, modified starches, and silica. In one embodiment, the amount of filler/extender/antiblocking agent/detackifying agent in the water-soluble film can be in a range of about 1 wt. % to about 6 wt. %, or about 1 wt. % to about 4 wt. %, or about 2 wt. % to about 4 wt. %, or about 1 phr to about 6 phr, or about 1 phr to about 4 phr, or about 2 phr to about 4 phr, for example. In example embodiments, when a starch or modified starch is included in the water-soluble film in addition to one of the specific starch components described above, the additional starch component will be provided in an amount of less than about 50 wt. %, based on the total weight of all starches included in the film. Without intending to be bound by theory, it is believed that any benefit provided to the films of the disclosure from the inclusion of the starch component described above is not affected by including an additional starch component that provides a lesser benefit to the water-soluble film or no benefit to the water-soluble film.

The film can further have a residual moisture content of at least 4 wt. %, for example, in a range of about 4 wt. % to about 10 wt. %, as measured by Karl Fischer titration.

### Methods of Preparing Fibers

Wet Cooled Gel Spinning

In example embodiments, the plurality of water-soluble fibers can include water-soluble fibers prepared according to a wet cooled gel spinning process, the wet cooled gel spinning process including the steps of:

(a) dissolving the water-soluble polymer (or polymers) in solution to form a polymer mixture, the polymer mixture optionally including auxiliary agents;
(b) extruding the polymer mixture through a spinneret nozzle to a solidification bath to form an extruded polymer mixture;
(c) passing the extruded polymer mixture through a solvent exchange bath;
(d) optionally wet drawing the extruded polymer mixture; and
(e) finishing the extruded polymer mixture to provide the water-soluble fibers.

The solvent in which the water-soluble polymer is dissolved can suitably be any solvent in which the water-soluble polymer is soluble. In example embodiments, the solvent in which the water-soluble polymer is dissolved includes a polar aprotic solvent. In example embodiments, the solvent in which the water-soluble polymer is dissolved includes dimethyl sulfoxide (DMSO).

The solidification bath includes a cooled solvent for gelling the extruded polymer mixture. The solidification bath can generally be at any temperature that facilitates solidification of the extruded polymer mixture. The solidification bath can be a mixture including a solvent in which the polymer is soluble and a solvent in which the polymer is not soluble. The solvent in which the polymer is not soluble is generally the primary solvent, wherein the solvent in which the polymer is not soluble makes up greater than 50% of the mixture by volume.

After passing through the solidification bath, the extruded polymer mixture gel can be passed through one or more solvent replacement baths. The solvent replacement baths are provided to replace the solvent in which the water-soluble polymer is soluble with the solvent in which the water-soluble polymer is not soluble to further solidify the extruded polymer mixture and, further, to replace the solvent in which the water-soluble polymer is soluble with a solvent that will more readily evaporate, thereby reducing the drying time. Solvent replacement baths can include a series of solvent replacement baths having a gradient of solvent in which the water-soluble polymer is soluble with the solvent in which the water-soluble polymer is not soluble, a series of solvent replacement baths having only the solvent in which the water-soluble polymer is not soluble, or a single solvent replacement bath having only the solvent in which the water-soluble polymer is not soluble. In example embodiments, at least one solvent replacement bath can consist essentially of a solvent in which the water-soluble polymer is not soluble.

Finished fibers are sometimes referred to as staple fibers, shortcut fibers, or pulp. In example embodiments, finishing includes drying the extruded polymer mixture. In example embodiments, finishing includes cutting or crimping the extruded polymer mixture to form individual fibers. Wet drawing of the extruded polymer mixture can provide a substantially uniform diameter to the extruded polymer mixture and, thus, the fibers cut therefrom. Drawing is distinct from extruding, as is well known in the art. In particular, “extruding” refers to the act of making fibers by forcing the resin mixture through the spinneret head whereas drawing refers to mechanically pulling the fibers in the machine direction to promote polymer chain orientation and crystallinity for increased fiber strength and tenacity.

In example embodiments wherein the water-soluble fibers are prepared from a wet cooled gel spinning process, the water-soluble polymer can be generally any water-soluble polymer or blend thereof, e.g., two or more different polymers, as generally described herein. In refinements of the foregoing embodiment, the polymer(s) can have any degree of polymerization (DP), for example, in a range of 10 to 10,000,000, for example, at least 10, at least 20, at least 50, at least 100, at least 200, at least 300, at least 400, at least 500, at least 750, or at least 1000 and up to 10,000,000, up to 5,000,000, up to 2,500,00, up to 1,000,000, up to 900,000, up to 750,000, up to 500,000, up to 250,000, up to 100,000, up to 90,000, up to 75,000, up to 50,000, up to 25,000, up to 12,000, up to 10,000, up to 5,000, or up to 2,500, for example in a range of 1000 to about 50,000, 1000 to about 25,000, 1000 to about 12,000, 1000 to about 5,000, 1000 to about 2,500, about 50 to about 12,000, about 50 to about 10,000, about 50 to about 5,000, about 50 to about 2,500, about 50 to about 1000, about 50 to about 900, about 100 to about 800, about 150 to about 700, about 200 to about 600, or about 250 to about 500. In example embodiments, the DP is at least 1,000. Auxiliary agents, as described above, can be added to the fibers themselves or to the nonwoven web during the carding and/or bonding process.

Thermoplastic Fiber Spinning

Thermoplastic fiber spinning is well known in the art. Briefly, thermoplastic fiber spinning includes the steps of:

(a) preparing a polymer mixture including the fiber forming polymer optionally including auxiliary agents;
(b) extruding the polymer mixture through a spinneret nozzle to form an extruded polymer mixture;
(c) optionally drawing the extruded polymer mixture; and
(d) finishing the extruded polymer mixture to provide the fibers.

The finished staple fibers of the thermoplastic fiber spinning process can be finished by drying, cutting, and/or crimping to form individual fibers. Drawing of the extruded polymer mixture mechanically pulls the fibers in the machine direction, promoting polymer chain orientation and crystallinity for increased fiber strength and tenacity. Preparing the polymer mixture for thermoplastic fiber spinning can include (a) preparing a solution of a fiber-forming material and a readily volatile solvent such that after extruding the solution through the spinneret when the solution is contacted with a stream of hot air, the solvent readily evaporates leaving solid fibers behind or (b) melting the polymer such that after extruding the hot polymer through the spinneret, the polymer solidifies by quenching with cool air. The thermoplastic fiber spinning method is distinct from the wet cooled gel spun method at least in that (a) in the thermoplastic fiber spinning method the extruded fibers are solidified by evaporation of the solvent or by quenching hot solid fibers with cool air, rather than by use of a solidification bath; and (b) in the wet-cool gel spun method, the optional drawing is performed while the fibers are in a gel state rather than a solid state.

Fiber forming materials for preparing fibers from a thermoplastic fiber spinning process can be any fiber forming polymer or blend thereof, e.g., two or more different polymers, provided that the polymer or blend thereof has suitable solubility in a readily volatile solvent and/or have a melting point lower than and distinct from their degradation temperature. Further, when a blend of fiber forming polymers are used to make a fiber, the fiber forming materials must have similar solubility in a readily volatile solvent and/or have similar heat profiles such that the two or more fiber forming materials will melt at similar temperatures. In contrast, the fiber forming materials for preparing fibers from the wet cooled gel spinning process are not as limited and fibers can be prepared from a blend of any two or more polymers that are soluble in the same solvent system, and the solvent system need not be a single solvent or even a volatile solvent.

The fiber forming polymer(s) for preparing thermoplastic fiber spun fibers can have a degree of polymerization (DP), for example, in a range of 10 to 10,000 for example, at least 10, at least 20, at least 50, at least 100, at least 200, at least 300, at least 400, at least 500, at least 750, or at least 1000 and up to 10,000, up to 5,000, up to 2,500, up to 1,000, up to 900, up to 750, up to 500, or up to 250. In example embodiments, the DP is less than 1,000.

Melt Spinning

Melt spinning is well known in the art and is understood to refer to both spun bond processes and melt blown processes. Melt spinning is a continuous process which directly prepares a nonwoven web in-line with fiber formation. As such, the melt-spun formed fibers are not finished and cut to any consistent length (e.g., staple fibers are not prepared by these processes). Additionally, melt spinning does not include a drawing step and, therefore, the only control over the diameter of the resulting melt-spun fibers is the size of the holes through which the fiber forming materials are extruded, and the polymer chains are not oriented in any specific direction.

In certain embodiments, melt spinning includes the steps of:

(a) preparing a polymer mixture including the fiber forming polymer optionally including auxiliary agents;
(b) extruding the polymer mixture into a die assembly to form an extruded polymer mixture;
(c) quenching the extruded polymer mixture;
(d) depositing the quenched, extruded polymer mixture on a belt to form a nonwoven web; and
(e) bonding the nonwoven web.

In the spun bond process, the extruded polymer mixture is pumped into the die assembly as molten polymer and quenched with cold air once passed through the die assembly. In the melt blown process, the extruded polymer mixture is pumped into a die assembly having hot air blown through it and is quenched upon exiting the die assembly and coming into contact with ambient temperature air. In both processes, the fibers are continuously dropped onto a belt or drum, usually facilitated by pulling a vacuum under the belt or drum.

The diameter of melt-spun fibers are in a range of about 0.1 to about 50 micron, for example, at least about 0.1 micron, at least about 1 micron, at least about 2 micron, at least about 5 micron, at least about 10 micron, at least about 15 micron, or at least about 20 micron and up to about 50 micron, up to about 40 micron, up to about 30 micron, up to about 25 micron, up to about 20 micron, up to about 15 micron, up to about 10 micron, about 0.1 micron to about 50 micron, about 0.1 micron to about 40 micron, about 0.1 micron to about 30 micron, about 0.1 micron to about 25 micron, about 0.1 micron to about 20 micron, about 0.1 micron to about 15 micron, about 0.1 micron to about 10 micron, about 0.1 micron to about 9 micron, about 0.1 micron to about 8 micron, about 0.1 micron to about 7 micron, about 0.1 micron to about 6 micron, about 0.1 micron to about 6 micron, about 5 micron to about 35 micron, about 5 micron to about 30 micron, about 7.5 micron to about 25 micron, about 10 micron to about 25 micron, or about 15 micron to about 25 micron. It is well known in the art that melt blown processes can provide micro-fine fibers having an average diameter in a range of about 1-10 micron, however, the melt blown process has very high variation in fiber-to-fiber diameter, e.g., 100-300% variation. Further, it is well known in the art that spun bond fibers can have larger average fiber diameters, e.g., about 15 to about 25 micron, but improved uniformity between fibers, e.g., about 10% variation.

The fiber forming material for heat extruded processes (e.g., melt-spun, thermoplastic fiber spinning) is more limited than for the wet-cooled gel spun process. For example, the degree of polymerization for heat extruding processes is limited to a range of about 200 to about 500. As the degree of polymerization decreases below 200, the viscosity of the fiber forming material is too low and the individual fibers prepared by pumping the material through the die assembly do not maintain adequate separation after exiting the die assembly. Similarly, as the degree of polymerization increases above 500, the viscosity is too high to efficiently pump the material through sufficiently small holes in the die assembly to run the process at high speeds, thus losing process efficiency and fiber and/or nonwoven uniformity. Further, processes requiring heating of the fiber forming material, are unsuitable for polyvinyl alcohol homopolymers as the homopolymers generally do not have the thermal stability required.

The wet cooled gel spinning process advantageously provides one or more benefits such as providing a fiber that includes a blend of water-soluble polymers, providing control over the diameter of the fibers, providing relatively large diameter fibers, providing control over the length of the fibers, providing control over the tenacity of the fibers, providing high tenacity fibers, providing fibers from polymers having a large degree of polymerization, and/or providing fibers which can be used to provide a self-supporting nonwoven web. Continuous processes such as spun bond, melt blown, electro-spinning and rotary spinning generally do not allow for blending of water-soluble polymers (e.g., due to difficulties matching the melt index of various polymers), forming large diameter (e.g., greater than 50 micron) fibers, controlling the length of the fibers, providing high tenacity fibers, and the use of polymers having a high degree of polymerization. Further, the wet cooled gel spinning process advantageously is not limited to polymers that are only melt processable and, therefore, can access fibers made from fiber forming materials having very high molecular weights, high melting points, low melt flow index, or a combination thereof, providing fibers having stronger physical properties and different chemical functionalities compared to fibers prepared by a heat extrusion process. Further still, advantageously, the wet cooled gel spinning process is not limited by the viscosity of the polymer. In contrast, it is known in the art that processes that require melting of the fiber forming material are limited to fiber forming materials having viscosities of 5 cP or less. Thus, fibers including polymers, including polyvinyl alcohol homopolymers and copolymers, having a viscosity of greater than 5 cP are only accessible by wet cooled gel spinning.

### Methods of Preparing Nonwoven Webs

The nonwoven webs of the disclosure are sheet-like structures having two exterior surfaces, the nonwoven webs including a plurality of fibers. The nonwoven webs of the disclosures can be prepared from fibers using any known methods in the art. As is known in the art, when fibers are spun bond or melt blown, the fibers are continuously laid down to form the nonwoven web, followed by bonding of the fibers.

Staple fibers can be carded or airlaid and bonded to provide a nonwoven web. Methods of carding and airlaying are well known in the art.

Methods of bonding nonwoven webs are well known in the art. For example, bonding can include thermal, mechanical, and/or chemical bonding. Thermal bonding can include, but is not limited to calendering, embossing, air-through, and ultra-sound. Mechanical bonding can include, but is not limited to, hydro-entangling (spunlace), needle-punching, and stitch-bonding. Chemical bonding can include, but is not limited to, solvent bonding and resin bonding.

Thermal bonding is achieved by applying heat and pressure, and maintains the pore size, shape, and alignment produced by the carding process. The conditions for thermal bonding can be readily determined by one of ordinary skill in the art. If the heat and/or pressure applied is too low, the fibers will not sufficiently bind to form a free-standing web and if the heat and/or pressure is too high, the fibers will begin to meld together. The fiber chemistry dictates the upper and lower limits of heat and/or pressure for thermal bonding. Without intending to be bound by theory, it is believed that at temperatures above 235° C., polyvinyl alcohol-based fibers degrade. Methods of embossment for thermal bonding of fibers are known. The embossing can be a one-sided embossing or a double-sided embossing. Embossing of water-soluble fibers includes one-sided embossing using a single embossing roll consisting of an ordered circular array and a steel roll with a plain surface. As embossing is increased (e.g., as surface features are imparted to the web), the surface area of the web is increased. Without intending to be bound by theory it is expected that as the surface are of the web is increased, the solubility of the web is increased. Accordingly, the solubility properties of the nonwoven web can be advantageously tuned by changing the surface area through embossing.

Air-through bonding requires a high thermoplastic content in the nonwoven web and two different melting point materials. In air-through bonding, the nonbonded nonwoven web is circulated around a drum while hot air flows from the outside of the drum toward the center of the drum. Air-through bonding can provide nonwovens having low density and higher basis weight (e.g., greater than 20 to about 2000 g/m²). Nonwovens bonded by air-bonding is very soft.

Chemical bonding includes solvent bonding and resin bonding. In particular, chemical bonding may use a binder solution of a solvent and a resin (e.g., latex or the waste polymer left over from preparing the fibers). The nonwoven can be coated with the binder solution and heat and pressure applied to cure the binder and bond the nonwoven. The binder solution can be applied by immersing the nonwoven in a bath of binder solution, spraying the binder solution onto the nonwoven, extruding the binder solution onto the web (foam bonding), and/or applying the binder solution as a print or gravure.

Chemical bonding can result in smaller, less ordered pores relative to the pores as carded/melt-spun. Without intending to be bound by theory, it is believed that if the resin solution used for chemical bonding is sufficiently concentrated and/or sufficient pressure is applied, a nonporous nonwoven web can be formed. The solvent used in chemical bonding induces partial solubilization of the existing fibers in the web to weld and bond the fibers together. Thus, the solvent for chemical bonding can be any solvent that can at least partially solubilize one or more fiber forming materials of the fibers of the nonwoven. In example embodiments, the solvent is selected from the group consisting of water, ethanol, methanol, DMSO, glycerin, and a combination thereof. In example embodiments, the solvent is selected from the group consisting of water, glycerin, and a combination thereof. In example embodiments, the binder solution comprises a solvent selected from the group consisting of water, ethanol, methanol, DMSO, glycerin, and a combination thereof and further comprises a resin selected from the group consisting of polyvinyl alcohol, latex, and polyvinylpyrrolidone. The binder provided in the solution assists in the welding process to provide a more mechanically robust web. The temperature of the polymer solution is not particularly limited and can be provided at room temperature (about 23° C.).

In some embodiments, a second layer of fibers can be used to bond the nonwoven web. In example embodiments, the nonwoven layer can be bonded using thermal, mechanical, or chemical bonding, alone or in addition to bonding using an additional layer of nonwoven web/fibers.

### Methods of Laminating Films to Nonwoven Webs or Foam Substrates

Methods of preparing a laminate (e.g., water-soluble film and a nonwoven) can include, but is not limited to, calender lamination (thermal with pressure) or melt adhesion.

Calender lamination is achieved by applying heat and pressure. The conditions for calender lamination can be readily determined by one of ordinary skill in the art. If the heat and/or pressure applied is too low, the fibers will not sufficiently bind to the water-soluble film to form a laminate and if the heat and/or pressure is too high, the fibers will begin to meld together with each other and the film. The fiber chemistry and film chemistry dictates the upper and lower limits of heat and/or pressure for calender lamination. Without intending to be bound by theory, it is believed that at temperatures above 235° C., polyvinyl alcohol-based fibers degrade. In example embodiments, the heat added to the overlaid nonwoven and water-soluble film is about 50° C. to about 200° C., for example, about 100° C. to about 200° C., about 110° C. to about 190° C., about 120° C. to about 180° C., or about 130° C. to about 160° C. In example embodiments, the pressure applied to the overlaid nonwoven and water-soluble film is about 5 psi to about 50 psi, such as, about 10 psi to about 40 psi, about 15 psi to about 30 psi, or about 20 psi to about 30 psi. In example embodiments, the heat added to the overlaid nonwoven and water-soluble film is about 150° C. and the pressure applied is about 25 psi. In example embodiments, the heat and pressure are applied for about 2-4 seconds. Methods of embossment for calender lamination of fibers and/or the film are contemplated. The embossing can be a one-sided embossing or a double-sided embossing. Embossing of water-soluble fibers and/or water-soluble films includes one-sided embossing using a single embossing roll consisting of an ordered circular array and a steel roll with a plain surface. As embossing is increased (e.g., increased amounts of surface features are imparted to the web and/or the film), the surface area of the laminate is increased. Without intending to be bound by theory it is believed that as the surface of the article is decreased, the solubility of the web and/or film is decreased. Accordingly, the solubility properties of the nonwoven web and/or water-soluble film can be advantageously tuned by changing the surface area through embossing. Without intending to be bound by theory, it is believed that as the degree of lamination of the unit dose article is increased, the surface area of the laminate decreases and the bonding between the water-soluble film and nonwoven increases, resulting in the solubility decreasing and the liquid release time increasing.

Melt adhesion lamination is achieved by applying an adhesive directly to the water-soluble film and the nonwoven web is then laid on top of the water-soluble film with the applied adhesive and is subjected to cold lamination for adhesion of the nonwoven web and the water-soluble film. As used herein, the term “cold lamination” refers to a lamination process that involves pressure but does not involve added heat. The adhesive can be any suitable adhesive to one of ordinary skill in the art. In example embodiments, the adhesive is a Henkel National Adhesive. The application of the adhesive directly to the water-soluble film can be applied by any suitable method to one of ordinary skill in the art, such as, a hot melt-spray process. In example embodiments, the melt adhesion lamination process can include a hot melt spray process at 160° C., followed by cold lamination at a pressure of 94 N/mm².

The laminate of the disclosure may include a water-soluble film and a nonwoven web. In example embodiments, the laminates can have a degree of lamination of about 1% to about 100%, for example, the degree of lamination can be in a range of about 1% to about 90%, or about 25% to about 75%, or about 1% to about 50%, or about 5% to about 25%, or about 25% to about 100%, or about 50% to about 100%. As used herein, the term “degree of lamination” refers to the amount of total area of the water-soluble film that is bonded to the nonwoven web. For example, a laminate having a degree of lamination of about 25% or less means that about 25% or less of the water-soluble film's area is bonded to the nonwoven web, e.g., lamination at the seals only. For example, a laminate having a degree of lamination of about 100% means that about 100% of the area of the water-soluble film is bonded to the nonwoven web. In example embodiments wherein the degree of lamination is about 25% or less, the laminate can be achieved during the heat seal process wherein the lamination occurs at each seal of the unit dose article. In example embodiments wherein the laminate has a degree of lamination of about 25% or less, this low degree of lamination can be advantageous as there is an interior void volume where the water-soluble film and the nonwoven web are not laminated providing physical separation for components having non-compatible chemistries, as well as providing an opportunity for a 2-step delivery system of compositions in a unit dose article. In example embodiments, the degree of lamination is in a range of about 5% to about 25%. In example embodiments, the degree of lamination is in a range of about 50% to about 100%.

### Dissolution and Disintegration Test (Modified MSTM-205)

A nonwoven web, water-soluble film, or laminate structure can be characterized by or tested for Dissolution Time and Disintegration Time according to the MonoSol Test Method 205 (MSTM 205), a method known in the art. See, for example, U.S. Pat. No. 7,022,656. The description provided below refers to a nonwoven web, while it is equally applicable to a water-soluble film or laminate structure.

Apparatus and Materials:

600 mL Beaker

Magnetic Stirrer (Labline Model No. 1250 or equivalent)

Magnetic Stirring Rod (5 cm)

Thermometer (0 to 100° C.±1° C.)

Template, Stainless Steel (3.8 cm×3.2 cm)

Timer (0-300 seconds, accurate to the nearest second)

Polaroid 35 mm slide Mount (or equivalent)

MonoSol 35 mm Slide Mount Holder (or equivalent)

Distilled water

For each nonwoven web to be tested, three test specimens are cut from a nonwoven web sample that is a 3.8 cm×3.2 cm specimen. Specimens should be cut from areas of web evenly spaced along the traverse direction of the web. Each test specimen is then analyzed using the following procedure.

Lock each specimen in a separate 35 mm slide mount.

Fill beaker with 500 mL of distilled water. Measure water temperature with thermometer and, if necessary, heat or cool water to maintain the temperature at the temperature for which dissolution is being determined, e.g., 20° C. (about 68° F.).

Mark height of column of water. Place magnetic stirrer on base of holder. Place beaker on magnetic stirrer, add magnetic stirring rod to beaker, turn on stirrer, and adjust stir speed until a vortex develops which is approximately one-fifth the height of the water column. Mark depth of vortex.

Secure the 35 mm slide mount in the alligator clamp of the 35 mm slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the nonwoven web surface is perpendicular to the flow of the water.

In one motion, drop the secured slide and clamp into the water and start the timer. Rupture occurs when the sample has become compromised within the slide, for example, when a hole is created. Disintegration occurs when the nonwoven web breaks apart and no sample material is left in the slide. When all visible nonwoven web is released from the slide mount, raise the slide out of the water while continuing to monitor the solution for undissolved nonwoven web fragments. Dissolution occurs when all nonwoven web fragments are no longer visible and the solution becomes clear. Rupture and dissolution can happen concurrently for nonwoven samples wherein the fibers are prepared from polyvinyl alcohol polymer having a low degree of hydrolysis (e.g., about 65-88%). Dissolution times are recorded independently of rupture times when there is a 5 second or greater difference between rupture and dissolution.

Thinning time can also be determined using MSTM-205. Thinning of a nonwoven web occurs when some of the fibers making up the nonwoven web dissolve, while other fibers remain intact. The thinning of the web occurs prior to disintegration of the web. Thinning is characterized by a decrease in opacity, or increase in transparency, of the nonwoven web. The change from opaque to increasingly transparent and can be visually observed. During MSTM-205, after the secured slide and clamp have been dropped into the water the opacity/transparency of the nonwoven web is monitored. At the time point wherein no change in opacity/transparency is observed (i.e., the web does not become any less opaque or more transparent), the time is recorded as the thinning time.

The results should include the following: complete sample identification; individual and average disintegration and dissolution times; and water temperature at which the samples were tested.

I_{corrected}=I_{measured}×(reference thickness/measured thickness)^{1.93} [1]

S_{corrected}=S_{measured}×(reference thickness/measured thickness)^{1.83} [2]

### Method for Determining Single Fiber Solubility

The solubility of a single fiber can be characterized by the water breaking temperature. The fiber breaking temperature can be determined as follows. A load of 2 mg/dtex is put on a fiber having a fixed length of 100 mm. Water temperature starts at 1.5° C. and is then raised by 1.5° C. increments every 2 minutes until the fiber breaks. The temperature at which the fiber breaks is denoted as the water breaking temperature.

The solubility of a single fiber can also be characterized by the temperature of complete dissolution. The temperature of complete dissolution can be determined as follows. 0.2 g of fibers having a fixed length of 2 mm are added to 100 mL of water. Water temperature starts at 1.5° C. and is then raised by 1.5° C. increments every 2 minutes until the fiber completely dissolves. The sample is agitated at each temperature. The temperature at which the fiber completely dissolves in less than 30 seconds is denoted as the complete dissolution temperature.

### Diameter Test Method

The diameter of a discrete fiber or a fiber within a nonwoven web is determined by using a scanning electron microscope (SEM) or an optical microscope and an image analysis software. A magnification of 200 to 10,000 times is chosen such that the fibers are suitably enlarged for measurement. When using the SEM, the samples are sputtered with gold or a palladium compound to avoid electric charging and vibrations of the fiber in the electron beam. A manual procedure for determining the fiber diameters is used from the image (on monitor screen) taken with the SEM or the optical microscope. Using a mouse and a cursor tool, the edge of a randomly selected fiber is sought and then measured across its width (i.e., perpendicular to the fiber direction at that point) to the other edge of the fiber. A scaled and calibrated image analysis tool provides the scaling to get an actual reading in microns. For fibers within a nonwoven web, several fibers are randomly selected across the sample of nonwoven web using the SEM or the optical microscope. At least two portions of the nonwoven web material are cut and tested in this manner. Altogether at least 100 such measurements are made and then all data are recorded for statistical analysis. The recorded data are used to calculate average (mean) of the fibers, standard deviation of the fibers, and median fiber diameters.

### Tensile Strength, Modulus, and Elongation Test

A nonwoven web, water-soluble film, or laminate structure characterized by or to be tested for tensile strength according to the Tensile Strength (TS) Test, modulus (or tensile stress) according to the Modulus (MOD) Test, and elongation according to the Elongation Test is analyzed as follows. The description provided below refers to a nonwoven web, while it is equally applicable to a water-soluble film or laminate structure. The procedure includes the determination of tensile strength and the determination of modulus at 10% elongation according to ASTM D 882 (“Standard Test Method for Tensile Properties of Thin Plastic Sheeting”) or equivalent. An INSTRON tensile testing apparatus (Model 5544 Tensile Tester or equivalent) is used for the collection of nonwoven web data. A minimum of three test specimens, each cut with reliable cutting tools to ensure dimensional stability and reproducibility, are tested in the machine direction (MD) (where applicable) for each measurement. Tests are conducted in the standard laboratory atmosphere of 23±2.0° C. and 35±5% relative humidity. For tensile strength or modulus determination, 1″-wide (2.54 cm) samples of a nonwoven web are prepared. The sample is then transferred to the INSTRON tensile testing machine to proceed with testing while minimizing exposure in the 35% relative humidity environment. The tensile testing machine is prepared according to manufacturer instructions, equipped with a 500 N load cell, and calibrated. The correct grips and faces are fitted (INSTRON grips having model number 2702-032 faces, which are rubber coated and 25 mm wide, or equivalent). The samples are mounted into the tensile testing machine and analyzed to determine the 100% modulus (i.e., stress required to achieve 100% film elongation), tensile strength (i.e., stress required to break film), and elongation % (sample length at break relative to the initial sample length). In general, the higher the elongation % for a sample, the better the processability characteristics for the nonwoven web (e.g., increased formability into packets or pouches).

### Abrasion Test

Off Hand Test:

3″ diameter discs are fitted with Roloc™ attachment. A carbon steel test panel as well as an aluminum test panel are abraded with a coated abrasive belt corresponding to any Example on hackstand to impose a linear grain on the test piece. The average Ra is 75 pin on carbon steel and 150 pin on aluminum test panels. The panel and disc are then weighed before testing.

Off Hand Short Test:

For one minute, working in the direction of the grain of the respective panel, scratches were removed from half of the panel with the nonwoven disc according to any Example. For a second one-minute period, working in the direction of the grain, the scratches are removed from the second half of the panel. The disc and workpiece are then cleaned and weighed. The Ra of the panel is also measured in 5 discreet areas and recorded.

Off Hand Long Test:

For one minute, working in the direction of the grain of the respective panels, scratches are removed from half of the panel with the nonwoven disc according to any Example. For a second one-minute period, working in the direction of the grain, the scratches are removed from the second half of the panel.

The panel is weighed before and after the 2-minute period to determine the mass loss of the panel.

A new panel is used for another 2 minutes with the methodology used above.

This process is continued for 4 panels—8 minutes of total off hand grinding time for each disc. The surface finish is measured on the first panel and the fourth panel in 5 discreet areas per panel. The highest and lowest surface finish numbers are discarded and the middle 3 Ra numbers are averaged. The average surface finish from panel 1 and panel 4 are averaged to give the final surface finish number.

XY Auto Test:

3″ diameter discs are fitted with Roloc™ attachment. The XY tests the disc for 8 cycles. Each cycle is 1 minute long in which the disc abraded a flat test panel. During the testing a robotic arm moves in the X and Y directions abrading the surface of the panel. The Ra that the disc leaves behind is checked after the first cycle and after cycle #8 in 5 discreet areas. The panel and disc are weighed before cycle 1 and after cycle 8 to determine the substrate and disc mass loss.

Force and RPM used when abrading carbon steel is either 5 pounds (lbs.) and 9000 RPM or 10 lbs. and 11,000 RPM. Force used when abrading aluminum is either 5 lbs. and 9,000 RPM or 5 lbs. and 11,0000 RPM.

Fiber Shrinkage Percent Test (MSTM)

A percent shrinkage of a fiber when contacted with a suitable amount of a carrier solvent can be determined according to a Fiber Shrinkage Percent Test under MonoSol Standard Operating Procedure.

Apparatus and Materials:

1. Fiber samples (approx. 3 grams)

2. 500 mL beaker

3. Chilled deionized water (located in refrigerator)

4. Deionized water

5. Paper clip

6. Alligator clamp (solubility stand)

7. Stir plate

8. Timer

Samples are prepared as follows:

1. Obtain a small bundle of fibers that isn't entangled. Enough to ensure it will hold in the paper clip and the alligator clamp, approximate weight of fiber bundle is 0.013 gram (g) to 0.015 g.

2. Take a paper clip and pull an end of the fiber through the cross sections of the paper clip.

3. Do this so each unique fiber to be tested has a replicate of N=3 for each testing temperature, 23° C. and 10° C.

Apparatus set-up:

1. Fill 500 ml beaker with 400 ml of respective temperature water. Make sure to check the water temperature with a temperature probe before and during testing.

2. Tape a ruler to the top of the alligator clamp so the ruler hangs parallel to the clamp.

3. Place the beaker on a stir plate and place the solubility stand next to the stir plate, submerging ruler into beaker so then you can read the length.

Testing procedure:

1. Attach the free end of the paper clipped fiber in the alligator clamp.

2. Submerge the test sample into the beaker so that the test sample is aligned next to the ruler.

3. Start the timer and record the initial length of the fiber. The test sample fiber length is from the end of alligator clip to the top of the paper clip.

4. After two minutes, record the final length of the fiber.

5. Lift the clamp out of the water and remove the sample from the clamp. Be sure to thoroughly dry off the outside of the clamp and the inside of clamp between each test.

Calculating Shrinkage Percent:

Shrinked length=initial length−final length [3]

Fiber Shrinkage (%)=(shrinked length/initial length)×100% [4]

### Uses of Articles

The articles of the disclosure are suitable for a variety of commercial applications. Suitable commercial applications for the article such as the single unit dose articles of the disclosure include delivering active cleaning formulations including, without limitation, a laundry detergent, a soap, a fabric softener, a bleaching agent, a laundry booster, a stain remover, an optical brightener, or a water softener. In example embodiments, the active cleaning formulation may include, without limitation, actives, detergents, surfactants, emulsifiers, chelants, dirt suspenders, stain releasers, enzymes, pH adjusters, builders, soil release polymers, structurants, free fragrance, encapsulated fragrance, preservatives, solvent, minerals, and/or any ingredients suitable in personal care, laundry detergent, dish detergent, and/or home surface cleaners or cleansers. Other examples include a dish detergent, soap or cleaner, a shampoo, a conditioner, a body wash, a face wash, a skin lotion, a skin treatment, a body oil, fragrance, a hair treatment, a bath salt, an essential oil, a bath bomb, or an enzyme. The active cleaning formulation may be in the form of a solid, e.g., a powder or a plurality of granules or particles, a gel, a liquid, or a slurry formulation, or any suitable combination of a powder, a solid, a gel, a liquid, or a slurry formulation, for example.

Additional applications for the unit dose articles of the disclosure can include delivering personal care products such as exfoliating materials, shampoo, conditioner, body wash, face wash, skin lotion, skin treatment, hair treatment, bath salts, essential oil, or a combination thereof. Additional contemplated applications include those that can involve a constant flow of water, for example, automotive cleaning applications and/or dish cleaning applications. Advantageously, in such applications, before and/or once at least a portion of the composition is released from the article, the nonwoven web can be used to facilitate foaming and/or scrubbing hard to remove grime without damaging the surface being cleaned, for example, the paint on a car or a non-stick cooking surface.

### EXAMPLES

As described herein, the unit dose article may include one of the following constructions, wherein a first surface or a first side of the nonwoven substrate is fibrous in appearance and a second surface or a second side of the nonwoven substrate is generally smooth or coated with water to create a continuous layer using a heat and/or water application:

(a) a single use cold water-dispersible nonwoven cleaning article, such as a towel or pad, having no moisture or a low moisture dish wash detergent and an abrasive material on one or more surfaces of the nonwoven towel for cleaning dry dishes; the water-soluble nonwoven towel is dissolved when contacted with cold water and delivers a sanitizer for soaking the dishes to be cleaned, once the dishes are cleaned, the dishes can be rinsed and dried on a rack, for example; or

(b) a hot water-soluble (>40° C.) nonwoven cleaning article, such as a towel or pad, having a dish wash detergent and an abrasive material for cleaning dishes, the water-soluble nonwoven towel is dissolved when contacted with hot water and delivers a sanitizer for soaking the dishes to be cleaned, once the dishes are cleaned, the dishes can be rinsed and dried on a rack. The cleaning article can be for single use or multiple uses. The cleaning article may comprises a single layer or multiple layers of nonwoven sheets.

The nonwoven article, such as a towel or pad, can be water-dispersible at a temperature below 40° C., for example, in a range of from about 10° C. to about 40° C., and water-soluble at a temperature of 40° C. and above, for example, in a range of from about 50° C. to about 100° C., or from about 60° C. to about 70° C. In certain embodiments, a plurality of particles of an active cleaning formulation can be bonded to the core substrate, such as a nonwoven substrate, to form the abrasive surface as described herein. A consumer uses a single-use nonwoven towel to scrub dishes. The towel delivers the necessary cleaning for a suitable load of hand-washed dishes, as well as an abrasive, for cleansing the physical food stuffs from the cookware, e.g., a pot, a pan, a plate, dinnerware, and/or cutlery. In example embodiments, the cookware is scrubbed when the cookware is dry. Once a suitable amount of the food stuffs are removed using the towel, the towel can be dissolved in a sink, for example, or in a soaking tub to deliver sanitizers or dish cleaning soap for further removal of debris and sanitization of cookware. In other example embodiments, cold water is applied to the cookware as the cookware is scrubbed, and the towel dissolves progressively or slowly during use. Once the cookware is washed, hot water is applied and the towel dissolves completely or substantially completely to deliver the sanitizing agent. In other example embodiments, the towel does not dissolve during use and the cookware is washed with hot water. An active cleaning formulation is continuously released and the towel does not dissolve during use. In certain embodiments, the cleaning article can be used multiple times. The cleaning article, such as towel or pad, can be disposed of in the dishwasher where the core substrate fully or substantially dissolves and aids in dish washing, or the towel is placed in the trash where the single use towel has an improved biodegradation profile, or the towel is recycled.

In the Examples, a nonwoven substrate including an active cleaning formulation is described as one example of the core substrate for illustration purposes. The core substrate and the active cleaning formulation can have any composition and/or form as described herein. For example, the core substrate can be a water-dispersible and/or water-soluble nonwoven, foam, film, or any combination thereof. Such core substrate may include one or more PVOH polymers such as vinyl alcohol-vinyl acetate copolymers. For example, in certain embodiments, the core substrate includes at least one nonwoven web or sheet comprising the plurality of fibers. The plurality of fibers comprise a first type of fiber comprising a polyvinyl alcohol copolymer having a degree of hydrolysis in a range of about 75% to about 89.9% (e.g., 80%-89.9%), and a second type of fiber comprising a polyvinyl alcohol copolymer having a degree of hydrolysis in a range of about 90% to about 99.9% (e.g., 95%-98%). A suitable ratio of the first type of fiber to the second type of fiber is, for example, in a range of from about 5:95 to about 25:75 by weight. In certain embodiments, the first type of fiber and the second type of fiber are mixed together in the at least one nonwoven web or sheet. In certain embodiments, the at least one nonwoven web or sheet comprises a first type of nonwoven made of the first type of fiber and a second type of nonwoven made of the second type of fiber. The two types of fibers may be in different nonwoven webs or sheets. In certain example embodiments, the cleaning article may include PVOH polymer-based fibers blended with non-PVOH polymer fibers, such as polyester, polylactic acid, and/or cellulose-based fibers.

### Fibers Used

As shown in Table 1, several types of fibers, i.e., Fiber 1 (“F1”), Fiber 2 (“F2”), Fiber 3 (“F3”), and Fiber 4 (“F4”) which comprise a copolymer of vinyl acetate and vinyl alcohol having a degree of hydrolysis of 88%, 96%, 98%, and 99.99%, respectively, were used as the starting materials. These fibers have uniform composition, and have additional properties shown in Table 1. In the Examples described herein, Fibers F1 and F2 each had a fineness-length of 2.2 dpf-51 mm. Fiber F3 includes two types of fibers: a first fiber type having a fineness-length of 1.7 dtex-38 mm, and a second fiber type having a fineness of 2.2 dtex-51 mm. Fiber F4 had a fineness-length of 1.7 dtex-38 mm. The units of fineness dtex and dpf are similar to each other and can be converted using a coefficient (dtex=dpf/0.9). In the Examples, a polymer comprising vinyl alcohol moieties is referred as “a polyvinyl alcohol polymer” and a fiber comprising such a polymer is referred as “a polyvinyl alcohol fiber.”

TABLE 1

| | Viscosity | | | | | Elonga- |
|---|---|---|---|---|---|---|
| | (4% | DH | Fineness | Solubility | Tenacity | tion |
| Fiber | solution) | (mol %) | (dtex) | Temp (C.) | (cN/dtex) | (%) |
| F1 | 22-23 | 88 | 2.2 | 20 | 5 | 20 |
| F2 | 22-23 | 96 | 2.2 | 40 | 7 | 15 |
| F3 | 22-23 | 98 | 1.7, 2.2 | 70 | 7 | 12 |
| F4 | 22-23 | 99.99 | 1.7 | 95 | 9 | 10 |

As shown in Table 2, under different bonding conditions, the four types of fibers were used to make nonwoven core substrates. In certain examples, the two type of fibers were also mixed to make one type of nonwoven core substrate (called a “blended nonwoven”).

TABLE 2

| | Composition | | | | | | | |
|---|---|---|---|---|---|---|---|---|
| | Fiber F1 - | Fiber F2- | Fiber F3 | Fiber F3 | Fiber F4 | Calender Bonding | | |
| | 2.2 dpf × | 2.2 dpf × | 1.7 dtex × | 2.2 dtex × | 1.7 dtex × | Calendar | Calender | Calender |
| | 51 mm | 51 mm | 38 mm | 51 mm | 38 mm | Speed | Pressure | Temperature |
| Sample | (%) | (%) | (%) | (%) | (%) | (FPM) | (psi) | (° C.) |
| Ex. 1 | | | 100 | | | 1 | 40 | 180 |
| Ex. 2 | | | 100 | | | 1 | 50 | 180 |
| Ex. 3 | | | 100 | | | 1 | 50 | 190 |
| Ex. 4 | | | | | 100 | 1 | 40 | 190 |
| Ex. 5 | | | 50 | 50 | | 2 | 40 | 180 |
| Ex. 6 | | | 50 | 50 | | 2 | 40 | 190 |
| Ex. 7 | | | 50 | | 50 | 2 | 40 | 180 |
| Ex. 8 | | | 50 | | 50 | 2 | 40 | 190 |
| Ex. 9 | | | | 50 | 50 | 2 | 40 | 180 |
| Ex. 10 | | | | 50 | 50 | 2 | 40 | 190 |
| Ex. 11 | 25 | | 75 | | | 2 | 40 | 180 |
| Ex. 12 | 25 | | | | 75 | 2 | 40 | 180 |
| Ex. 13 | 75 | | 25 | | | 2 | 40 | 180 |
| Ex. 14 | 75 | | | | 25 | 2 | 40 | 180 |
| Ex. 15 | 50 | | 50 | | | 2 | 40 | 180 |
| Ex. 16 | | 50 | 50 | | | 2 | 40 | 180 |
| Ex. 17 | 50 | | | | 50 | 2 | 40 | 180 |

The properties for Examples 1-17 are shown in Tables 3 and 4. These properties include solubility data, such as rupture time and disintegration time, tensile strength, softness rating, and surface roughness. These nonwoven (NW) samples were also applied to a testing substrate made of acrylic polymer on aluminum. The gloss of the testing substrate before and after the applications were recorded. The Ra values were measured using an SPI Roughness Tester II, which had measurement limit of 250 μm. The gloss measurement were performed using a BYK micro-TRI-gloss. All gloss measurements were recorded at 20°.

TABLE 3

| | | | | | | Softness |
|---|---|---|---|---|---|---|
| | | | | | | Rating |
| | Solubility 80° C. | | Solubility 90° C. | | Tensile | 1 - softest, |
| | Rupture | Disintegration | Rupture | Disintegration | Max Load | 5 - extremely |
| Sample | (s) | (s) | (s) | (s) | (N) | rough |
| Ex. 1 | 3.33 | 7.67 | | | 6.99 | 3 |
| Ex. 2 | 2.67 | 9.00 | | | 3.58 | 2 |
| Ex. 3 | 4.33 | 10.33 | | | 9.33 | 3 |
| Ex. 4 | | | 7.67 | 15.67 | 6.13 | 3 |
| Ex. 5 | 2.67 | 21.33 | | | 7.37 | 2 |
| Ex. 6 | 4.67 | 21.00 | | | 7.24 | 3 |
| Ex. 7 | | | 5.33 | 13.33 | 1.59 | 2 |
| Ex. 8 | | | 23.33 | 74.00 | 2.49 | 3 |
| Ex. 9 | | | 4.33 | 10.33 | 7.75 | 2 |
| Ex. 10 | | | 13.67 | 41.00 | 10.08 | 3 |
| Ex. 11 | | | | | 10.07 | 5 |
| Ex. 12 | | | 3.33 | 8.33 | 7.64 | 3 |
| Ex. 13 | | | | | 61.10 | 5 |
| Ex. 14 | | | 4.33 | 13.00 | 5.31 | 3 |
| Ex. 15 | 10.33 | 32.00 | | | 29.81 | 5 |
| Ex. 16 | 5.00 | 10.00 | | | 2.86 | 3 |
| Ex. 17 | | | 8.00 | 21.67 | 7.46 | 3 |

TABLE 4

| | | | Gloss (Acrylic |
|---|---|---|---|
| | Surface | Gloss (Acrylic | on Aluminum |
| | Roughness | on Aluminum | Sheet) Post |
| | Average Ra | Sheet) | NW |
| Sample | (μin) | Average GU | Average GU |
| Ex. 1 | 159.33 | 254.5 | 249.5 |
| Ex. 2 | 160.33 | 250.5 | 255.5 |
| Ex. 3 | 173 | 254.5 | 249.5 |
| Ex. 4 | 154.67 | 254.5 | 253 |
| Ex. 5 | 197.00 | 252.5 | 249.5 |
| Ex. 6 | 216.67 | 250.5 | 250.5 |
| Ex. 7 | 175.33 | 251.5 | 257 |
| Ex. 8 | 189.33 | 249.5 | 255.5 |
| Ex. 9 | 214.33 | 255 | 233 |
| Ex. 10 | 169.67 | 253.5 | 250.5 |
| Ex. 11 | 241.67 | 250.5 | 248.5 |
| Ex. 12 | 207.67 | 248.5 | 250 |
| Ex. 13 | 249.67 | 251.5 | 249.5 |
| Ex. 14 | 208.00 | 251 | 250 |
| Ex. 15 | 250.67 | 254.5 | 253.5 |
| Ex. 16 | 205.33 | 249 | 255 |
| Ex. 17 | 225 | 253 | 254.5 |

Based on the compositions and the property data shown in Tables 2-4, in example embodiments at least one nonwoven (as the core substrate) comprises a plurality of fibers made of a PVOH copolymer having a degree of hydrolysis in a range of 90-99.99%, more particularly in a range of 90% to 98%. For example, nonwoven substrates made of one or two fibers, such as Fiber F3 (D.H. of 98%) or a combination of Fiber F3 and Fiber F2 (D. H. of 96%), for example, Samples Exs. 1, 5, and 16, provide a short disintegration time in hot water (e.g., at 80° C.) and good softness. Fiber F1 (D.H. 88%) can be also combined with Fiber F3 or F2, but the content of Fiber F1 in example embodiments is less than 50% or equal to or less than 25% of a total weight of the fibers. The introduction of F1 (e.g., Sample Exs. 11, 13, and 15) tends to decrease the softness and increase disintegration time of the nonwoven samples. Most of the samples were calendered at 180° C. Fiber F1 is more heat sensitive and susceptible to heat degradation when compared to Fiber F2 and Fiber F3 resulting in stiffer nonwoven samples. With an increasing amount of Fiber F4, the disintegration time of a resulting nonwoven sample in hot water tends to increase. As shown in Table 4, the stiffer fibers had a higher Ra value, but there was no observable difference in gloss measurements to assess or distinguish the abrasiveness of Experimental Samples 1-17.

As shown in Table 5, Experimental Samples 18-23 were made from blends of Fiber F2 with other fiber chemistries of varying denier, including TREVIRA™ polyester fibers, polylactic acid (PLA) fibers, Rayon Viscose (cellulose) fibers, polyethylene terephthalate (PET) fibers, VESTERA™ cellulose fibers, and LENZING LYOCELL™ cellulose fibers. The property data of these samples are shown in Table 6. Blends of nonwovens with fibers of higher denier, are expected to be less soft comparted to lower denier blends.

TABLE 5

| | Composition | | | | | | |
|---|---|---|---|---|---|---|---|
| | | TREVIRA | Polylatic | Rayon | | Round | Lenzing |
| | Fiber F2 - | polyester | acid (PLA) | Viscose | | Vestera | Lyocell |
| | 2.2 dpf × | 298 1.5 dpf × | 6 dpf × | 5 dpf × | PET | 1.8 dtex × | 1.5 dpf × |
| Sample | 51 mm (%) | 38 mm (%) | 60 mm (%) | 76 mm (%) | 20 dpf | 51 mm (%) | 38 mm (%) |
| Ex. 18 | 50 | 50 | | | | | |
| Ex. 19 | 50 | | 50 | | | | |
| Ex. 20 | 50 | | | 50 | | | |
| Ex. 21 | 75 | | | | 25 | | |
| Ex. 22 | 50 | | | | | | 50 |
| Ex. 23 | 50 | | | | | 50 | |

TABLE 6

| | Calendar Bonding | | | | | | | |
|---|---|---|---|---|---|---|---|---|
| | Settings | | Basis | Solubility | Solubility | Tensile | Softness | Surface |
| | Calender | Calender | Weight | 23° C. | 40° C. | Max | Rating | Roughness |
| | Pressure | Temperature | Target | Rupture | Rupture | Load | 1- softest, | Average |
| Sample | (psi) | (° C.) | (GSM) | (s) | (s) | (N) | 5 - rough | Ra (μin) |
| Ex. 18 | 40 | 140 | 50 | | | 3.95 | 2 | 187 |
| Ex. 19 | 40 | 140 | 50 | | | 5.24 | 4 | 220.33 |
| Ex. 20 | 40 | 140 | 50 | 130.67 | 11.67 | 4.89 | 2 | 215.00 |
| Ex. 21 | 40 | 140 | 50 | 123.33 | 8.67 | 10.94 | 4 | 222.00 |
| Ex. 22 | 40 | 140 | 50 | 144.67 | 24.00 | 5.70 | 3 | 138.33 |
| Ex. 23 | 40 | 140 | | 134.33 | 14.67 | 1.88 | 2 | 160.00 |

As shown in Tables 7 and 8, Experimental Samples 24-25 were nonwoven samples (70 gsm) made of 100% Fibers F3 with different bonding pattern. These nonwoven samples are water-dispersible and eventually water-soluble in hot water. These samples were evaluated both with and without abrasive powder dishwasher detergent adhered to the surface. The abrasive powder was Cascade Complete and the detergent powder was adhered to the surface of the WSW using Elmer's Multi-Purpose Spray Adhesive. Each of Experimental Samples 24-25 are two samples: a first sample without the detergent powder and a second sample with the detergent powder. The detergent powder has dual functions as both the active cleaning formulation and the abrasive powder. Compared to the point bonding pattern, the daisy bonding pattern has a higher bonding density. The daisy bonded water-soluble nonwoven showed a higher Ra value than the point bonded material. This increase in Ra corresponded to the nonwoven's rougher subjective feel. Both nonwovens without any abrasive powders were rubbed on an aluminum surface and an acrylic surfaces resulting in no changes to the gloss of those surfaces. The nonwoven samples with abrasive powders, however, did scratch both the acrylic surface and the aluminum surface with rubbing, resulting in a significant decrease in gloss.

TABLE 7

| | | | | | | Surface |
|---|---|---|---|---|---|---|
| | | | | | Surface | Roughness |
| | Fiber F3 | Fiber F3 | Bonding | | Roughness | (NW + Abrasive |
| | 1.7 dtex × | 2.2 dtex × | Pattern | Basis | (NW only) | powder) |
| | 38 mm | 51 mm | Daisy or | Weight | Average | Average |
| Sample | (%) | (%) | Point | (gsm) | Ra (μin) | Ra (μin) |
| Ex. 24 | 50 | 50 | Daisy | 70 | 245 | 250+ |
| Ex. 25 | 50 | 50 | Point | 70 | 150.33 | 250+ |

TABLE 8

| | | Gloss | | Gloss | |
|---|---|---|---|---|---|
| | Gloss | (Acrylic on | | (Aluminum | |
| | (Acrylic | Aluminum | Gloss | Sheet)- | |
| | on | Sheet)- | (Aluminum | with | |
| | Aluminum | with NW + | Sheet)- | NW + | |
| | Sheet)-with | Abrasive | with NW | Abrasive | Softness |
| | NW only | Powder | only | Powder | Rating |
| | Average | Average | Average | Average | 1-soft, |
| Sample | GU | GU | GU | GU | 5-rough |
| Ex. 24 | 250.67 | 148.33 | 133.50 | 99.10 | 4 |
| Ex. 25 | 250.00 | 160.00 | 134.00 | 102.50 | 2 |

Example embodiments of the disclosure are described in the following numbered paragraphs. These example embodiments are intended to be illustrative in nature and not intended to be limiting.

The following paragraphs describe further aspects of the disclosure:

1. An article for hand-washing an object, comprising:

a core substrate comprising a plurality of fibers including a resin, the core substrate having an abrasive surface and containing an active cleaning formulation,

wherein the core substrate is water-dispersible upon contact with water having a temperature of 40° C. or lower according to Testing Method MSTM-205 to release the active cleaning formulation from the core substrate.

2. The article according to clause 1, wherein the core substrate has a dispersion time of 300 seconds or less.

3. The article according to clause 1 or 2, wherein the core substrate is water-soluble upon contact with water having a temperature of greater than 40° C. according to Testing Method MSTM-205.

4. The article according to any of clauses 1-3, wherein the core substrate has a moisture content of less than 10 wt. %.

5. The article according to any of clauses 1-4, wherein the abrasive surface has an Ra value of 8 uin (0.2 μm) to 60 uin (1.5 μm).

6. The article according to any of clauses 1-5, wherein the active cleaning formulation is in the form of at least one of the following: a solid, a liquid, a gel, or a slurry form.

7. The article according to any of clauses 1-6, wherein the active cleaning formulation comprises one or more of the following: a sanitizer or sanitizing agent, a detergent, a surfactant, an emulsifier, a chelants, a dirt suspender, a stain lifter or releaser, an enzyme, a pH adjuster, a builder, a soil release agent, a structurant, a free fragrance an encapsulated fragrance, a preservative, a solvent, a mineral, a foam builder, an HLB adjuster, or a degreaser, or a combination thereof.

8. The article according to any of clauses 1-7, wherein the active cleaning formulation is at least one of disposed on a surface of the core substrate or embedded in a matrix of the core substrate.

9. The article according to any of clauses 1-8, wherein the core substrate is at least one of saturated with the active cleaning formulation, coated with the active cleaning formulation or impregnated with the active cleaning formulation.

10. The article according to any of clauses 1-9, wherein the active cleaning formulation is present in the core substrate.

11. The article according to any of clauses 1-10, wherein the active cleaning formulation comprises a carrier solvent.

12. The article according to any of clauses 1-11, wherein each fiber of the plurality of fibers having a length of 10 mm to 100 mm.

13. The article according to any of clauses 1-12, wherein each fiber of the plurality of fibers having a length to diameter (L/D) ratio of 0.5 to 25.

14. The article according to any of clauses 1-13, wherein the core substrate comprises a nonwoven substrate in the form of a nonwoven sheet, a plurality of nonwoven sheets bonded to form a nonwoven block substrate, or a plurality of nonwoven sheets coupled to form a sphere or spheroid.

15. The article according to any of clauses 1-14, wherein the active cleaning formulation comprises one or more of the following sanitizing agents: quaternary ammonium compounds (QACs), halogenated oxidizers, hypochlorous acid generating compounds, hypochlorite generating compounds, 1-bromo-3-chloro-5,5-dimethylhydantoin, dichloroisocyanuric acid, alcohols, oxygen radical generators, hydrogen peroxide (H₂O₂), sulfate generating compounds, methylisothiazolinone (MIT), benzisothiazolinone (BIT), or sodium metabisulfite.

16. The article according to any of clauses 1-15, wherein the core substrate comprises at least one nonwoven sheet comprising a plurality of fibers made of the resin.

17. The article according to clause 16, wherein the plurality of fibers is saturated with the active cleaning formulation.

18. The article according to clause 16 or 17, wherein the active cleaning formulation is one of disposed on a surface of the plurality of fibers or embedded in the plurality of fibers.

19. The article according to any of clauses 16-18, wherein the core substrate includes a plurality of nonwoven layers, and the active cleaning formulation is disposed between adjacent layers of the plurality of layers.

20. The article according to any of clauses 16-19, wherein the resin is a polymer comprising a vinyl alcohol moiety.

21. The article according to clause 20, wherein the polymer comprising a vinyl alcohol moiety includes a polyvinyl alcohol homopolymer, a polyvinyl alcohol copolymer, or a combination thereof.

22. The article according to clause 21, wherein the polyvinyl alcohol copolymer is a copolymer of vinyl acetate and vinyl alcohol or an anionically modified copolymer.

23. The article according to clause 22, wherein the anionically modified copolymer comprises a carboxylate, a sulfonate, or combinations thereof.

24. The article according to any of clauses 16-23, wherein the plurality of fibers comprise a polyvinyl alcohol copolymer having a degree of hydrolysis in a range of about 95% to about 98%.

25. The article according to any of clauses 16-23, wherein the plurality of fibers comprise a first type of fiber comprising a polyvinyl alcohol copolymer having a degree of hydrolysis in a range of about 75% to about 89.9%, and a second type of fiber comprising a polyvinyl alcohol copolymer having a degree of hydrolysis in a range of about 90% to about 99.99%.

26. The article according to clause 25, wherein a ratio of the first type of fiber to the second type of fiber is in a range of from about 5:95 to about 25:75 by weight.

27. The article according to clause 25 or 26, wherein the first type of fiber comprises a polyvinyl alcohol copolymer having a degree of hydrolysis in a range of about 80% to about 89%, and the second type of fiber comprises a polyvinyl alcohol copolymer having a degree of hydrolysis in a range of about 95% to about 98%.

28. The article according to any of clauses 25-27, wherein the core substrate comprises at least one nonwoven sheet including a mixture of the first type of fiber and the second type of fiber.

29. The article according to any of clauses 20-28, wherein the core substrate comprises fibers made of a polymer, which is not a polymer comprising a vinyl alcohol moiety.

30. The article according to any of clauses 1-29, wherein the core substrate comprises a plurality of layers, the plurality of layers selected from a nonwoven sheet, a foam layer, a film, or any combination thereof.

The article according to clause 30, wherein the plurality of layers includes separate sheets in a plied construction or a continuous sheet folded in a serpentine construction.

32. The article according to any of clauses 1-31, wherein the abrasive surface comprises a plurality of particles comprising the active cleaning formulation bonded onto the core substrate.

33. The article according to any of clauses 1-31, wherein the resin is biodegradable.

34. A method for making an article for hand-washing an object, the method comprising:

forming a nonwoven substrate comprising a plurality of fibers including a resin, the nonwoven substrate containing an active cleaning formulation; and

forming an abrasive surface of the nonwoven substrate.

35. The method according to clause 34, wherein forming a nonwoven substrate comprising a plurality of fibers including a resin, the nonwoven substrate containing an active cleaning formulation, comprises at least one of saturating the nonwoven substrate with the active cleaning formulation, disposing the active cleaning formulation on a surface of the water-soluble nonwoven substrate, coating a surface of the substrate with the active cleaning formulation, embedding the active cleaning formulation in the nonwoven substrate, or impregnating the nonwoven substrate with the active cleaning formulation.

36. The method according to clause 35 or 36, wherein the active cleaning formulation includes a carrier solvent.

37. The method according to clause 36, wherein the nonwoven substrate is water-dispersible upon contact with water having a temperature of 40° C. or lower, and is water-soluble upon contact with water having a temperature greater than 40° C. according to Testing Method MSTM-205.

38. The method according to any of clauses 34-37, wherein forming an abrasive surface of the nonwoven substrate comprises forming an abrasive material on, disposing an abrasive material on, embedding an abrasive material in, coating an abrasive material on, or adhering an abrasive material to a first surface of the nonwoven substrate.

39. The method according to any of clauses 34-38, wherein forming an abrasive surface of the nonwoven substrate comprises adhesively bonding the abrasive material to a first surface of the nonwoven substrate.

40. The method according to clause 39, wherein the abrasive material comprises a plurality of particles made of the active cleaning formulation.

41. The method according to any of clauses 34-40, wherein forming an abrasive surface of the nonwoven substrate comprises heating a first surface of the substrate to adhere an abrasive material to the first surface.

42. The method according to any of clauses 34-41, wherein forming an abrasive surface of the nonwoven substrate comprises disposing an abrasive material in a matrix of the nonwoven substrate.

43. The method according to any of clauses 34-42, wherein forming an abrasive surface of the nonwoven substrate comprises at least partially dissolving a first surface of the nonwoven substrate and applying an abrasive material to the first surface.

44. The method according to any of clauses 34-43, further comprising forming a substantially smooth surface of the nonwoven substrate.

45. The method according to clause 44, comprising coating a second surface of the nonwoven substrate with water or heating the second surface to create a continuous smooth second surface.

46. The method according to any of clauses 34-45, wherein forming an abrasive surface of the nonwoven substrate comprises forming an abrasive gradient through a thickness of the nonwoven substrate.

All percentages, parts and ratios referred to herein are based upon the total dry weight of the fiber composition, film composition, or total weight of the packaging material composition of the present disclosure, as the case may be, and all measurements made are at about 25° C., unless otherwise specified. All percentages, parts and ratios referred to herein for liquid formulations are based upon the total weight of the liquid formulation. All such weights as they pertain to listed ingredients are based on the active level and therefore do not include carriers or by-products that may be included in commercially available materials, unless otherwise specified.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

It is expressly contemplated that for any number value described herein, e.g., as a parameter of the subject matter described or part of a range associated with the subject matter described, an alternative which forms part of the description is a functionally equivalent range surrounding the specific numerical value (e.g., for a dimension disclosed as “40 millimeters (mm)” an alternative embodiment contemplated is “about 40 mm”).

Reference throughout this specification to “example embodiment” or “an embodiment” may mean that a particular feature, structure, or characteristic described in connection with a particular embodiment may be included in at least one embodiment of claimed subject matter. Thus, appearances of the phrase “example embodiments” or “an example embodiment” in various places throughout this specification is not necessarily intended to refer to the same embodiment or to any one particular embodiment described. Further, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

One skilled in the art will realize that a virtually unlimited number of variations to the above descriptions are possible, and that the examples and the accompanying figures are merely to illustrate one or more examples of implementations.

It will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular embodiments disclosed, but that such claimed subject matter may also include all embodiments falling within the scope of the appended claims, and equivalents thereof.

In the detailed description above, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

What is claimed is:

1. An article for hand-washing an object, comprising:
a core substrate comprising a plurality of fibers including a resin, the core substrate having an abrasive surface and containing an active cleaning formulation,
wherein the core substrate is water-dispersible upon contact with water having a temperature of 40° C. or lower according to Testing Method MSTM-205 to release the active cleaning formulation from the core substrate.

2. The article according to claim 1, wherein the core substrate has a dispersion time of 300 seconds or less.

3. The article according to claim 1, wherein the core substrate is water-soluble upon contact with water having a temperature of greater than 40° C. according to Testing Method MSTM-205.

4. The article according to claim 1, wherein the core substrate has a moisture content of less than 10 wt. %.

5. The article according to claim 1, wherein the abrasive surface has an Ra value of 8 uin (0.2 μm) to 60 uin (1.5 μm).

6. The article according to claim 1, wherein the active cleaning formulation is in the form of at least one of the following: a solid, a liquid, a gel, or a slurry form.

7. The article according to claim 1, wherein the active cleaning formulation comprises one or more of the following: a sanitizer or sanitizing agent, a detergent, a surfactant, an emulsifier, a chelants, a dirt suspender, a stain lifter or releaser, an enzyme, a pH adjuster, a builder, a soil release agent, a structurant, a free fragrance an encapsulated fragrance, a preservative, a solvent, a mineral, a foam builder, an HLB adjuster, or a degreaser, or a combination thereof.

8. The article according to claim 1, wherein the active cleaning formulation is at least one of disposed on a surface of the core substrate or embedded in a matrix of the core substrate.

9. The article according to claim 1, wherein the core substrate is at least one of saturated with the active cleaning formulation, coated with the active cleaning formulation or impregnated with the active cleaning formulation.

10. The article according to claim 1, wherein the active cleaning formulation is present in the core substrate.

11. The article according to claim 1, wherein the active cleaning formulation comprises a carrier solvent.

12. The article according to claim 1, wherein each fiber of the plurality of fibers having a length of 10 mm to 100 mm.

13. The article according to claim 1, wherein each fiber of the plurality of fibers having a length to diameter (L/D) ratio of 0.5 to 25.

14. The article according to claim 1, wherein the core substrate comprises a nonwoven substrate in the form of a nonwoven sheet, a plurality of nonwoven sheets bonded to form a nonwoven block substrate, or a plurality of nonwoven sheets coupled to form a sphere or spheroid.

15. The article according to claim 1, wherein the active cleaning formulation comprises one or more of the following sanitizing agents: quaternary ammonium compounds (QACs), halogenated oxidizers, hypochlorous acid generating compounds, hypochlorite generating compounds, 1-bromo-3-chloro-5,5-dimethylhydantoin, dichloroisocyanuric acid, alcohols, oxygen radical generators, hydrogen peroxide (H₂O₂), sulfate generating compounds, methylisothiazolinone (MIT), benzisothiazolinone (BIT), or sodium metabisulfite.

16. The article according to claim 1, wherein the core substrate comprises at least one nonwoven sheet comprising a plurality of fibers made of the resin.

17. The article according to claim 16, wherein the plurality of fibers is saturated with the active cleaning formulation.

18. The article according to claim 16, wherein the active cleaning formulation is one of disposed on a surface of the plurality of fibers or embedded in the plurality of fibers.

19. The article according to claim 16, wherein the core substrate includes a plurality of nonwoven layers, and the active cleaning formulation is disposed between adjacent layers of the plurality of layers.

20. The article according to claim 16, wherein the resin is a polymer comprising a vinyl alcohol moiety.

21. The article according to claim 20, wherein the polymer comprising a vinyl alcohol moiety includes a polyvinyl alcohol homopolymer, a polyvinyl alcohol copolymer, or a combination thereof.

22. The article according to claim 21, wherein the polyvinyl alcohol copolymer is a copolymer of vinyl acetate and vinyl alcohol or an anionically modified copolymer.

23. The article according to claim 22, wherein the anionically modified copolymer comprises a carboxylate, a sulfonate, or combinations thereof.

24. The article according to claim 16, wherein the plurality of fibers comprise a polyvinyl alcohol copolymer having a degree of hydrolysis in a range of about 95% to about 98%.

25. The article according to claim 16, wherein the plurality of fibers comprise a first type of fiber comprising a polyvinyl alcohol copolymer having a degree of hydrolysis in a range of about 75% to about 89.9%, and a second type of fiber comprising a polyvinyl alcohol copolymer having a degree of hydrolysis in a range of about 90% to about 99.99%.

26. The article according to claim 25, wherein a ratio of the first type of fiber to the second type of fiber is in a range of from about 5:95 to about 25:75 by weight.

27. The article according to claim 25, wherein the first type of fiber comprises a polyvinyl alcohol copolymer having a degree of hydrolysis in a range of about 80% to about 89%, and the second type of fiber comprises a polyvinyl alcohol copolymer having a degree of hydrolysis in a range of about 95% to about 98%.

28. The article according to claim 25, wherein the core substrate comprises at least one nonwoven sheet including a mixture of the first type of fiber and the second type of fiber.

29. The article according to claim 20, wherein the core substrate further comprises fibers made of a polymer, which is not a polymer comprising a vinyl alcohol moiety.

30. The article according to claim 1, wherein the core substrate comprises a plurality of layers, the plurality of layers selected from a nonwoven sheet, a foam layer, a film, or any combination thereof.

31. The article according to claim 30, wherein the plurality of layers includes separate sheets in a plied construction or a continuous sheet folded in a serpentine construction.

32. The article according to claim 1, wherein the abrasive surface comprises a plurality of particles comprising the active cleaning formulation bonded onto the core substrate.

33. The article according to claim 1, wherein the resin is biodegradable.
